(19) United States
(12) Patent Application Publication
(10) Pub. No.: US 2005/0207687 A1
(43) Pub. Date: Sep. 22, 2005

(54) Rolling bearing

(75) Inventors: Shinji Fujita, Hiratsuka-shi (JP); Yoshiaki Sakajiri, Yokohama-shi (JP); Susumu Tanaka, Fujisawa-shi (JP); Youichi Matsumoto, Yokohama-shi (JP); Nobuaki Mitamura, Yokohama-shi (JP); Yasuo Murakami, Hadano-shi (JP); Kenichi Iso, Yamato-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK Ltd., Tokyo (JP)

(21) Appl. No.: 10/895,410

(22) Filed: Jul. 21, 2004

Related U.S. Application Data
(63) Continuation of application No. PCT/JP03/00484, filed on Jan. 21, 2003.

(30) Foreign Application Priority Data
Jan. 21, 2002 (JP) 2002-011623
Apr. 17, 2002 (JP) 2002-115383
Apr. 22, 2002 (JP) 2002-119452
Jul. 22, 2002 (JP) 2002-212894

(51) Int. Cl. F16C 33/62; F16C 29/06

(52) U.S. Cl. 384/492

(57) ABSTRACT

The centerline average roughness of the raceway surface of at least the fixed ring of bearing rings is controlled to be 0.025 to 0.075 μmRa, thereby suppressing the rotation slip of the rolling elements so as to prevent flaking that is accompanied by a structural change. This enables prolongation of the life of bearings. At least the fixed ring of the bearing rings contains, as alloy ingredients at a ratio of from 0.50 to 1.20% by mass of carbon, from 0.10 to 1.50% by mass of silicon, from 0.1 to 2.0% by mass of manganese, from 3.0 to 6.0% by mass of chromium, 2.0% by mass or less of molybdenum, and 1.0% by mass or less of vanadium, whereby the necessary hardness is obtained and the structure is stabilized. This enables prolongation of the life of bearings.

### TECHNICAL FIELD

The present invention concerns a rolling bearing and, more in particular, it relates to a rolling bearing suitable for use in supporting pulleys in belt-type continuously variable transmissions, engine auxiliary equipments (engine auxiliary equipments including, for example, alternators, solenoid clutches, intermediate pulleys, compressor pulleys, car conditioner compressors and water pumps) or gas heat pumps.

Further, the present invention concerns a rolling bearing usable even under a lubrication condition where formation of oil films tends to become difficult due to high temperature, high speed, large vibration and heavy load and under a condition where moisture intrudes and, it particularly relates to a rolling bearing suitable to engine auxiliary equipments, automatic transmissions, CVT (continuously variable transmissions), machine tools and compressors.

Further, the present invention concerns a three-point or four-point, multiple contact rolling bearing and, more in particular, it relates to a four-point contact rolling bearing suitable for use in solenoid clutches.

### BACKGROUND ART

(I) As the materials for bearing rings and rolling elements of rolling bearings including those for use in supporting pulleys in belt-type continuously variable transmissions or engine auxiliary equipments, SUJ2 (high carbon chromium bearing steel, 2nd class) and SCR 420 (case-hardened steel) according to Japanese Industrial Standard (JIS) have been mainly used so far. Further, since foreign bodies often intrude in the belt-type continuously variable transmissions, surface modification has been applied, for examples to bearing rings to make the life longer as a countermeasure for surface originated flaking, as well as a countermeasure for preventing intrusion of foreign bodies into bearings has been adopted, for example, by the modification of the seal structure for bearings.

However, in the rolling bearings for supporting pulleys in the belt-type continuously variable transmissions, early flaking accompanied by structural change has occurred in addition to the surface originated flaking initiated from foreign body indentations and inside originated flaking initiated from inclusions. This is because large vibrations are transmitted to rolling bearings supporting the pulleys of the belt-type continuously variable transmissions, which cause sliding to the rolling elements thereby forming a fresh surface on the raceway surface to evolve hydrogen by mechanochemical reaction, or exerts shearing force on grease or oil to evolve hydrogen, thereby bringing about early flaking. That is, the life of the bearings supporting the pulleys of the belt-type continuously various transmissions is different from usual rolling fatigue life originated from non-metal inclusions.

Further, along with reduction in the size and the weight of automobiles in recent years, reduction of size and weight, and higher performance and higher output have been demanded also for engine auxiliary equipments. For example, since large vibration and heavy load (about 4G to 20G by gravitational acceleration) accompanying high speed rotation exert by way of a belt to the bearings for use in an alternator simultaneously with the operation of an engine, this causes early flaking accompanied by structural change to the raceway surface of an outer ring as a fixed ring to shorten the bearing life. Further, also in the bearing for use in the engine auxiliary equipment, like the bearing for supporting the pulley of the belt-type continuously variable transmission described above, shearing stress exerts on the grease by the rotation slip of rolling element caused on the inlet of the fixed ring, which decomposes the molecular structure of the grease to evolve hydrogen and cause early flaking.

Various rolling bearings coping with the inside originated flaking accompanied by structural change described above have been proposed. For example, Japanese Patent Publication No. 2883460 describes the use of a steel having a content of carbon (C) as low as 0.65 to 0.90 mass %, a content of chromium (Cr) as high as 2.0 to 5.0 mass %, containing nitrogen (N) by 90 to 200 ppm and containing one or both of 10 to 500 ppm of aluminum (Al) and 50 to 5000 ppm of niobium (Nb).

Further, Japanese Patent Publication No. 3009254 describes that a bearing ring as a fixed ring of a grease-sealed bearing is formed of a steel containing 1.5 to 6 mass % of Cr and that a Cr oxide layer is formed to the rolling surface for preventing intrusion of hydrogen. Further, Japanese Unexamined Patent Publication No. Hei 3-173747 describes a grease-sealed bearing in which at least a fixed ring is constituted with a martensitic stainless steel and comprising 14 mass % or 18 mass % Cr series high carbon stainless steel.

Further, Japanese Examined Patent Publication No. Hei 7-72565 describes that the amount of retained austenite in a fixed ring is reduced to 10 vol % or less by applying a sub-zero treatment after usual hardening to a fixed ring formed of SUJ2 and, subsequently, applying a high temperature tempering treatment. That is, this intends to keep the hardness of the fixed ring high by decreasing the amount of the retained austenite in the fixed ring, thereby decreasing the plastic deformation on the raceway surface of the fixed ring under large vibration and heavy load to prevent early flaking.

Further, Japanese Unexamined Patent Publication No. Hei 12-81043 describes that flaking accompanied by structural change caused by the rotation slip of rolling elements is prevented by defining the center line average roughness for the raceway surface of a fixed ring to 0.04 to 0.08 μmRa, the center line average roughness on a surface of the rotational ring to 0.01 to 0.04 μmRa, and defining the ratio of the former to the latter to 1 to 8.

Further, it is considered that, in a case of transmitting the shaft output to the succeeding stage, the pulley shaft of the belt-type continuously variable transmission undergoes a thrust load as a reaction force, to cause so-called axis offset where centers are deviated between an input (primary) pulley and an output (secondary) pulley. The axis offset causes large sliding of rolling elements to the inner and outer rings of bearings for supporting primary and secondary pulleys to increase heat generation during high speed rotation. As a result, retained austenite in the inner rings, outer rings and rolling elements are decomposed to cause dimensional change which decreases the clearance and results in seizure.

As a countermeasure, it has been proposed as described, for example, in Japanese Examined Patent Publication NO. Hei 8-30526, to decrease the axial clearance by making the radius of curvature for each of the inner and outer rings closer to a ball diameter thereby decreasing the axial clearance, or using a double-row angular ball bearing and using it under a pre-loaded state thereby decreasing the axial clearance to “0”. Further, it has been proposed, for example, in Japanese Unexamined Patent Publication No. Hei 10-292859 a technique of keeping excellent dimensional stability and preventing seizure even when generation of heat is increased by the axis offset between the pulleys, by using a four-point contact ball bearing capable of undergoing a radial load and a thrust load, and further, restricting the retained austenite at least in the inner ring and the rolling element to 5 mass % or less.

Generally, in an AC current electric generator for use in vehicles, that is, in an alternator, friction is caused between a belt and a pulley by a high speed rotational movement transmitted from a crank shaft of an engine to cause static electricity. Usually, while the inner ring and the outer ring are insulated by oil films of a lubricant during rotation of the bearing, when the potential difference increases due to the static electricity between the inner ring and the outer ring (about 100 to 500V), electric discharge is generated between the inner ring and the outer ring. Then, this decomposes water intruded in the grease or in the lubricant to evolve hydrogen ions and cause early flaking accompanied by structural change in the same manner as described above by the intrusion of hydrogen from the raceway surface of the bearing.

In order to solve the problem described above, Japanese Unexamined Patent Publication No. Hei 11-117758 discloses suppression of the electric discharge due to the static electricity in the bearing by using a hybrid pulley constituted with an insulative material instead of a metallic pulley as a member for use in engine auxiliary equipments or as a member for use in automobile electrical components.

However, in the rolling bearing for use in supporting the pulley in the belt-type continuously variable transmission, since sliding of the rolling element increases under the heavy load as described above, sliding of the rolling elements can not be controlled by merely optimizing the chemical ingredients for the fixed ring suffering from frequent occurrence of early flaking as in the rolling bearing described in Japanese Patent Publication No. 2883460, and it is substantially difficult to prevent early flaking of the fixed ring. Further, in the bearing for use in the high speed rotational type engine auxiliary equipment such as the alternator, since hydrogen evolves by the static electricity causes early flaking, this can not be an effective countermeasure.

Further, in the rolling bearing described in Japanese Patent Publication No. 3009254, the thickness of the Cr oxide layer (FeCrO₄) that can be formed with 1.5 to 6 mass % Cr is about 1 to 2 nm. This is because the temperature of the raceway surface in contact with an abrasive in the final finishing step for the bearing is as high as about 700° C., and a hard and dense nano-order Cr oxide layer is formed by the accompanying high temperature oxidation. However, when the rolling bearing is used for supporting the pulleys of the belt-type continuously variable transmission, the Cr oxide layer is easily disconnected by the sliding of the rolling element under the heavy load, and early flaking of the fixed ring can not be prevented. Further in the bearing for use in the high speed rotational type engine auxiliary equipment such as the alternator described above, since hydrogen evolved by the static electricity permeates the Cr oxide layer of about 1 to 2 nm thickness, it can not provide a basic solution for the early flaking accompanied by structural change.

Further, in the rolling bearing described in Japanese Examined Patent Publication No. Hei 7-72565, since the amount of retained austenite is decreased by high temperature tempering, it involves a problem that the hardness of the entire bearing ring is lowered. Further, in the rolling bearing described in Japanese Unexamined Patent Publication No. Hei 3-173747, since the cost of the material per se is high, as well as a great amount of contained Cr can not be coped with existent heat treatment apparatus, it increases the cost also in view of the steps.

Further, in the rolling bearing described in Japanese Unexamined Patent Publication No. Hei 12-81043, there is a room for further improvement as the material for preventing flaking accompanied by structural change although it has an effect capable of suppressing the rotation slip of the rolling element.

Further, in the rolling bearing described in Japanese Examined Patent Publication No. Hei 8-30526, there is a limit for decreasing the axial clearance by making the radius of curvature smaller for the inner ring and the outer ring and it is difficult to obtain a sufficient effect. In addition, scattering of the size for the shaft and the inner diametrical size of the bearing gives undesired effects on the axial clearance to increase scattering in the axial clearance, which also results in a problem of requiring strict control for the accuracy of the shaft size and the accuracy for the inner diametrical size to increase the cost. Further, while the method of using the double-row angular ball bearing can provide high rigidity, this not only increases the cots of the bearing but also requires a large space in the axial direction, which is not practical.

Further, in the rolling bearing described in Japanese Unexamined Patent Publication No. Hei 10-292859, heat generation increases due to metal contact between the rolling element and the inner and outer rings of the bearing by the fluctuation of the divisional pulley. Then, in a case where the temperature is 150° C. or higher, it may be a worry not only of seizure but also flaking caused by lubrication failure. Further, in the rolling bearing described in Japanese Unexamined Patent Publication No. Hei 10-292859, it is impossible to maintain the hardness of HRC of 58 or more required for the ball bearing under the circumstance of 150° C. or higher. Then, since lowering of the rolling life by the lowering of the hardness is not taken into consideration, a countermeasure in view of the material is considered necessary.

Further, in the rolling bearing described in Japanese Unexamined Patent publication No. Hei 11-117758, while the electric discharge due to the static electricity inside the bearing is suppressed and this is effective for early flaking accompanied by structural change caused by hydrogen, the hybrid pulley itself is expensive to bring about a problem that the cost increases inevitably.

In view of the above, the present invention has been accomplished in order to solve the foregoing problems and it is a first subject thereof to provide a rolling bearing, such as a rolling bearing for use in supporting pulleys of a belt-type continuous variable transmission or a rolling bearing for use in an engine auxiliary equipment such as an alternator, capable of suppressing the rotation slip of rolling elements under heavy load and at high temperature, as well as preventing early flaking accompanied by structural change caused by evolution of hydrogen or the like thereby capable of prolonging the life.

(II) A rolling bearing is generally used in rotary portions of various power apparatus in an automobile engine, for example, automobile electrical components or engine auxiliary equipments. Then, SUJ2 is used as a material for the bearing ring and the rolling element of the rolling bearing and lubrication is conducted mainly by a grease.

In automobiles (passenger cars), an engine room space is obliged to be restricted by popularization of FF (front engine front derive) cars with an aim of reducing the size and weight, and by a demand for the extension of habitat spaces. Accordingly, reduction of size and weight for the electrical components and engine auxiliary equipments of automobiles has been proceeded further. In addition, higher performance and higher output have also been demanded for the components described above, and large vibration and heavy load (about 4G to 20G of gravitational acceleration) accompanying high speed rotation exerted by way of the belt on the bearing for use in the alternator simultaneously with the operation of the engine.

However, since the output is lowered inevitably as the size is reduced for each of the components, lowering of the output is compensated by increasing the speed, for example, in the solenoid clutch for use in the alternator or the car air conditioner, and the speed of the idler pulley is also increased correspondingly.

Further, improvement for the quietness is desired for automobiles, and tight sealing for engine rooms has been progressed. Accordingly, since the temperature in the engine room has been increased more, it is necessary for each of the components to withstand high temperature.

Along with increase for the temperature and the operation speed and improvement of the performance, a problem for the occurrence of flaking accompanied by structural change to the white structure due to hydrogen brittlement has become elicited in the bearing for each of the components and it is a new important subject to prevent the same. Further, some of the components described above are used in a high temperature region (for example, 170 to 180° C.), and seizure resistance at high temperature is also an important necessary performance. Further, it is also necessary for the bearing to use a grease of excellent rust preventive performance compared with bearings used for other portions.

Among them, bearings used in the high temperature region include those of excellent dimensional stability and with less lowering of the hardness at high temperature disclosed in Japanese Examined Patent Publication No. Hei 6-033441. The bearing is constituted with a steel having a carbon content of 0.95 to 1.10 mass %, a silicon or aluminum content of 1 to 2 mass %, a manganese content of 1.15 mass % or less and a chromium content of 0.90 to 1.60 mass %, which is applied with a high temperature tempering at 230 to 300 ° C., to control the amount of retained austenite to 8 vol % or less and the hardness HRC to 60 or more.

Further, the grease described above includes those disclosed, for example, in Japanese Unexamined Patent Publication No. Hei 3-200898 or Japanese Unexamined Patent Publication No. Hei 9-3466. The former is a grease with addition of an oil soluble organic inhibitor (metal sulfonate salt, etc.), a water soluble inorganic passivation agent (sodium nitrite, etc), and a nonionic surfactant, respectively, and improvement of the rust preventive performance is intended by such additives. Further, the latter is a grease using a diurea compound as a thickening agent.

On the other hand, in the vehicle AC power generator, static electricity is generally generated between the belt and the pulley by the high speed rotational movement transmitted from the crank shaft of the engine. While the inner ring and the outer ring of the bearing during rotation are usually insulated by oil films of the lubricant, electric discharge occurs between the inner ring and the outer ring when the potential between the inner ring and the outer ring increases (about 100 to 500V). Grease or water content contained in the grease is decomposed by the electric discharge to evolve hydrogen ions which intrude as hydrogen atoms from the raceway surface. Then, it is considered that early flaking accompanied by structural change is caused as described above.

A countermeasure for the phenomenon described above is disclosed in Japanese Patent Unexamined Patent Publication No. Hei 11-117758. That is, it discloses a hybrid pulley constituted at the internal portion thereof with an insulative material instead of a metallic pulley in the member for use in the engine auxiliary equipment including the alternator or the member for use in automobile electrical parts, thereby suppressing the electric discharge due to the static electricity inside the bearing.

By the way, as an index regarding the life of the rolling bearing, a concept of an oil film parameter A expressing the extent of oil film formation that greatly effectuates the quality of lubrication is used. Then, it has been considered to be a necessary condition to fabricate the rolling contact surface between the bearing ring and the rolling element as smooth as possible to form the oil film sufficiently in order to improve the life of the bearing. This is also applicable to the grease lubrication, and the rolling contact surface between the bearing ring and the rolling element has been fabricated as smooth as possible to increase the oil film parameter A and make the surface roughness of the raceway surface satisfactory, thereby suppressing disconnection of the oil films to suppress the occurrence of flaking.

However, in the bearing for use in the alternator, for example, used under grease lubrication in which high temperature, large vibration and heavy load (4 to 20G of gravitational acceleration) accompanying high-speed rotation exert simultaneously by way of the belt, the oil film parameter A is decreased than usual tending to make it difficult for oil film formation. As it is described that an average rotation slip ratio increases as high as about 25 to 30%, for example, in the Tribology Conference Pretext of Corporation of Japan Tribology Society (“measurement of ball rotation slip of a ball bearing undergoing radial load and relation thereof with brittle flaking”, written by Toshikazu Nanbu, Yoshinobu Akamatsu, Tribology Conference Pretext (Tokyo, 1995-5), 551 to 554 pp, issued from Corporation of Japan Tribology Society in Apr. 25, 1995), formation of the oil film tends to become difficult in the loading zone of the fixed ring tending to generate sliding, that is, in the outer ring.

The surface roughness for the raceway surface and the rolling surface is disclosed in Japanese Examined Publication No. Hei 5-32602 and Japanese Patent Publication No. 2508178. The former describes that the surface roughness of a steel ball is made smaller than the surface roughness for the rolling surface (the surface roughness of steel ball is 0.05 μm Ra or more), and the surface roughness of the steel ball is made closer to the surface roughness of the rolling surface, thereby forming an oil film between the rolling surfaces to suppress the rise of temperature in the steel ball. This can prevent the early flaking on the surface of the steel ball and extend the life.

Further, the latter describes that the sliding movement is suppressed by forming at least the raceway surface of the outer ring among each of the raceway surfaces of the inner and outer rings and the surface of the rolling elements with plural grooved concave portions each at a depth of 0.0005 to 0.0008 mm and smooth portions each partitioned by the grooved concave portions and having a surface roughness of 0.08 μmRa or less. Further, it is described that metal adhesion at the smooth portion is prevented by providing the grooved concave portion also with an ancillary function of an oil sump. They can prevent the seizure of the bearing and provide a sufficient bearing performance.

Further, Japanese Patent Unexamined Publication No. Hei 12-81043 describes a rolling bearing in which a lubricant sump is formed to a fixed ring often suffering from the occurrence of flaking by defining center line average roughness σ1 for the raceway surface of the fixed ring to 0.04 to 0.08 μmRa, the center line average roughness σ2 for the raceway surface of a rotational ring to 0.01 to 0.04 μmRa and defining the ratio σ1/σ2 between them to 1 to 8. Since the surface roughness for the raceway surface of the rotational ring is more smooth than that of the fixed ring in this rolling bearing, large vibrations are suppressed and early flaking in the fixed ring is prevented.

Among the rolling bearings, the bearing for use in the engine auxiliary equipments including the alternator is used under higher temperature, larger vibration and heavier load than usual bearings, so that earlier flaking sometimes occur to extremely shorten the bearing life compared with the calculated life. Such a problem has not yet been solved basically.

It is considered that the early flaking phenomenon is caused by the following mechanisms.

(i) Formation of oil films is made difficult by heavy load, large vibration, fluctuation of rotation, high temperature, etc. and the raceway surface and the rolling element tend to be in contact with each other.

(ii) Lubricant or the water content contained in the lubricant is decomposed by the catalytic effect on the activated fresh surface of the contact surface between the bearing ring and the rolling element to evolve hydrogen ions.

(iii) Generated hydrogen ions are adsorbed on the fresh surface to form hydrogen atoms which are accumulated to a high strained area (near the maximum shearing stress position) to cause structural change to the structure referred to as a white structure. The structural change results in flaking.

Further, for example, in the alternator, static electricity is generated between the belt and the pulley by the high speed rotational movement transmitted from the crank shaft of the engine. While the inner ring and the outer ring of the bearing during rotation are usually insulated by oil films of the lubricant, electric discharge phenomenon is generated between the inner ring and the outer ring as the potential difference between the inner ring and the outer ring increases (about 100 to 500 V). The grease or the water content in the grease is decomposed by the electric discharge to generate hydrogen ions which intrude as hydrogen atoms from the raceway surface. Then, it is considered that early flaking accompanied by structural change described above is caused.

A technique for improving the life of the bearing used under such large vibration and heavy load is disclosed in Japanese Examined Patent Publication Nos. Hei 7-72565 and Hei 6-89783. In the rolling bearing described in the former, since the amount of retained austenite in the steel is defined as 0.05 to 6% by volume, plastic deformation due to decomposition of the retained austenite below the raceway surface is prevented, so that the bearing life is excellent.

Further, in the rolling bearing in which the grease is sealed inside described in the latter, since an oxide layer of 0.1 to 2.5 μm thickness is formed on the raceway surface of the bearing ring, generation of hydrogen from the grease is suppressed and, accordingly, early flaking less occurs.

However, the bearing described in the former has an aim of preventing the plastic deformation due to the decomposition of the retained austenite below the raceway surface, improvement for the life by suppressing the early flaking accompanied by structural change can not be expected. Further, while it is intended to improve the life by forming the oxide layer on the raceway surface, the oxide layer is disconnected easily under large vibration or under large sliding. Accordingly, like the bearing described in the former, it cannot be expected that the early flaking accompanied by structural change is suppressed to improve the life, and the effect is limitative.

Further, since the bearing is generally manufactured continuous manufacturing steps from the grinding step to the assembling step, provision of the step for forming the oxide layer in the course of the manufacturing steps incurs large increase in the cost.

Further, the rolling bearing described in Japanese Unexamined Patent Publication No Hei 4-244624 is a ball bearing using a ceramic ball for rolling elements. In a case where the rolling element is constituted with ceramics, since flowing of static electricity generated by the friction between the pulley and the belt through the shaft to the bearing is prevented, decomposition of the lubricant is suppressed and the life of the bearing is made longer. However, since the ceramic ball is extremely expensive, it is not practical.

Since it is anticipated that the amount of static electricity generated by the belt and the pulley along with further increase in the speed of the alternator in the feature, it is considered that the electrical countermeasure will become effective more and more for the flaking accompanied by structural change. The countermeasure is disclosed in Japanese Unexamined Patent Publication No. Hei 11-117758. That is, it discloses a hybrid pulley for suppressing the discharging phenomenon by the static electricity inside the bearing by constituting the inside with an insulative material instead of the metal pulley in the member for use in the engine auxiliary equipment including the alternator and the member for use in automobile electrical components. However, since the cost of the bearing is inevitably increased by applying the electrical countermeasure by the method described above, a further improvement is desired.

Further, in addition to the flaking accompanied by structural change described above, a possibility of causing seizure by the degradation of the grease is increased, along with further increase in the temperature and the operation speed of the alternator in the feature. Further, since SUJ2 suffers from lowering of hardness at an increased temperature, flaking tends to occur.

Japanese Examined Patent Publication No. 6-33441 describes a bearing as a method of suppressing the lowering of the hardness. That is, the bearing is constituted with a steel comprising a carbon content of 0.95 to 1.10 mass %, a silicon or aluminum content of 1 to 2 mass %, a manganese content of 1.15 mass % or less and a chromium content of 0.90 to 1.60 mass %, which is applied with high temperature tempering at 230 to 300° C., to define the amount of retained austenite to 8 volume % or less and the hardness HRC to 60 or more. However, while a countermeasure for high temperature is adopted, no countermeasure is taken into consideration for early flaking accompanied by structural change.

Further, an example of the countermeasure for early flaking accompanied by structural change observed in the bearings for use in the engine auxiliary equipment and the bearing for use in the automobile electrical components can include, for example, those described in Japanese Patent Publication No. 2883460. The publication proposes use of a steel comprising a lower carbon content (0.65 to 0.90 mass %), a higher chromium content (2.0 to 5.0 mass %) compared with existent SUJ2, containing nitrogen (90 to 200 ppm) and further containing one or both of aluminum (10 to 500 ppm) and niobium (50 to 500 ppm).

However, it is impossible to control the static electricity generated between the belt and the pulley by merely optimizing the chemical composition of a steel constituting a fixed ring tending to cause early flaking. Accordingly, it can not be a complete countermeasure for the early flaking caused by hydrogen evolved due to static electricity and it is difficult to prevent the early flaking caused to the fixed ring. Further, no consideration has been taken for seizure.

Further, Japanese Patent Publication No. 3009254 describes a bearing in which at least a fixed ring is constituted with a steel containing 1.5 to 6 mass % of chromium. Then, it is described that since a chromium oxide layer (FeCrO₄) is formed on the surface of a bearing ring and the raceway surface is passivated, intrusion of hydrogen formed by the decomposition of grease to the inside of the raceway surface can be suppressed.

However, since hydrogen evolved by the static electricity can permeate the chromium oxide layer, it is difficult to completely prevent the early flaking. Further, no consideration has been taken for the seizure.

Further, it is extremely difficult to obtain sufficient flaking life and seizure life under severe conditions of high temperature, high speed and heavy load even by the use of a grease described in Japanese Unexamined Patent Publication No. Hei 3-200898 or Japanese Unexamined Patent Publication No. Hei 9-3466. For example, even when a sulfonate salt or the like is used as a rust preventive agent as in the grease described in Japanese Unexamined Patent Publication No. Hei 3-210394, it is not easy to attain a sufficient flaking life while maintaining the rust preventive performance. Further, in a case of the grease described in Japanese Unexamined Patent Publication No. Hei 9-3466, those usable up to a high temperature region (for example, 160° C. or higher) have not yet been obtained.

Further, in the bearing for use in the alternator where high temperature, large vibration and heavy load (4 to 20G of gravitational acceleration) accompanying the high speed rotation are exerted simultaneously by way of the belt, the oil film parameter A decreases tending to cause a difficulty in the oil film formation. Then, this resulted in a problem that the early flaking accompanied by structural change was caused to the loading zone of the fixed ring tending to bring about sliding, that is, to the outer ring thereby shortening the life of the bearing.

As a countermeasure for preventing the early flaking accompanied by structural change in the fixed ring, “SAE technical paper: SAE 950944 (held on Feb. 27 to Mar. 2, 1995)”, from 1st to 14^{th} chapters discloses the analysis of the fatigue mechanism in the bearing for use in the alternator and change of sealed grease from E grease to M grease. Since the M grease has a high damper effect, when it is used for the bearing used under large vibration and heavy load, it can suppress sliding and absorb vibration and load sufficiently to prevent metal contact in the bearing. Accordingly, the early flaking accompanied by structural change is prevented.

However, while the technique disclosed in Japanese Examined Patent Publication No. Hei 5-32602 can prolong the life of the steel ball, since the surface roughness of the steel ball is as large as 0.05 μmRa, increase of the vibration is anticipated to bring about a problem for the acoustic performance. Further, while the technique disclosed in Japanese Patent Publication No. 2508178 can be expected to provide an effect of prolonging the life of the fixed ring, since the surface roughness optimal to the rotational ring is unknown, it may be a possibility of causing a problem for the acoustic performance.

Further, while the balling bearing described in Japanese Unexamined Patent Publication No. Hei 12-81043 can suppress large vibration and prevent early flaking of the fixed ring, a further improvement is necessary since merely definition for the center line average roughness for the raceway surface is sometimes insufficient.

Further, various other improvements may be considered and, for example, a method of constituting plural-row bearing thereby decreasing the load may also be considered. However, since it is expected that the size of the bearing also undergoes restriction along with reduction in the size and the weight and the improvement in the performance of the engine in the feature, it can not be considered that the method can provide a drastic resolution.

On the other hand, a rolling bearing is used for a portion of a solenoid clutch in a gas heat pump air conditioner (GHPA) which is a system for conducting cooling and heating through a heat pump cycle by driving a compressor gas engine. Then, as the material for the rolling bearing, high carbon chromium bearing steels, particularly, SUJ2 according to JIS have been mainly used. The high carbon chromium bearing steel is applied with hardening and tempering, to control the surface hardness HRC (Lockwell hardness) to about 62 and the amount of a retained austenite to about 10% by volume.

Also in the rolling bearing for use in the solenoid clutch of GHPA, early flaking accompanied by structural change tends to occur like the rolling bearing for use in the engine auxiliary equipments or the rolling bearing for use in the automobile electrical components. It is considered that this is caused by vibrations of the engine like in the case of the rolling bearing for use in the engine auxiliary equipments or the rolling bearing for use in the automobile electrical components.

Then, it is a second subject of the present invention to solve various problems in the prior art as described above and provide a long life rolling bearing less suffering from early flaking accompanied by structural change caused by hydrogen even under a circumstance where static electricity is generated to form hydrogen. It is also the second subject to provide a long life rolling bearing less suffering from seizure even under a high temperature circumstance tending to cause seizure.

(III) Generally, in a rolling bearing, rolling movement is taken place between bearing rings and rolling elements as constituent components thereof and the bearing rings and the rolling elements undergo repetitive stress. Accordingly, it is required for the material constituting the components to have properties such as being hard, endurable to load, having long rolling fatigue life and favorable wear resistance to sliding.

In view of the above, for the material generally constituting the components, SUJ2 according to JIS has been used frequently as the bearing steel, and steels corresponding to SCR 420 and steels corresponding to SCM 420 according to JIS as the case hardened steel have been used frequently.

Since the materials described above undergo repetitive stress as described previously, in order to obtain required physical properties such as rolling fatigue life, hardening and tempering are applied for the bearing steel and hardening and tempering are applied after carburization or carbonitridation for the case hardened steel to control the hardness HRC to 56 to 64.

Among the rolling bearings, the rolling bearing used for the engine auxiliary equipment including the alternator sometimes causes early flaking to extremely shorten the bearing life compared with the calculated life since it is used under higher temperature, larger vibration or heavier load than usual bearings. It is considered that the early flaking phenomenon is caused accompanied by structural change to a so-called white structure when the oil film formation becomes difficult, for example, by heavy load, large vibration and fluctuation of rotation in which the raceway surface and the rolling element tend to be in contact with each other and, further, water contained in the lubricant is decomposed to evolve hydrogen ions, which are adsorbed as hydrogen atoms to the fresh surface on the raceway surface and accumulated to the highly strained area (near the maximum shearing stress position).

A prior art intending to improve the life of the bearing used under the large vibration and heavy load is described, for example, in Japanese Examined Patent Publication No. Hei 7-72565 and Japanese Examined Patent Publication No. Hei 6-89783. In the technique of the former, the plastic deformation due to the decomposition of the retained austenite below the raceway surface is suppressed to improve the bearing life by defining the amount of the retained austenite in the steel to 0.05% or more and 6% or less. In the technique of the latter, it is described that separation of hydrogen from the grease is suppressed by forming an oxide layer of 0.1 to 2.5 μm thickness on the raceway surface of the bearing in a grease-sealed bearing in which grease is sealed in the bearing ring and early fracture of the bearing can be prevented.

On the other hand, a countermeasure for early flaking of the bearing used under high temperature, large vibration and heavy load accompanying the high speed rotation is described in 1st to 14^{th} items of “SAE technical paper: SAE 950944 (held on Feb. 27 to Mar. 2 in 1995)”. That is, it is reported that the early flaking can be prevented by absorbing large vibration and heavy load and moderating metal contact by the damper effect of the grease.

However, since the technique described in Japanese Examined Patent Publication No. Hei 7-72565 intends to prevent plastic deformation due to the decomposition of the retained austenite under the raceway surface, it can not be expected for the effect of suppressing the flaking caused by the structural change thus improving the life. Further, the technique in Japanese Examined Patent Publication No. Hei 6-89783 described above intends to prolong the life by forming an oxide layer on the surface. However, when it is put under large vibration or large sliding, the oxide layer is disconnected easily. Accordingly, it can not be expected for the effect of suppressing flaking caused by the structural change to improve the life, like the technique described in Japanese Examined Patent Publication No. Hei 7-72565, and the effect is limitative. Further, since also the technique described in “SAE technical paper” absorbs the large vibration and heavy load and moderates the metal contact by the damper effect of the grease, it can not provide a drastic resolution.

Further, while it may be considered that moderation of the loading condition or the like by making the bearing into a plural row constitution can be one of countermeasures for the improvement, since it is anticipated that the size of the bearing will be restricted by the reduction of the size and the weight and the improvement of the performance of engines, and it is also anticipated that the working conditions of the rolling bearing become severer, this can not also be a drastic resolution.

Further, it has been found for rolling bearings used under oil lubrication, for example, in the automatic transmission or the belt type CVT that structural change similar with white structure observed in the rolling bearing used under grease lubrication, for example, in the engine auxiliary equipment may be caused.

Generally, in a rolling bearing used under oil lubrication, a gear oil, machine oil or the like has been used so as to be in common with lubricants of excellent fluidity including spindle oils and turbine oils, and lubricants for use in components in the vicinity of the bearing such as gears.

On the other hand, the transmission of an automobile is an apparatus incorporated, for example, with a torque converter, a gearing mechanism, an oil pressure mechanism, a wet clutch, etc. and in order to smoothly operate the mechanisms to transmit a power, lubricants such as those for use in ATF (Automatic Transmission Fluid) and those for use in CVTF (Continuously Variable Transmission Fluid) of high traction coefficient are used.

It is required for ATF or CVTF to have various functions as heat medium, lubrication for frictional material and keeping of appropriate frictional characteristics in order to smoothly operate the mechanisms described above. However, in a case of the rolling bearing used under oil lubrication, since a tangential force formed between the bearing ring and the rolling element increases, the lubrication film tends to be broken not at the center for the contact ellipsis where the contact pressure is highest, but at a portion slightly deviated from the center of a contact ellipsis where the PV value (product of contact pressure and speed) is largest. Then, since hydrogen evolved by decomposition of water content in the lubricant, etc. intrudes into the steel simultaneously, it is considered that this brings about the structural change not observed under the existent oil lubrication condition.

In view of the above, it is a third subject of the present invention to solve the problem in the existent rolling bearings as described above and provide a rolling bearing having a long life even under a lubrication condition where the formation of an oil film tends to become difficult due to high temperature, high speed, large vibration and heavy load and under conditions where the water content intrudes. (IV) Heretofore, as the material used for a rolling bearing for use in the solenoid clutch, high carbon chromium bearing steels, particularly, SUJ2 according to JIS have been used generally. The steels are applied with hardening and tempering to a surface hardness HRC (Lockwell hardness) of about 62 and the amount of retained austenite of about 10% by volume and used.

In a compressor for a car conditioner, as shown in FIG. 1, an engine power is transmitted from a crank pulley and a belt (both not illustrated) to a solenoid clutch pulley 101. The transmitted power of the engine is transmitted to a compressor 104 by adsorbing a frictional plate 102 formed at the end of the solenoid clutch pulley 101 by the electromagnetic force of a solenoid coil 103, to drive the compressor 104. Further, an inner ring 106 of a rolling bearing 108 is fixed to a cylindrical portion 105 protruded from a housing H so as to cover the driving shaft of the compressor 104, and an outer ring 107 of the rolling bearing 108 is press fit into the solenoid clutch pulley 101 thereby supporting the solenoid clutch pulley 101 rotationally.

The rolling bearing 108 is applied with tension by a belt for actuating the solenoid clutch pulley 101 and a radial loaded is applied to the rolling bearing 108 by the tension and a thrust load is further added during operation of the solenoid clutch. Further, the axial centers are offset between the solenoid clutch pulley 101 and the rolling bearing 108 by the restriction for the arrangement at the periphery of the engine, and a moment load is applied to the r rolling bearing 108 due to the displacement.

Accordingly, the rolling bearing 108 is inclined and, in a case where the inclination is large, the attraction force by the electromagnetic force of the solenoid coil 103 is weakened, failing to couple the clutch pulley 101 and the frictional plate 102, or coupling with the frictional plate 102 is weakened to cause sliding, whereby the power of the engine can not be transmitted to the compressor 104 to cause generation of heat.

In view of the situations described above, a double row angular ball bearing or two single row radial ball bearings in combination are so far used for the rolling bearing for use in the solenoid clutch in order to decrease inclination of a bearing when undergoing a moment load.

However, since size reduction or cost down has been demanded strongly, use of a three-point or four-point multiple point contact single row ball bearing capable of undergoing not only the radial load but also the thrust load has been studied.

An example of the multiple point contact single low ball bearing can include those described in Japanese Unexamined Patent Publication No. 2001-304273. In the bearing, since the radius of curvature for the groove in the raceway surface of the inner ring is defined as 52 to 53.5% of the ball diameter, the radius of curvature for the groove in the raceway surface of the outer ring is defined as 53.5 to 56% of the ball diameter and the angle of contact between the ball and the inner and outer rings is defined within a range of 20 to 300, it does not incur the lowering of the moment rigidity and can avoid the problem of heat generation caused by the spin of the ball or run-on of the ball.

Further, those described in Japanese Unexamined Patent Publication No. Hei 11-336795 can be mentioned as another example. The bearing is a four-point contact single row ball bearing in which the raceway surfaces of the inner and outer rings are made symmetrical with respect to the center. Then, the radius of curvature for the grooves in the raceway surfaces of the inner and outer rings is defined to 51.5 to 55% of the ball diameter, by which the contact pressure generated at the rolling surface between the ball and the inner and outer rings is decreased to thereby reduce the heat generation by sliding and minimize the occurrence of sliding caused by the revolution of the ball around the axis and the rotation (spin) different in the direction with respect to the axis, to thereby prevent seizure.

However, since no sufficient study has been made for the increase of the temperature in the bearing described in Japanese Unexamined Patent Publication No. 2001-304273, it is uncertain whether the problem described above can be avoided or not also in a case of application to a compressor the working temperature of which is to be increased in the future.

Further, in a case where the temperature of the bearing exceeds 150° C. due to the rise of the atmospheric temperature by the size reduction of the compressor in the future, it may be a worry not only for the seizure but also flaking due to lowering of the hardness by the rise of the working temperature. However, nothing is mentioned for the ingredients of the material in the bearing described in Japanese Unexamined Patent Publication No. Hei 11-336795. Since it is the necessary condition to keep the hardness HRC to 58 or more required for the bearing even under a circumstance of 150° C. or higher as the essential condition in the future, lowering of the rolling life due to the lowering of the hardness has to be taken into consideration. Accordingly, it is considered that a countermeasure in view of the material is necessary.

The present invention has been accomplished in view of the technical background as described above, and it is a fourth subject to provide a multiple-point contact rolling bearing capable of maintaining a stable bearing dimension to prevent seizure and capable of preventing early flaking caused by the lowering of hardness even under a circumstance where heat generation is caused by metal contact by the sliding of the rolling element which is inherent to the multiple-point contact rolling bearing.

(V) As has been described above, SUJ2 according to JIS has been used mainly as described above for the material of the bearing ring and the rolling element of the rolling bearing. Further, along with reduction in the size and the weight of automobiles in recent years, higher performance and higher output, as well as reduction in the size and the weight are required also for the engine auxiliary equipments. For example, large vibration and heavy load (about 4 to 20G of gravitational acceleration) by the high speed rotation exert by way of a belt to bearings for use in the alternator, simultaneously with the operation of the engine. Accordingly, in the existent bearing for use in the alternator, early flaking accompanied by structural change occurs to the raceway surface of an outer ring as the fixed ring thereby shortening the life.

Various rolling bearings have been proposed for coping with the early flaking accompanied by structural change. For example, Japanese Patent No. 2883460 describes the use of a steel comprising a carbon(C) content of as low as 0.65 to 0.90 mass %, a chromium(Cr) content of as high as 2.0 to 5.0 mass %, containing 90 to 200 ppm of nitrogen(N) and one or both of 10 to 500 ppm of aluminum (Al) and 50 to 5000 ppm of niobium (Nb).

Further, Japanese Patent No. 3009254 describes to constitute a fixed ring of a grease-sealed bearing with a steel containing 1.5 to 6 mass % of Cr and form a Cr oxide layer on the rolling surface thereof for preventing intrusion of hydrogen formed by decomposition of a grease.

Further, as a bearing to be used in a high temperature region, Japanese Examined Patent Publication No. Hei 6-033441 discloses a bearing having excellent dimensional stability and less lowering hardness at high temperature. The bearing is constituted with a steel comprising 0.95 to 1.10 mass % of carbon content and 1 to 2 mass % of silicon or aluminum content, 1.15 mass % or less of manganese content and 0.90 to 1.60 mass % of chromium content, and applied with high temperature tempering at 230 to 300° C. to reduce the amount of retained austenite to 8% by volume or less and increase the hardness HRC to 60 or more.

It is considered that a possibility of causing early flaking accompanied by structural change will further increase in the future along with increase in the temperature and the speed as the working condition in the alternator. Accordingly, for the alloying ingredients in the steel materials, the amount of the elemental ingredients for retarding the structural change is insufficient in SUJ2 and it is necessary to decrease sulfur-series inclusions (MnS) which form initiation points of the white structure.

However, the bearing described in Japanese Patent No. 2883460, while the amount of Cr as the element retarding the structural change is taken into consideration but the amount of S is not taken into consideration.

Further, in the bearing described in Japanese Patent No. 3009254, the amount of S is not taken into consideration. Further, since the amount of Cr is insufficient in the Cr oxide layer of the bearing, it is difficult to effectively prevent the intrusion of hydrogen.

Further, in the bearing described in Japanese Examined Patent Publication No. Hei 6-033441, the amount of Cr as the element for retarding the structural change is insufficient and, in addition, the amount of S is not taken into consideration.

In view of the above, it is a fifth subject of the present invention to solve the various problems in the prior art as described above, and provide a rolling bearing less suffering from early flaking accompanied by structural change caused by hydrogen and having long life.

### DISCLOSURE OF THE INVENTION

(I) When the present inventors have recalled bearings, for example, for supporting primary and secondary pulleys in belt-type continuously variable transmissions and bearings for use in solenoid clutches in GHPA from the market and investigated for defective products specifically, the following conclusion was obtained. That is, most of products causing early defects recalled from the market did not suffer from seizure but defects were caused by flaking. Then, near the flaked portion suffering from, were observed structural changes similar with those observed in the bearings for use in engine auxiliary equipments or bearings for use in automobile electrical components. Further, grinding traces on the raceway surface were scarcely present in the flaked products, and the hardness at the extreme surface was lowered greatly to Hv of 600 or less.

In the case of the bearing for supporting the pulley of the belt-type continuously variable transmission, it is considered that such defects were caused not only from heat generation by metal contact between the rolling element and the inner and the outer rings leading to seizure as considered so far. Then, it led to a new conclusion that heat is generated by the metal contact between the rolling elements and the inner and outer rings and the hardness of the bearing is lowered therewith to reach flaking and shorten the life.

Further, in the bearings for use in engine auxiliary equipments or bearings for use in automobile electrical components, it has been considered so far that the cause is vibrations by the engine but it is considered that only the vibrations is not the cause in the case of GHPA. That is, since GHPA is often operated under idling condition, the bearing for use in the solenoid clutch thereof is used at a lower rotational speed compared with the bearing for use in the engine auxiliary equipment or the bearing for use in the automobile electrical component. It is accordingly considered that the oil film forming performance is lowered and metal contact tends to be caused easily between the rolling elements and inner and the outer rings. Then, it has reached a new conclusion that heat is generated by the metal contact between the rolling elements and the inner and outer rings, the hardness of the bearing is lowered correspondingly to reach flaking accompanied by structural change to shorten the life.

Both in the bearing for supporting the pulley of the belt-type continuously variable transmission and the bearing for use in the solenoid clutch of GHPA, it is also one of factors for promoting the occurrence of early flaking that the lubrication condition becomes severer by the rise of the temperature of the bearing under the heat generation caused by metal contact tending to further cause the metal contact. Accordingly, it has reached a conclusion as the countermeasure for the defects described above that it is effective to constitute the bearing with a heat resistant steel thereby preventing the lowering of the hardness at high temperature.

While M50, etc. may be considered as the heat resistant steel, since C concentration is high in M50 and eutectic carbides of Cr, Mo and V are present in the stage of row material, the workability in the pretreatment is poor. Further, presence of the eutectic carbides results in a problem that stress is localized at the periphery of the carbides to result in flaking from the site as an initiation point to rather shorten the life.

Then, for solving the first subject described above, the present invention comprises the following constitution. That is, a rolling bearing according to the present invention has a feature in a rolling bearing in which plural rolling elements are arranged between a fixed ring and a rotational ring for use, wherein the center line average roughness for the raceway surface of at least the fixed ring in the fixed ring and the rotational ring is from 0.025 to 0.075 μm Ra.

In the rolling bearing, it is preferred that at least the fixed ring in the fixed ring and the rotational ring contains alloying ingredients at a ratio of from 0.50 to 1.20 mass % of carbon, from 0.10 to 1.50 mass % of silicon, from 0.1 to 2.0 mass % of manganese, from 3.0 to 6.0 mass % of chromium, 2.0 mass % or less of molybdenum and 1.0 mass % or less of vanadium.

Further, a rolling bearing according to the present invention also for solving the first subject has a feature in a rolling bearing in which plural rolling elements are arranged between a fixed ring and a rotational ring for use, wherein at least the fixed ring on the fixed ring and the rotational ring contains alloying ingredients at a ratio of from 0.50 to 1.20 mass % of carbon, from 0.10 to 1.50 mass % of silicon, from 0.1 to 2.0 mass % of manganese, from 3.0 to 6.0 mass % of chromium, 2.0 mass % or less of molybdenum and 1.0 mass % or less of vanadium.

The rolling bearings according to the present invention can be used for supporting pulleys in a belt-type continuously variable transmission.

Further, a rolling bearing according to the present invention also for solving the first subject has a feature in a rolling bearing which is used for supporting pulleys in a belt-type continuously variable transmission and in which plural rolling elements are arranged between a fixed ring and a rotational ring for use, wherein at least one of the fixed ring, the rotational ring and the rolling element is formed of a steel material containing alloying ingredients at a ratio of from 0.50 to 1.20 mass % of carbon, from 0.10 to 1.50 mass % of silicon, from 0.1 to 2.0 mass % of manganese, from 2.5 to 9.5 mass % of chromium, 2.0 mass % or less of molybdenum, and 1.0 mass % or less of vanadium, and the carbon content C %, the chromium content Cr %, the molybdenum content Mo % and the vanadium content V % satisfy the following formula:
C %≦−0.05×Cr %−0.12×(Mo %+V %)+1.41

Further, a rolling bearing according to the present invention also for solving the first subject has a feature in a rolling bearing which is used for an engine auxiliary equipment and in which plural rolling elements are arranged between a fixed ring and a rotational for use, wherein the center line average roughness for the raceway surface of at least the fixed ring in the fixed and the rotational ring is from 0.025 to 0.075 μmRa.

In the rolling bearing, it is preferred that at least the fixed ring in the fixed ring and the rotational ring contains alloying ingredients at a ratio of from 0.50 to 1.20 mass % of carbon, from 0.60 to 1.50 mass % of silicon, from 0.1 to 2.0 mass % of manganese, from 2.5 to 9.5 mass % of chromium, 2.0 mass % or less of molybdenum and 1.0 mass % or less of vanadium.

Further, a rolling bearing according to the invention also for solving the first subject has a feature in a rolling bearing which is used for an engine auxiliary equipment and in which plural rolling elements are arranged between a fixed ring and a rotational ring for use, wherein at least the fixed ring in the fixed ring and the rotational ring contains alloying ingredients at a ratio of from 0.50 to 1.20 mass % of carbon, from 0.60 to 1.50 mass % of silicon, from 0.1 to 2.0 mass % of manganese, from 2.5 to 9.5 mass % of chromium, 2.0 mass % or less of molybdenum and 1.0 mass % or less of vanadium.

Further, a rolling bearing according to the present invention also for solving the first subject has a feature in a rolling bearing in which plural rolling elements arranged between a fixing ring and a rotational ring are lubricated with a grease for use, wherein at least one of the fixed ring and the rotational ring is constituted with a steel material containing alloying ingredients at a ratio of from 0.50 to 1.20 mass % of carbon, from 0.60 to 1.50 mass % of silicon, from 0.1 to 2.0 mass % of manganese, from 2.5 to 9.5 mass % of chromium, 2.0 mass % or less of molybdenum and 1.0 mass % or less of vanadium.

Further, a rolling bearing according to the present invention also for solving the first subject has a feature in a rolling bearing in which plural rolling elements arranged between a fixing ring and a rotational ring are lubricated with a grease for use, wherein at least one of the fixed ring and the rotational ring is constituted with a steel material containing alloying ingredients at a ratio of from 0.50 to 1.20 mass % of carbon, from 0.60 to 1.50 mass % of silicon, from 0.1 to 2.0 mass % of manganese, from 2.5 to 9.5 mass % of chromium, 2.0 mass % or less of molybdenum and 1.0 mass % or less of vanadium and from 0.1 to 10 mass % of a conductive substance based on the entire amount is blended with a grease comprising a lubrication base oil and a thickening agent, and the grease is sealed.

The critical meaning in the present invention for solving the first subject is to be described below. (For center line average roughness for the raceway surface) In a case where the center line average roughness for the raceway surface exceeds 0.075 μmRa, metal contact between the bearing ring and the rolling element increases to rise the temperature by which flaking occurs to shorten the life. Further, in a case where the center line average roughness for the raceway surface is less than 0.025 μmRa, sliding of the rolling element increases, hydrogen is evolved by the formation of a fresh surface, or shear stress exerts on the grease or the oil to evolve hydrogen, thereby causing flaking accompanied by structural change. In order to make it possible to lower the degree of metal contact and suppress the sliding of the rolling element, the center line average roughness for the raceway surface is preferably from 0.025 to 0.075 μmRa and, more preferably, 0.030 to 0.060 μmRa.

(For Carbon Content)

Carbon C is necessary by 0.50 mass % in order to obtain a required hardness as the rolling bearing. In order to prevent mechanochemical structural change as described above, specifically, the structural change in which carbon C diffuses to cause whitening, stabilization in the microstructure is necessary. For this purpose, it is necessary to make the affinity strong between chromium Cr and carbon C and, for this purpose, it is required by 1.20 mass % or less. In a case where carbon C exceeds 1.20 mass %, carbon C is no more trapped to chromium Cr and carbon C diffuses easily to cause structural change. Further, it forms coarse eutectic carbides during steel making to result in lowering of the rolling life and shorten the life. In order to improve the cleanliness and prevent the eutectic carbides, it is desirable that the carbon C content is 0.50 mass % or more and 1.20 mass % or less.

(For Silicon Content)

Silicon Si is an element acting as a deoxidizing agent during steel making thereby improving the hardenability and strengthening martensite in the matrix material and this is an element effective to retard the structural change and prolong the bearing life. In a case where the silicon Si content is less than 0.10 mass %, such effects can not be obtained sufficiently and no desired hardness at high temperature can be maintained. Further, in a case where the silicon Si content exceeds 1.50 mass %, the machinability, the forgeability and the cold workability are remarkably deteriorated. Further, for preventing the structural changes by Si more reliably, it is preferred that the lower limit is 0.5 mass % and, more preferably, 0.60 mass %.

(For Manganese Content)

Manganese Mn is an element of strengthening ferrite in the steel to improve the hardenability and the effect is insufficient in a case where the content is less than 0.10 mass %. Further, in a case where the manganese content exceeds 2.0 mass %, the amount of the retained austenite after hardening is increased to lower the hardness and also deteriorate the cold workability.

(For Chromium Content)

Chromium Cr develops effects such as improvement of the hardenability, improvement of the resistance to temper softening and improvement of the wear resistance. In addition, this is an element of forming firm carbides and, at the same time, solid solubilizing into the matrix to prevent diffusion (whitening) of carbon C, stabilizing the structure and preventing the flaking accompanied by structural change.

In the present invention, the chromium Cr content is defined as 2.5 mass % or more. In a case where the chromium Cr content is less than 3.0 mass %, it may be a worry that the effects described above, particularly, prevention for the lowering of the hardness and flaking accompanied by structural change at high temperature can be not prevented. Further, while the chromium Cr content is defined as 9.5 mass % or less in the invention, in a case where the chromium Cr content exceeds 6.0 mass %, not only the effect of preventing the lowering of the hardness at high temperature or the effect of preventing the flaking accompanied by structural change are saturated but also it results in a problem of shortening the general life or deteriorating the machinability due to the generation of coarse carbides.

Then, by restricting the chromium Cr content to 6.0 mass % or less, since such problems can be avoided and the hardening temperature can be lowered by about 100° C., the heat treatment cost can also be reduced. Further, for preventing the flaking accompanied by structural change more reliably, it is desirable that the lower limit is 3.5 mass %. Further, for preventing coarse carbides more reliably, it is further preferred that the upper limit is 5.0 mass %.

(For Molybdenum Content)

Molybdenum Mo is an element having an effect of remarkably improving the hardenability and the resistance to temper softening and also contributing to the improvement of the rolling fatigue life. However, since the toughness and the workability are lowered when it is added in excess, it is defined as 2.0 mass % or less.

(For Vanadium Content)

Vanadium V is an element of forming fine carbides and having an effect of improving the wear resistance. Further, it is an element also forming carbides to develop the same effect as that of the chromium Cr. However, in a case where the vanadium V content exceeds 1.0 mass %, not only the effects described above are saturated but also it results in occurrence of coarse carbides or increases the material cost.

(For Formula:
C %≦−0.05×Cr %−0.12×(Mo %+V %)+1.41)

It is known that eutectic carbides are formed during steel making in a case where the concentrations for carbon C and chromium Cr are high. In a case where the eutectic carbides are present, workability in the pretreatment-is deteriorated. Further, presence of the eutectic carbides results in stress concentration at the periphery of the carbides to cause flaking at the site as an initiation point to rather shorten the life. In view of the above, the concentrations for carbon C and chromium Cr are restricted in accordance with the formula described above by using the concentrations for molybdenum Mo and vanadium V.

(For Content of Conductive substance)

In a case where the conductive substance exceeds 10 mass % based on the entire grease, the consistency of the grease is lowered and seizure occurs to shorten the life. Further, in a case where the electrocondutive material is less than 0.1 mass % based on the entire grease, electroconductivity is not reliable and a potential difference is formed between the inner ring and the outer ring to generate electric discharge. Therefore, hydrogen evolves to cause flaking accompanied by structural change. In the present invention, the content of the conductive substance in the entire grease is defined as 0.1 mass % or more and 10 mass % or less as a range of less causing seizure and making the electroconductivity reliable.

(II) In order to solve the second subject, the present invention comprises the following constitution. That is, a rolling bearing according to the present invention has a feature in a rolling bearing which is used for an engine auxiliary equipment or gas heat pump in which a compressor is driven by a gas engine and in which plural rolling elements arranged between a fixed ring and a rotational ring are lubricated with a grease for use, wherein at least one of the fixed ring, the rotational ring and the rolling elements is formed of a steel material containing alloying ingredients at a ratio of from 0.50 to 1.20 mass % of carbon, from 0.60 to 1.50 mass % of silicon, from 0.1 to 2.0 mass % of manganese, from 2.5 to 17.0 mass % of chromium, 2.0 mass % or less of molybdenum and 1.0 mass % or less of vanadium, and the carbon content C %, the chromium content Cr %, the molybdenum content Mo % and the vanadium content V % satisfy the following formula:
C %≦−0.05×Cr %−0.12×(Mo %+V %)+1.41

In the rolling bearing, the center line average roughness for the raceway surface of at least the fixed ring in the fixed ring, the rotational ring and the rolling element is preferably from 0.025 to 0.15 μmRa.

Further, at least the fixed ring in the fixed ring, the rotational ring and the rolling element is defined to a hardness of HRC preferably from 56 to 64 by hardening and tempering.

Further, a rolling bearing according to the present invention also for solving the second subject has a feature in a rolling bearing in which plural rolling elements arranged between a fixed ring and a rotational ring are lubricated by a grease for use, wherein the center line average roughness for the raceway surface of at least the fixed ring in the fixed ring and the rotational ring is from 0.01 to 0.08 μmRa and the skewness thereof is from −5.0 to −0.5.

In the rolling bearing, the viscosity of the base oil contained in the grease at 40° C. is preferably from 70 to 200 mm²/s.

Further, it is preferred that at least the fixed ring in the fixed ring, the rotational ring and the rolling element contains chromium at a ratio of 2.0 to 16.0 mass % as the alloying ingredient and is controlled to the hardness is controlled to HRC of from 56 to 64 by hardening and tempering.

Further, the grease is preferably blended with 0.1 to 10 mass % of a conductive substance based on the entire grease.

Further, it is preferred that the grease comprises a base oil and at least one kind of diurea compounds according to the following chemical formulae (1) to (3), a naphthenate salt, and succinic acid or a derivative thereof, in which the content of the diurea compound based on the entire grease satisfies the conditions represented by the following formulae (4) and (5), and the content of the naphthenate salt and the content of the succinic acid or the derivative thereof are 0.1 to 10 mass % based on the entire grease. 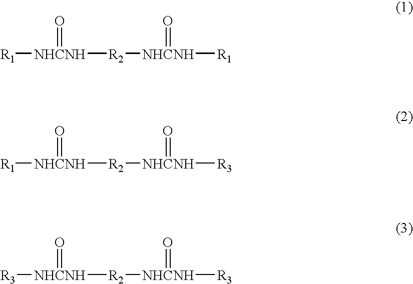
0≦W₁+W₂+W₃≦35 (4)
0≦(W₁+0.5×W₂)/(W₁+W₂+W₃)≦0.55 (5)

In the chemical formulae (1) to (3), R₁ represents a aromatic ring-containing hydrocarbon group (7 to 12 carbon atoms in total), R₂ represents a bivalent aromatic ring-containing hydrocarbon group (6 to 15 carbon atoms in total), and R₃ represents a cyclohexyl group or an alkylcyclohexyl group (7 to 12 carbon atoms in total).

Further, in the formula (4) and the formula (5), W₁, W₂, and W₃ each represents the content of the diurea compounds of the chemical formulae (1), (2) and (3) based on the entire grease (mass % unit).

Further, it is preferred that the grease preferably contains at least one of the metal compounds of the following chemical formulae (6) to (11) and the content is from 0.1 to 10 mass % based on the entire grease.

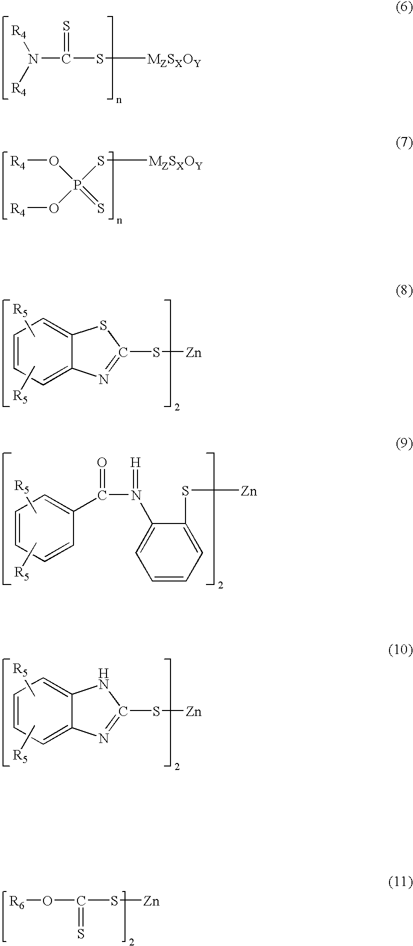

In the chemical formulae (6) and (7), R₄ represents a hydrocarbon group of 1 to 18 carbon atoms and M represents a metal. Further, n represents an integer of 2 to 4, x and y each represents an integer of 0 to 4 and z represents an integer of 1 to 4, respectively.

Further, in the chemical formulae (8) to (10), R₅ represents hydrogen or a hydrocarbon group of 1 to 18 carbon atoms and, in the chemical formula (11), R₆ represents hydrocarbon group of 1 to 18 carbon atoms.

Further, the grease preferably does not contain a sulfonate salt.

Furthermore, the average distance Sm between the concave/convex on the raceway surface is preferably from 3 to 50 μm.

The critical meaning of the present invention for solving the second subject is to be described.

(For Carbon Content)

Carbon has an effect of solid solublizing into a matrix and improving the hardness after hardening and tempering thereby improving the strength and it is necessary by 0.50 mass % for obtaining hardness required as the rolling bearing. For preventing the structural change described above, stabilization in the microstructure is necessary. For this purpose, it is necessary to make the affinity between chromium and carbon strong and, for this purpose, it is required by 1.20 mass % or less. In a case where carbon exceeds 1.20 mass %, carbon is no more fixed to chromium and carbon easily diffuses to cause structural change. In a case where the carbon content is excessive, it tends to form coarse eutectic carbides during steel making to sometimes bring about remarkable lowering in the fatigue life or strength. Further, the cold workability and the machinability is sometimes deteriorated to increase the fabricating cost.

(For Silicon Content)

Silicon is an element acting as a deoxidizing agent during steel making and effective for improving the hardenability, strengthening martensite in the base material and retarding the structural change to improve the bearing life. Further, it also has an effect of improving the resistance to temper softening, the dimensional stability and the heat resistance.

In a case where the silicon content is less than 0.10 mass %, no sufficient effects described above, particularly, the effect of retarding the structural change can be obtained and desired hardness at high temperature can not be maintained. Further, in a case where the silicon content exceeds 1.50 mass %, the machinability, the forgeability and the cold workability are remarkably deteriorated.

(For Manganese Content)

Manganese is an element necessary as a deoxidizing agent during steel making and improving the hardenability. In a case where the manganese content is less than 0.10 mass %, the effects are insufficient. Further, in a case where the manganese content exceeds 2.0 mass %, the starting temperature for martensitic transformations is lowered. Then, the amount of retained austenite after hardening is increased to lower the harness and also deteriorate the cold workability or the machinability.

(For Chromium Content)

Chromium solid solubilizes into the matrix material and develops effects of improving the hardenability, improving the resistance to temper softening and improving the wear resistance and corrosion resistance. In addition, it forms fine carbides to prevent growth of crystal grains during heat treatment, or strengthen the effect of trapping diffusing hydrogen intruded into the steel. Further, it is an element of forming firm carbides to stabilize the structure and preventing flaking accompanied by structural change.

In a case where the chromium content is less than 2.0 mass %, the effects described above become insufficient, particularly, the effect of trapping diffusive hydrogen is lowered to possibly make the effect of preventing flaking accompanied by structural change insufficient. Further, in a case where the chromium content exceeds 17.0 mass %, not only the effect of preventing the flaking accompanied by structural change is saturated, but also it results in a problem such as lowering of the general life, deterioration of the machinability and lowering of the strength due to the formation of coarse carbides. For suppressing such problems, the chromium content is more preferably from 2.5 to 16.0 mass %.

(For Molybdenum Content)

Molybdenum has an effect of solid solubilizing into a matrix material to remarkably improve the hardenability, the resistance to temper softening and the corrosion resistance. In addition, it has effects of forming fine carbides to prevent growth of crystal grains during heat treatment and enhance the fatigue life or wear resistance. Further, it has also an effect of stabilizing the structure to greatly suppress the structural change. With the reasons described above, molybdenum is added selectively within a permissible range in view of the cost.

However, if it is added in excess, this may sometimes lower the cold workability or the machinability to remarkably increase the cost, or coarse eutectic carbides are formed to sometimes greatly lower the fatigue life or the strength. Accordingly, the molybdenum content is, preferably, 3.0 mass % or less and, more preferably, 2.0 mass % or less in order to obtain favorable workability and toughness.

(For Vanadium Content)

Vanadium is a powerful carbide and nitride forming element and has an effect of forming fine carbides to remarkably improve the strength and the wear resistance. Further, it also has an effect of stabilizing the structure to greatly suppress the structural change. With the reasons described above, vanadium is added selectively within permissible range in view of the cost.

However, when it is added in excess, this may sometimes deteriorate the cold workability and the machinability to remarkably increase the cost, or coarse eutectic carbides are formed to sometimes greatly deteriorate the fatigue life or the strength. Accordingly, the vanadium content is, preferably, 2.0 mass % or less and more, preferably, 1.0 mass % or less in order to suppress formation of coarse carbides and increase of the cost.

(For Tungsten Content)

Tungsten is a powerful carbide and nitride forming element and has an effect of remarkably improving the strength and the wear resistance. Further it also has an effect of stabilizing the structure to greatly suppress the structural change. With the reasons described above, tungsten is added selectively within a permissible range in view of the cost.

However, when it is added in excess, it may sometimes deteriorate the cold workability or the machinability to remarkably increase the cost, or coarse eutectic carbides are formed to remarkably deteriorate the fatigue life or the strength.

(For other Alloying Ingredients and Inevitable Impurities)

Oxygen forms oxide type inclusions and titanium (Ti) forms titanium type inclusions to shorten the bearing life. Accordingly, the content thereof is preferably lower. It is preferred that oxygen is 20 ppm or less and titanium is 50 ppm or less. Further, phosphorus (P) or sulfur (S) may possibly cause undesired effects on the bearing life by segregation or forming sulfides to deteriorate the corrosion resistance if the content thereof is excessive. Accordingly, the content is preferably as low as possible and each of them is preferably 0.03 mass % or less.

(For the Formula:
C %≦−0.05×Cr %−0.12×(Mo %+V %)+1.41)

Defining the value for −0.05×Cr %−0.12×(Mo %+V %)+1.41, as α value, when α value is less than C %, eutectic carbides are formed and, accordingly, the general life of the bearing is lowered. Accordingly, it is necessary that α value is C % or more.

(For Content of Conductive Substance)

Since formation of hydrogen by the electric discharge described above can be suppressed by blending the conductive substance with the grease, it is preferred that carbon is blended, for example, by 0.1 to 10 mass %.

In a case where the conductive substance exceeds 10 mass % based an the entire grease, the consistency of the grease is lowered and seizure occurs to shorten the life. Further, in a case where the conductive substance is less than 0.1 mass % based on the entire grease, no reliable electroconductivity is obtained and a potential difference is formed between the inner ring and the outer ring to generate electric discharge. Therefore, hydrogen evolves to cause flaking accompanied by structural change. In the present invention, the content of the conductive substance in the entire grease is defined as 0.5 to 5 mass % in order to suppress seizure and obtain more reliable electroconductivity.

(For Viscosity of Grease Base Oil)

For the viscosity of the base oil used in the grease, in a case where the viscosity at 40° C. is 70 mm²/s or more, it has an effect of improving the bearing life and, particularly, improvement of life can be expected in a case where early flaking occurs. Then, taking the acoustic performance or torque at low temperature into consideration, the viscosity of the base oil at 40° C. is preferably from 70 to 200 mm²/s.

(For Surface Roughness for the Raceway Surface)

In a case where the center line average roughness for the raceway surface is less than 0.025 μmRa, rotation slip of the rolling element can not be suppressed. Then, the structural change described above occurs to cause early flaking. Further, in a case if it exceeds 0.075 μmRa, while the rotation slip of the rolling element can be suppressed, the oil film may possibly be not formed sufficiently since the raceway surface is excessively coarse. Then, the surface-originated flaking occurs to shorten the life of the bearing. In order to suppress such a problem, the center line average roughness for the raceway surface is preferably from 0.04 to 0.095 μmRa.

Further, for enhancing the effect of retaining oils at the surface of contact between the bearing ring and the rolling element or the effect of suppressing the discharge of static electricity to suppress the early flaking accompanied by structural change, it is preferred that the center line average roughness for the raceway surface is from 0.01 to 0.08 μmRa and the skewness thereof is defined as to a negative skewness of −5.0 to −0.5.

In a case where the conditions can not be compatible, no sufficient effect for retaining the oils on the surface of contact between the bearing ring and the rolling element or suppressing the electric discharge of static electricity can be obtained sufficiently, and suppression for the early flaking accompanied by structural change can not be expected sufficiently. In order to provide both of the effects to the utmost degree, it is more preferred to control the center line average roughness for the raceway surface to 0.02 to 0.06 μmRa, and control the skewness thereof to −5.0 to −1.0.

(For the Hardness of Bearing Ring and Rolling Element)

It is preferred to control the hardness of at least the fixed ring in the fixed ring, the rotational ring and the rolling element to HRC from 56 to 64. If the hardness HRC is less than 56, the flaking life is lowered and, on the other hand, if HRC exceeds 64, the workability is deteriorated. (III) For solving the third subject, the present invention comprises the following constitution. That is, the rolling bearing according to the present invention has a feature in a rolling bearing comprising an inner ring, an outer ring, and plural rolling elements arranged rotationally between the inner ring and the outer ring, wherein at least one of the inner ring, the outer ring and the rolling element is constituted with a steel satisfying the following three conditions.

Condition 1: it contains from 0.40 to 0.87 mass % of carbon, from 3.0 to 7.0 mass % of chromium, from 0.1 to 2.0 mass % of manganese, from 0.1 to 2.0 mass % of silicon, and from 0.03 to 0.2 mass % of N, and the balance of iron and inevitable impurities.

Condition 2: total content for carbon and nitrogen is from 0.5 to 0.9 mass %.

Condition 3: the carbon content C % and the chromium content Cr % satisfy the formula:
C %≦−0.05×Cr %+1.41.

Further, the rolling bearing according to the present invention for also solving the third subject has a feature in a rolling bearing comprising an inner ring, an outer ring and plural rolling elements arranged rotationally between the inner ring and the outer ring, wherein at least one of the inner ring, the outer ring and the rolling element is constituted with a steel satisfying the following three conditions.

Condition 1: it contains from 0.40 to 0.87 mass % of carbon, from 3.0 to 7.0 mass % of chromium, from 0.1 to 2.0 mass % of manganese, from 0.1 to 2.0 mass % of silicon, and from 0.03 to 0.2 mass % of nitrogen, containing at least one of 3.0 mass % or less of molybdenum, 2.0 mass % or less of vanadium, and 2.0 mass % or less of tungsten by 1.0 mass % or more in total with the balance of iron and inevitable impurities.

Condition 2: total content for carbon and nitrogen is from 0.5 to 0.9 mass %.

Condition 3: the carbon content C %, the chromium content Cr %, the molybdenum content Mo %, the vanadium content V %, and the tungsten content W% satisfy the formula:
C %≦−0.05×Cr %−0.12×(Mo %+V % 30 W %)+1.41.

The steel of the constitution described above less forms white structure even upon invasion of hydrogen atoms evolved by decomposition of water content intruded into the lubricant or decomposition of the lubricant itself. Accordingly, the rolling bearing in which at least one of the inner ring, the outer ring and the rolling element is constituted with the steel described above can be retained from flaking by the formation of the white structure even when it is used under the lubrication condition where the formation of oil films tends to become difficult due to high temperature, high speed, large vibration and heavy load and under the condition where the water content intrudes, so that the life is long.

Particularly, since the latter rolling bearing in the two rolling bearings for solving the subject is constituted with a steel containing at least one of molybdenum, vanadium and tungsten which is an element having a high effect for suppressing the formation of white structure, it has a longer life.

The critical meanings for each of the numerical values in the three conditions described above are to be explained.

(For Carbon Content)

Carbon (C) has an effect of solid solubilizing into a matrix and improving the hardness after hardening and tempering thereby improving the strength, as well as bonding with carbide forming elements such as chromium (Cr), molybdenum (Mo), vanadium (V), and tungsten (W) to form carbides, thereby improving the wear resistance.

In a case where the carbon content is less than 0.40 mass %, the amount of carbon solid solubilizing into the matrix becomes insufficient failing to ensure a sufficient hardness after hardening and tempering. On the other hand, in a case where the carbon content exceeds 0.87 mass %, coarse eutectic carbides tend to be formed during steel making to sometimes deteriorate the fatigue life or the strength remarkably, and the cold workability or the machinability is lowered to result in increase of the cost. In order to suppress such problems, the carbon content is more preferably from 0.5 to 0.8 mass %.

(For Chromium Content)

Chromium has an effect of solid solubilizing into a matrix to improve the hardenability, the resistance to temper softening and the corrosion resistance and, further, forming fine carbides to prevent growth of crystal grains during heat treatment thereby also improving the fatigue life characteristic and the wear resistance. Further, it is an element of also stabilizing the structure to greatly suppress the structural change to the white structure.

In order to provide such effects sufficiently, it is necessary that the chromium content is 3.0 mass % or more. However, in a case where the chromium content is excessive, it sometimes lowers the cold workability or the machinability to result in remarkable increase of the cost or macro eutectic carbides are formed to remarkably deteriorate the fatigue life or the strength, so that it should be 7.0 mass % or less. It is more preferably from 3.5 to 6.5 mass %.

(For Manganese Content)

Manganese (Mn) is an element necessary as a deoxidizing agent during steel making and it is necessary to be incorporated by 0.1 mass % or more. Further, it has an effect of solid solubilizing into a matrix to improve the hardenability like chromium. However, since addition of a great amount not only deteriorates the cold workability or the machinability but also sometimes lower the temperature for the start of martensitic transformation failing to obtain a sufficient hardness, it should be 2.0 mass % or less. It is more preferably from 0.1 to 0.5 mass %.

(For Silicon Content)

Silicon (Si) is an element necessary as a deoxidizing agent during steel making like manganese. Further, it is an element also effective to the improvement of the hardenability, strengthen the martensite in the matrix and improving the bearing life like chromium and manganese. Further, it also has an effect of improving the resistance to temper softening. In order to provide such effects sufficiently, it is necessary that the silicon content is 0.1 mass % or more.

However, in a case where it is added in excess of 2.0 mass %, the machinability, the forgeability or the cold workability is sometimes deteriorated. It is more preferably from 0.5 to 1.5 mass %.

(For Nitrogen Content)

Nitrogen (N), like carbon, has an effect of solid solubilizing into a matrix to improve the hardness after hardening and tempering thereby increasing the strength and improving the corrosion resistance. Further, since the nitrides contained in the material are finer than carbides which tend to be solubilized upon hardening, and nitrogen also has an effect of refining the carbides, it has an effect of providing stable hardenability. Further, since nitrogen is also an element of also promoting the formation of retained austenite, a stable amount of retained austenite can be ensured during hardening. In order to provide such effects sufficiently, it is necessary that the nitrogen content is 0.03 mass % or more.

However, since a great amount of addition forms bubbles in the course of solidification to introduce a great amount of voids in ingots to deteriorate the intactness of the material, it is necessary that the nitrogen content is 0.20 mass % or less. It is more preferably from 0.05 to 0.15 mass %.

(For Total Content of Carbon and Nitrogen)

In order to obtain a surface hardness HRC of 58 or more and a sufficient wear resistance after hardening and tempering, it is necessary that the content for carbon and nitrogen in total is 0.5 mass % or more. However, in a case where the content for carbon and nitrogen in total is excessive, the cold workability or the machinability is deteriorated, particularly, to result in increase of the cost, so that it has to be 0.9 mass % or less.

(For the Formula:
C %≦−0.05×Cr %+1.41)

Even in a case where each of the elements satisfies the suitable range respectively, when the content C % for carbon and the content Cr % for chromium as the carbide forming element do not satisfy the formula described above, coarse eutectic carbides are sometimes formed during steel making to remarkably deteriorate the fatigue life or the strength.

(For Molybdenum Content)

Molybdenum, like chromium, has an effect of solid solubilizing into a matrix to enhance the hardenability, the resistance to temper softening and the corrosion resistance. In addition, it has effects of forming fine carbides to prevent growth of crystal grains during heat treatment and also enhance the fatigue life and the wear resistance. Further, it is an element of also stabilizing the structure to greatly suppress the structural change to the white structure. With the reasons described above, it is selectively added within a permissible range in view of the cost.

However, if it is added in excess, this may sometimes lower the cold workability or the machinability to remarkably increase the cost or coarse eutectic carbides are formed to sometimes greatly lower the fatigue life or the strength. Accordingly, the upper limit has to be 3.0 mass %.

(For Vanadium Content)

Vanadium is a powerful carbide and nitride forming element and has an effect of improving the strength and the wear resistance remarkably. Further, it is an element of also stabilizing the structure to greatly suppress the structural change to the white structure. With the reasons described above, it is added selectively within a permissible range in view of the cost.

However, when it is added in excess, it may sometimes deteriorate the cold workability or the machinability to remarkably increase the cost, or coarse eutectic carbides are formed to greatly deteriorate the fatigue life or the strength, so that the upper limit has to be 2.0 mass %.

(For Tungsten Content)

Tungsten is a powerful carbide and nitride forming element and has an effect of remarkably improving the strength and the wear resistance. Further, it is an element of also stabilizing the structure to greatly suppress the structural change to the white structure. With the reasons described above, it is added selectively within a permissible range in view of the cost.

However, when it is added in excess, it may sometimes lower the cold workability or the machinability to result in remarkable increase in the cost, or coarse eutectic carbides are formed to remarkably deteriorate the fatigue life or the strength, so that the upper limit should be 2.0 mass % or less.

(For the Formula:
C %≦−0.05×Cr %−0.12×(Mo %+V %+W %)+1.41)

Even when each of the elements described above satisfies the suitable range respectively, if the carbon content C %, the chromium content Cr % as a carbide forming element, and the molybdenum, vanadium, and tungsten contents Mo %, V % and W % do not satisfy the formula described above, coarse eutectic carbides are sometimes formed during steel making thereby remarkably deteriorating the fatigue life and the strength.

(IV) The present inventors have made detailed investigations for test-interrupted protects and test-completed products in a flaking test and a seizure test on four-point contact rolling bearings for use in solenoid clutches as the example of multiple-point contact rolling bearings, and obtained the following conclusion.

That is, grinding traces on the raceway surface were scarcely present in the test-interrupted products and the test-completed products both for the flaking test and the seizure test. Further, the hardness on the extreme surface of the raceway surface was sometimes greatly lowered to Hv of 600 or less.

Then, the present inventors have found, for the cause of the short life due to the seizure of the four-point contact rolling bearing, that since the rolling elements and the inner and outer rings are put to metal contact at four points, they generate more heat compared with the rolling bearings of usual structure, which leads to seizure by the degradation of grease, or remarkable change of the size caused by heat generation leading to seizure by the decrease of the clearances.

Further, they had also reached a conclusion for the cause of the short life of the four-point contact rolling bearing by flaking, that since the rolling elements and the inner and outer rings are put to four point contact, the amount of heat generation increases and, correspondingly, the hardens of the bearing is lowered leading to flaking thereby shortening the life.

Since the cause both for the seizure and the flaking is attributable to the rise of bearing temperature by metal contact between the rolling elements and the inner and outer rings at four points, it has been found that the only one countermeasure for the early failure of the bearing it to use a heat resistant steel thereby improving the dimensional stability and preventing lowering of the hardness at high temperature.

While M50, etc. may be considered as the heat resistant steel, M50 involves the problem that workability in the pretreatment is poor since the C concentration is high and eutectic carbides of Cr. Mo and V are present in the stage of the raw material and, in addition, that existence of the eutectic carbides induces stress concentration at the periphery of the carbides to cause flaking from the site as the initiation point to rather shorten the life.

As the technique for preventing seizure accompanied by dimensional change, it may be considered to temper the bearing steel or the like at a high temperature to decrease the amount of retained austenite. However, sine lowering of hardness at high temperature is remarkable in the bearing steel including SUJ2, this additionally causes the problem of flaking, so that a drastic countermeasure is necessary.

In view of the above, for solving the fourth subject, the present invention comprises the following constitution. That is, the rolling bearing according to the present invention has a feature in a multiple-point contact rolling bearing in which plural rolling elements are arranged rotationally between an inner ring and an outer ring, wherein at least one of the inner ring, the outer ring and the rolling elements is formed of a steel material containing alloying ingredients at a ratio of from 0.50 to 1.20 mass % of carbon, from 0.10 to 1.50 mass % of silicon, from 0.1 to 2.0 mass % of manganese, from 2.5 to 17.0 mass % of chromium, 2.0 mass % or less of molybdenum, and 1.0 mass % or less of vanadium, and the carbon content C %, the chromium content Cr %, the molybdenum content Mo % and the vanadium content V % satisfy the following formula:
C %≦−0.05×Cr %−0.12×(Mo %+V %)+1.41

The function and the critical meanings for the content of contained elements used for the multiple-point contact rolling bearing according to the present invention for solving the fourth subject are to be described.

(For Carbon Content)

For obtaining a hardness required as the rolling bearing, carbon C is necessary by 0.50 mass %. On the other hand, if it is contained in excess of 1.20 mass %, since coarse eutectic carbides are formed during steel making to result in shortening of the rolling life, the life is shortened. Accordingly, for improving the cleanliness and preventing the eutectic carbides, the C content is defined as 0.50 mass % or more and 1.20 mass % or less.

(For Silicon Content)

Silicon Si is an element acting as a deoxidizing agent during steel making, improving the hardenability and strengthening the martensite in the matrix material and it is an element effective for prolonging the bearing life. In a case where the Si content is less than 0.10 mass %, the effects can not be obtained sufficiently and predetermined hardness at high temperature can not be maintained. Further, in a case where the Si content exceeds 1.50 mass %, the machinability, the forgeability and the cold workability are greatly deteriorated. Accordingly, the Si content is defined as 0.10 mass % or more and 1.50 mass % or less.

(For Manganese Content)

Manganese Mn is an element of strengthening ferrite in the steel and improving the hardenability. In a case where the Mn content is less than 0.10 mass %, the effect is insufficient. On the other hand, in a case where the Mn content exceeds 2.0 mass %, the amount of retained austenite after hardening increases to lower the hardness and also lowers the cold workability. Accordingly, the Mn content is defined as 0.10 mass % or more and 2.0 mass % or less.

(For Chromium Content)

Chromium Cr is an element of developing the effects such as improvement of the hardenability and the wear resistance, as well as improving the resistance to temper softening and preventing lowering of the hardness during high temperature use. In addition, it is an element of improving the dimensional stability during use at high temperature. In a case where the Cr content is less than 2.5 mass %, the effects described above, particularly, the effect of preventing the lowering of hardness and the effect of dimensional stability at high temperature are poor. Further, in a case where the Cr content exceeds 17.0 mass %, not only the effect of preventing the lowering of the hardness at high temperature is saturated but also it results in problems such shortening of general life due to the formation of coarse carbides or seizure due to the temperature rise in the bearing along with lowering of the heat conductivity. Accordingly, the Cr content is defined as 2.5 mass % or more and 17.0 mass % or less.

(For Molybdenum Content)

Molybdenum Mo is an element having an effect of remarkably increasing the hardenability and the resistance to temper softening and contributing to the improvement of the rolling fatigue life. However, in a case where it is added in excess, it lowers the toughness and the workability, so that it is restricted to 2.0 mass % or less.

(For Vanadium Content)

Vanadium V is an element of forming fine carbides and having an effect for improving the wear resistance. Further it is an element of also developing the effect described above by forming carbides. However, in a case where the V content exceeds 1.0 mass %, not only such effects are saturated but also it results in a problem such as formation of coarse carbides or increase in the material cost. Accordingly, the V content is restricted to 1.0 mass % or less.

(For Formula:
C %≦−0.05×Cr %−0.12×(Mo %+V %)+1.41)

It has been known that eutectic carbides are formed during steel making in a case where concentrations of C and Cr are high. Further, also the amount of Mo and V have an effect on the formation of eutectic carbides. Presence of the eutectic carbides worsens the workability in the pretreatment. Further, presence of the eutectic carbides results in a problem of inducing stress concentration at the periphery of the carbides thereby causing flaking from the site as the initiation point to rather shorten the life. In view of the above, it is conditioned that the C amount, the Cr amount, the Mo amount and the V amount satisfy the relation of the formula described above.

(V) For solving the fifth subject, the present invention comprises the following constitution. That is, a rolling bearing according to the present invention has a feature in a rolling bearing which is used for an engine auxiliary equipment or a gas heat pump in which the compressors is driven by a gas engine and in which plural rolling elements arranged between the fixed ring and the rotational ring are lubricated by a grease for use, wherein at least one of the fixed ring, the rotational ring and the rolling element is formed of a steel material containing alloying ingredients at a ratio of from 0.50 to 1.20 mass % of carbon, from 0.10 to 1.50 mass % of silicon, from 0.1 to 2.0 mass % of manganese, from 2.5 to 17.0 mass % of chromium, 2.0 mass % or less of molybdenum and 1.0 mass % or less of vanadium, in which the carbon content C %, the chromium content Cr %, the molybdenum content Mo %, and the vanadium content V % satisfy the following formula;
C %≦−0.05×Cr %−0.12−(Mo %+V %)+1.41

In the rolling bearing, it is preferred that the steel material described above has a sulfur content of 0.008 mass % or less, and the rating number for Thin type A-series inclusions is 1.5 or less and the rating number for Heavy type A-series inclusions is 1.0 or less according to the method specified in ASTM E45.

It is considered so far that flaking accompanied by structural change to the white structure is caused by hydrogen and it has been considered that hydrogen is evolved by the loading of shearing stress on lubricant. However, it has not yet been identified so far what is the initiation point for the white structure.

Then, when the present inventors have recalled bearings for use in alternators from the market, and investigated failed products suffering from flaking accompanied by structural change to the white structure specifically, the following conclusion has been obtained. That is, it has been found that hydrogen accumulated to the defects of the material, which forms the initiation point for the white structure. As the defects of the material, grain boundaries, inclusions, transformation, etc. may be considered and the present inventors have taken notice on the inclusions, particularly, MnS in the steel. Then, as a result of conducting the bearing life test, it has been found that the amount of S and distribution of MnS give a significant effect on the flaking accompanied by structural change to the white structure.

The mechanism of causing the structural change to the white structures is as described below. That is, MnS present near the maximum shearing stress position takes place chemical reaction with hydrogen evolved from the grease and diffused in the steel, to form hydrogen sulfide, and hydrogen sulfide forms the white structure. For obtaining a long-life bearing of less causing such defects, it is important to use a steel containing a great amount of Cr as an element for retarding the structural change and with less defects forming the initiation point for the white structure. Accordingly, it is necessary to define the amount of S and the distribution of MnS in the steel.

The high alloy steel includes, for example, M50 but M50 has poor workability in the pretreatment since the carbon content is high and eutectic carbides of Cr, Mo and V are present in the stage of the raw material. Further, since stresses are localized at the periphery of the eutectic carbides to form initiation points for flaking, they cause shortening of the life.

The critical meanings in the present invention for solving the fifth subject is to be described.

(For Carbon Content)

Carbon has an effect of solid solubilizing into a matrix material and improving the hardness after hardening and tempering thereby improving strength and it is necessary by 0.50 mass % for obtaining a hardness required as the rolling bearing. On the other hand, in a case where the carbon content exceeds 1.20 mass %, it tends to form coarse eutectic carbides during steel making to sometimes result in shortening of the rolling life.

(For Silicon Content)

Since silicon acts as a deoxidizing agent during steel making thereby improving the hardenability and strengthening the martensite in the matrix material, it is an element effective for prolonging the bearing life.

Further, it has also an effect of improving the resistance to temper softening, the dimensional stability and the heat resistance.

In a case where the silicon content is less than 0.10 mass %, no sufficient effects can be obtained and predetermined hardness at high temperature can not be maintained. Further, in a case where the silicon content exceeds 1.50 mass %, the machinability, the forgeability, and the cold workability are remarkably deteriorated.

(For Manganese Content)

Manganese is an element of strengthening the ferrite in the steel and improving the hardenability. In a case where the manganese content is less than 0.10 mass %, the effect is insufficient. Further, in a case where the manganese content exceeds 2.0 mass %, the starting temperature for martensitic transformation is lowered. Then, the amount of retained austenite after hardening increases to lower the hardness and also deteriorate the cold workability and the machinability.

(For Chromium Content)

Chromium solid solubilizes into the matrix material to develop effects such as improvement of the hardenability, the wear resistance and the corrosion resistance. Further, it improves the resistance to temper softening and prevents lowering of the hardness at high temperature.

In a case where the chromium content is less than 2.5 mass %, the effects described above are insufficient and the hardness tends to be lowered particularly at high temperature. Further, in a case where the chromium content exceeds 17.0 mass %, not only the effect of preventing the lowering of the hardness at high temperature is saturated, but also it results in a problem such as shortening of the general life and deterioration of the machinability due to the formation of coarse carbides.

(For Molybdenum Content)

Molybdenum has an effect of solid solubilizing into the matrix material and remarkably improving the hardenability, the resistance to temper softening and the corrosion resistance. In addition, it has also an effect of improving the fatigue life or wear resistance. However, in a case where it is added in excess, the toughness and the workability are deteriorated to cause remarkable increase of the cost, so that the molybdenum content is restricted preferably to 2.0 mass % or less.

(For Vanadium Content)

Vanadium is a powerful carbide and nitride forming element and has an effect of forming fine carbides thereby remarkably improving the strength and the wear resistance. However, in a case where it is added in excess, not only the such effects are saturated but also it results in remarkable increase of the cost or forms coarse eutectic carbides to sometimes lower the fatigue life or the strength remarkably. Accordingly, vanadium content is preferably restricted to 1.0 mass % or less.

(For Formula:
C %≦−0.05×Cr %−0.12×(Mo %+V %)+1.41)

It has been known that eutectic carbides are formed during steel making when the carbon concentration and the chromium concentration are high. Presence of the eutectic carbides deteriorates the workability in the pretreatment. Further, when the eutectic carbides are present, stresses are localized at the periphery thereof to cause a problem that flaking occurs at the site as the initiation point to rater shorten the life. In view of the above, the carbon concentration and the chromium concentration are defined by the formula described above by using the molybdenum concentration and the vanadium concentration.

(For Sulfur Content and Rating Number of A-Series Inclusions)

Sulfur is an impurity contained in the steel and it is usually present as A-series inclusion such as MnS in the steel. Further, the A-series inclusions act as a chip breaker to improve the machinability of the steel and is often utilized effectively. It has also been considered so far that the A-series inclusions give no so large effect on the bearing life compared with the B-series inclusion or the D-series inclusions.

However, in a case where the bearing is used under specified conditions such as high temperature, large vibration, high speed and heavy load, hydrogen evolved from the grease and MnS present at the maximum shearing position take place chemical reaction to form the white structure thereby possibly shortening the life remarkably.

The present inventors have found that the A series inclusions in the steel are preferably defined as described below for suppressing the early flaking accompanied by structural change to the white structure, thereby making the bearing life longer. That is, it has been found that the rating number for the Heavy type A-series inclusions among the A-series inclusions is preferably defined as 1.0 or less according to the method of ASTM E45. For this purpose, it is necessary to decrease the amount of S in the steel to 0.008 mass % or less, thereby decreasing the amount of sulfides as the A-series inclusions.

However, as the A-sires inclusions are larger, reactivity with hydrogen becomes higher. Further, since the A-series inclusions are soft and have no strength durable to the shearing stress, the shearing stress per unit area increases in the vicinity of the A-series inclusions tending to cause plastic flow and form the white structure. Accordingly, it is preferred that the rating number for the Thin type A-series inclusions is 1.5 or less and the rating number for the Heavy type A-series inclusions is 1.0 or less according to the method of ASTM E 45.

### BRIEF DESCRIPTION OF THE DRAWINGS

FIG. 1 is a view showing a structure of a compressor of an existent car air conditioner.

FIG. 2 is a vertical cross sectional view showing an embodiment of a rolling bearing according to the present invention for solving the first subject.

FIG. 3 is a schematic constitutional view for a cantilever type life testing apparatus.

FIG. 4 is a constitutional view for a belt-type continuously variable transmission.

FIG. 5 is an explanatory view showing a relation between the center line average roughness for the raceway surface and the life-time in a test by the cantilever type life testing apparatus.

FIG. 6 is a graph showing a relation between the center line average roughness for the raceway surface and the life time in a test by a belt-type continuously variable transmission.

FIG. 7 is a graph showing a relation between the amount of C and the life time in a test by the belt-type continuously variable transmission.

FIG. 8 is a graph showing a relation between the amount of Cr and the life time in a test by the belt-type continuously variable transmission.

FIG. 9 is a constitutional view of an alternator.

FIG. 10 is an explanatory view showing a relation between the center line average roughness for the raceway surface and the life time in a test by a cantilever type life testing apparatus.

FIG. 11 is a graph showing a relation between the center line average roughness for the raceway surface and the life time in a test by an alternator.

FIG. 12 is a graph showing a relation between the amount of C and the life time in a test by the alternator.

FIG. 13 is a graph showing a relation between the amount of C and the life time in a flaking test.

FIG. 14 is a graph showing a relation between the amount of Cr and the life time in a flaking test.

FIG. 15 is a graph showing a relation between the amount of the conductive substance and the life time in the flaking test.

FIG. 16 is a graph showing a relation between the amount of the conductive substance and the life time in the seizure test.

FIG. 17 is a graph showing a relation between the center line average roughness for the raceway surface and the life time in a flaking reproducing test.

FIG. 18 is a graph showing a relation between the amount of Cr and the life time in the flaking reproducing test.

FIG. 19 is a graph showing a relation between the blending amount of the conductive substance and the life time in the flaking test.

FIG. 20 is a graph showing a relation between the blending amount of the conductive substance and the life time in the seizure test.

FIG. 21 is a vertical cross sectional view showing an embodiment of a rolling bearing according to the present invention for solving a second subject,

FIG. 22 is a chart showing the result of measurement of the center line average roughness for the raceway surface of an outer ring.

FIG. 23 is a constitutional view for a grease lubrication life tester.

FIG. 24 is a graph showing a relation between the skewness on the raceway surface and the life time of the bearing.

FIG. 25 is a graph showing the relation between the amount of Cr and the flaking life and the seizure life of bearings.

FIG. 26 is a graph showing a relation between the content of diurea compound in a grease and the seizure life of bearings.

FIG. 27 is a graph showing a relation between the addition amount of zinc naphthenate in a grease and the flaking life and the rust preventive property of bearings.

FIG. 28 is a graph showing a relation between the addition amount of a succinic ester in a grease and the flaking life and the rust preventive property of bearings.

FIG. 29 is a graph showing a relation between the addition amount of ZnDTP in a grease and the flaking life and the rust preventive property of bearings.

FIG. 30 is a graph showing a relation between the center line average roughness for the raceway surface and the life time in a test by the cantilever type life testing apparatus.

FIG. 31 is a graph showing a relation between the center line average roughness for the raceway surface and the life time in life test by an actual alternator test.

FIG. 32 is a graph showing a relation between the center line average roughness for the raceway surface and the flaking life of bearings.

FIG. 33 is a graph showing a relation between the average distance Sm for the concave/convex on the raceway surface and the flaking life of the bearing.

FIG. 34 is a graph showing a relation between the amount of Cr and the flaking life of the bearing.

FIG. 35 is a schematic view showing a structure of a tester used for an oil bath lubrication life test.

FIG. 36 is a view showing the structure of a compressor of a car air conditioner used in the life test of a four-point contact deep groove ball bearing.

FIG. 37 is a graph showing a relation between the amount of Cr and the flaking life of a bearing.

FIG. 38 is a graph showing a relation between the amount of Cr and the seizure life of a bearing.

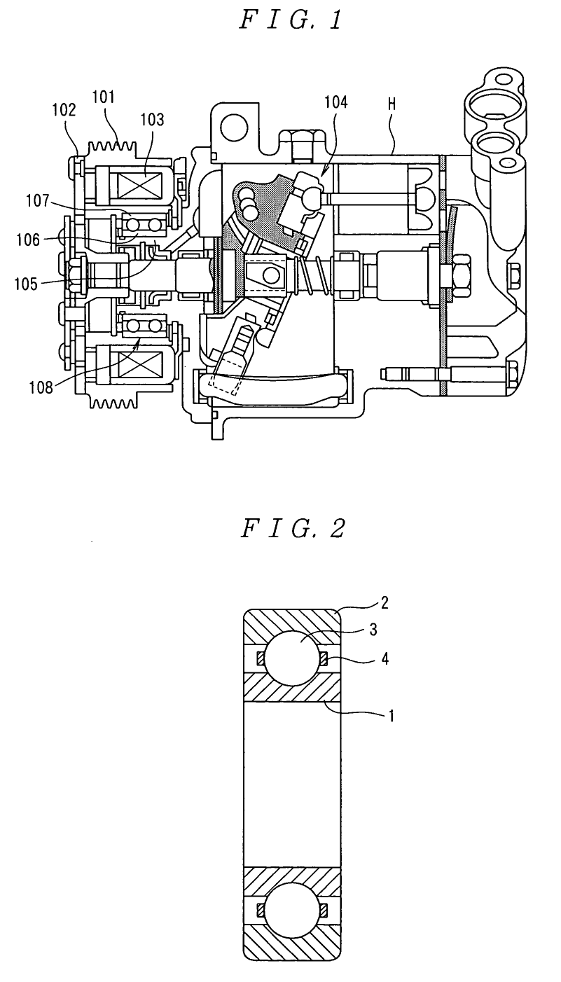

### BEST MODE FOR PRACTICING THE INVENTION

Embodiments of the present invention are to be described specifically with reference to the drawings. The embodiments show the example of the present invention but the present invention is not restricted to the embodiments.

### (I) For Preferred Embodiment of the Present Invention Solving the First Subject Described Above

At first, a first embodiment of a rolling bearing prepared for supporting pulleys in a belt-type continuously variable transmission is to be described.

FIG. 2 is a cross sectional view of a rolling bearing of the embodiment. The rolling bearing is a deep groove ball bearing having an inner ring 1 as a rotational ring and an outer ring 2 as a fixed ring, reference 3 denoting a rolling element and reference 4 denoting a cage.

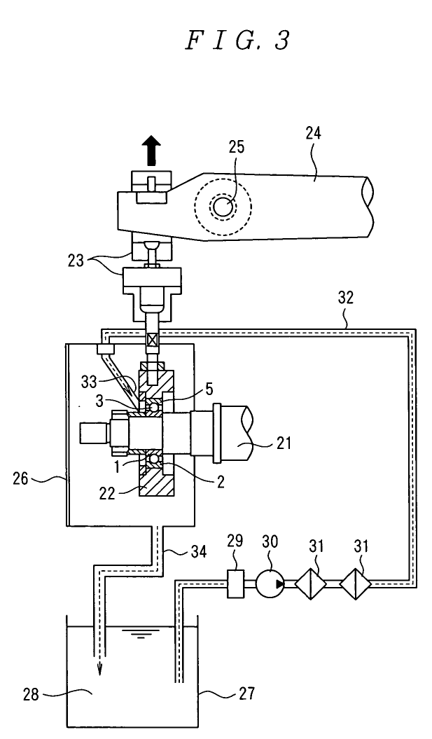

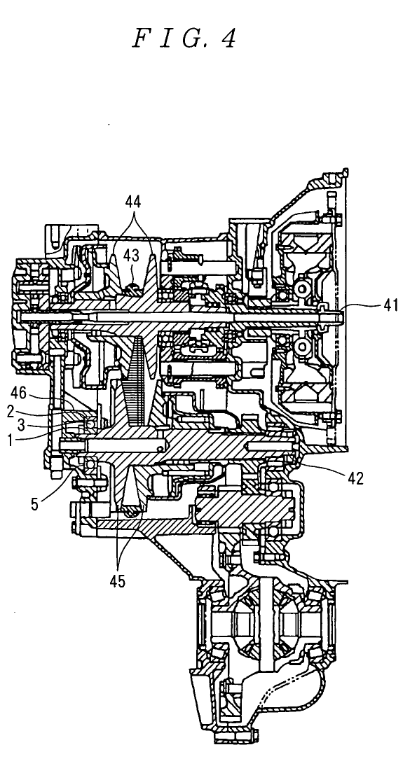

Using the rolling bearing, a life test was conducted while variously changing the center line average roughness for the raceway surface. For the life test, a cantilever type life testing apparatus shown in FIG. 3 and a belt-type continuously variable transmission shown in FIG. 4 were used in which rolling bearings of examples and comparative examples were assembled respectively, to conduct a life test. Both for the rolling bearings of the examples and the comparative examples, bearing steel, 2nd class (SUJ2) was used for the inner ring 1, the outer ring 2, the rolling element 3 and, after being formed into a predetermined shape, applied with hardening under heating at 830 to 880° C., oil cooling and then tempering at 180 to 240° C. It was controlled such that the surface hardness HRC was from 57 to 64, the amount of retained austenite was from 0 to 20% for the inner and the outer rings and the rolling element and the surface roughness for the rolling element was from 0.003 to 0.010 μmRa.

At first, the cantilever type life testing apparatus shown in FIG. 3 is to be described. The cantilever type life testing apparatus has a motor driven shaft 21 and a housing 22 in which the inner ring 1 of a rolling bearing 5 is fit to the shaft 21 and the outer ring 2 of the rolling bearing 5 is fit into a through hole of the housing 22. When the shaft 21 is rotated in this state, the inner ring 1 rotates as the rotational ring, and the outer ring 2 is fixed to the housing as the fixed ring, and the rolling elements move under rolling.

The housing 22 containing the rolling bearing 5 is connected by way of a shaft 23 to a lever 24. When the lever 24 is rotated around a horizontal shaft 25, the shaft 23 is raised upward, by which a radial load is loaded on the rolling bearing 5 by way of the housing 22.

The housing 22 is contained in a chamber 26. A lubricant 28 in a lubricant tank 27 is supplied by way of a flow meter 29, a pump 30 and a filter 31 to a lubricant channel 32, and supplied from a lubricant supply channel 33 in the chamber 26 to the rolling bearing 5. The lubricant in the chamber 26 is recovered from a return channel 34 to the lubricant tank 27.

Using the cantilever type life testing apparatus, a life test was conducted at a rotational speed of 3900 min⁻¹. The tested bearing was JIS bearing designation 6206 (30 mm inner diameter, 62 mm outer diameter, 16 mm width), the bearing clearance was 10 to 15 μm, the loading condition was at: applied load/dynamic load rating (P/C)=0.30, and the testing temperature was set constant at 80° C. Further, Fluid: NS-1 for use in continuously variable transmission (manufactured by Showa Shell Petroleum Co. Ltd.)was used for the lubricant.

Then, a belt-type continuously variable transmission shown in FIG. 4 is to be described above. In the belt-type continuously variable transmission, a belt 43 laid between an input shaft 41 and an output shaft 42 was wound over pulleys 44 and 45, and the groove width for the pulleys 44 and 45 are changed continuously thereby changing the radius of contact between the belt and the pulley to change the speed changing ratio steplessly as described, for example, in Japanese Unexamined Patent Publication No. Hei 10-202859. In the life test, the inner ring 1 of the rolling bearing 5 was fitted as the rotational ring to the left in the drawing, that is, on the front side of the output shaft 42 for supporting the pulley 45 (secondary pulley) on the output of the belt-type continuously variable transmission, while the outer ring 2 of the rolling bearing 5 is fitted as the fixed ring into the concave portion of the housing 46. Thus, rolling elements 3 moves under rolling when the output shaft 42 rotates.

Using the belt-type continuously variable transmission, a life test was conducted at a rotational speed of 500 to 3500 min⁻¹. As the tested bearing, a deep groove ball bearing of 40 mm inner diameter, 90 mm outer diameter and 19 mm width was used and adapted such that the bearing clearance was 10 to 15 Mm, the load condition was at: applied load/dynamic load rating (P/C)=0.17, and a testing temperature was set constant at 130° C. Further, Fluid: NS-1 for use in continuously variable transmission (manufactured by Showa Shell Petroleum Co. Ltd.) was used for the lubricant. The lubricant was supplied by way of a predetermined lubrication channel to the bearing 5.

In the life test, rolling bearings of Examples a to f having the center average roughness for the raceway surface within the recommended range described above, and rolling bearings of Comparative Examples g to j out of the recommended range were provided, which are attached to the cantilever type life testing apparatus shown in FIG. 3 and the belt-type continuously variable transmission shown in FIG. 4 respectively to conduct the life test. Table 1 shows the center line average roughness for the raceway surface for them and the result of the life test (CVT in the table shows the continuously variable transmission).

TABLE 1

L₁₀ life (hr)

| | | | Cantilever | |
|---|---|---|---|---|
| | | Surface | type life | Actual |
| | Test | Roughness | testing | belt-type |
| | piece | (μmRa) | apparatus | CVT test |
| Example | a | 0.025 | 180 | 550 |
| | b | 0.03 | 130 | 590 |
| | c | 0.04 | 105 | 630 |
| | d | 0.05 | 90 | 590 |
| | e | 0.06 | 54 | 560 |
| | f | 0.075 | 33 | 510 |
| Comp. | g | 0.01 | 230 | 280 |
| Example | h | 0.015 | 220 | 320 |
| | i | 0.08 | 27 | 290 |
| | j | 0.1 | 20 | 120 |

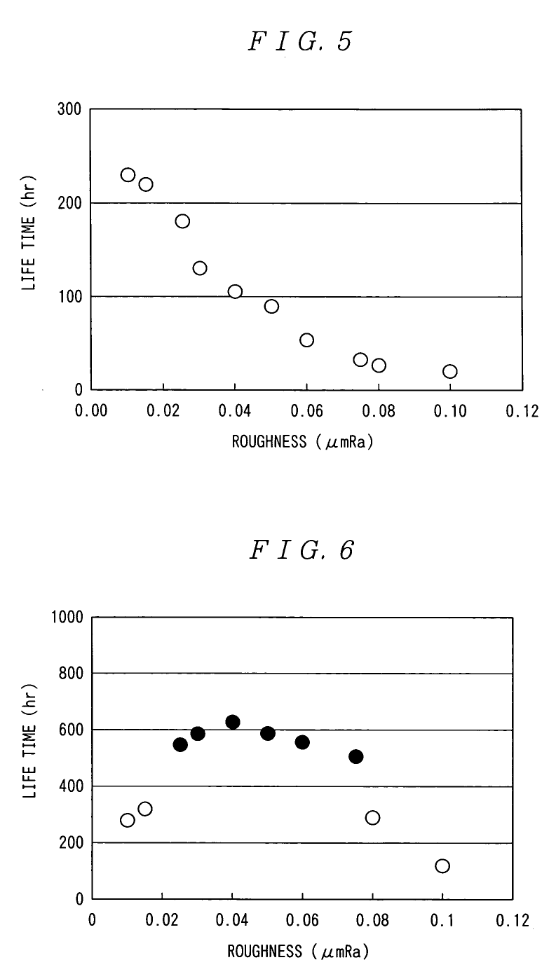

Among them, FIG. 5 shows a relation between the life time in the life test by the cantilever type life testing apparatus and the center line average roughness for the raceway surface. As apparent from the drawing, the life tends to be longer as the center line average roughness for the raceway surface is smaller under usual working conditions as in the cantilever type life testing apparatus. This is considered that the oil film parameter increases by making the raceway surface smooth and the disconnection of the oil film is suppressed to lower the degree of metal contact between the inner and outer rings and the rolling element.

On the contrary, FIG. 6 shows a relation between the life time in the life test by the belt-type continuously variable transmission and the center line average roughness for the raceway surface. As apparent from the drawing, the life is short in Comparative Example g (=0.01 μmRa), Comparative Example h (=0.015 μmRa) with smaller center line average roughness for the raceway surface and Comparative Example i (=0.08 μmRa), and Comparative Example j (=0.1 μmRa) with larger center line average roughness for the raceway surface. The life is longer for each of examples between them, that is, those having the center line average roughness for raceway surface of from 0.025 to 0.075 μmRa.

Among them, in the region with the center average roughness for the raceway surface of less than 0.025 μmRa, sliding of rolling elements increases, hydrogen evolves by the formation of fresh surface or hydrogen evolves concerned with the shearing stress exerting on the grease or oil. Then, it is considered that since they caused flaking accompanied by structural change, the life was shortened. Further, in a region where the center line average roughness for the raceway surface exceeds 0.075 μmRa, it is considered that the life was shortened since the metal contact increased between the inner and outer rings and the rolling elements to cause usual flaking. Accordingly, the center line average roughness for the raceway surface is defined as from 0.025 to 0.075 μmRa, preferably, from 0.03 to 0.06 μmRa in this embodiment.

Then, as shown in the following Table 2, Examples A-H containing the chemical ingredients of steel materials for the bearing rings within the recommended range of the invention and Comparative Examples I to N containing them outside of the recommended range of the invention were provided and rolling bearings for the life test by the belt type continuously varying transmission were manufactured. Numeral values with underlines in the table are for the ingredients out of the recommended range of the invention. Meanings for the underlines attached to the numerical values are also identical for all of the tables in the present specification.

TABLE 2

| | Tested | Steel composition (mass %) | | | | | |
|---|---|---|---|---|---|---|---|
| | material | C | Si | Mn | Cr | Mo | V |
| Example | A | 1.00 | 0.20 | 0.50 | 3.00 | 0.20 | 0.20 |
| | B | 0.50 | 1.0 | 0.40 | 3.50 | | |
| | C | 0.80 | 0.50 | 1.0 | 4.00 | 2.00 | |
| | D | 0.60 | 0.50 | 0.50 | 4.00 | 0.40 | |
| | E | 0.70 | 1.50 | 0.20 | 4.50 | | 0.20 |
| | F | 0.50 | 1.00 | 0.50 | 5.00 | 0.50 | |
| | G | 0.60 | 0.75 | 0.80 | 6.00 | 0.10 | |
| | H | 1.20 | 1.0 | 0.40 | 6.00 | 0.50 | 1.0 |
| Comp. | I | 0.95 | 0.35 | 0.38 | 1.45 | | |
| Example | J | 0.95 | 0.35 | 0.38 | 1.45 | 0.50 | 0.20 |
| | K | 0.80 | 0.50 | 0.40 | 2.50 | 0.50 | |
| | L | 0.45 | 1.0 | 0.50 | 6.50 | 1.00 | 0.50 |
| | M | 0.40 | 1.00 | 0.40 | 4.50 | 0.50 | 0.20 |
| | N | 1.30 | 0.80 | 0.80 | 5.00 | 0.50 | 0.20 |

After forming the steel materials of the compositions described above into the shape of rolling bearings for the life test by the belt type continuously varying transmission and applying dip hardening, they were finished by grinding. In this case, the center line average roughness for the raceway surface was within a range from 0.015 to 0.08 mRa as shown in Table 3 by varying the grinding condition. Further, SUJ2 was used for the rolling element, the surface hardness was HRC from 57 to 64, the amount of retained austenite was set to 0 to 20% for the inner and outer rings and the rolling element, and the surface roughness of the rolling element was from 0.003 to 0.020 μmRa. Further, UMM grease was used for the grease to be sealed in the rolling bearing.

The result of the life test is also shown together in Table 3. The test conditions are identical with those described above. Since the calculated life is 1567 hours, termination time was defined as 1500 hours and when vibrations increased up to five times as large as the initial vibratons, it was defined as the life time. The number of the test specimens was determined each by the number of 10 and L₁₀ life was determined based on the result of test specimens by the number of 10. When all the test specimens by the number of 10 did not cause abnormality such as seizure or flaking till the termination time, the L₁₀ life was defined as 1500 hours.

TABLE 3

| | | | Surface | |
|---|---|---|---|---|
| | Test | Tested | roughness | L₁₀ life |
| | piece | material | (μmRa) | (hr) |
| Example | 1 | A | 0.04 | 1290 |
| | 2 | B | 0.025 | 1500 |
| | 3 | C | 0.05 | 1420 |
| | 4 | D | 0.04 | 1500 |
| | 5 | E | 0.05 | 1500 |
| | 6 | F | 0.05 | 1500 |
| | 7 | G | 0.07 | 1480 |
| | 8 | H | 0.05 | 1220 |
| Comp. | 1 | I | 0.015 | 320 |
| Example | 2 | I | 0.04 | 630 |
| | 3 | J | 0.07 | 460 |
| | 4 | K | 0.035 | 760 |
| | 5 | L | 0.05 | 580 |
| | 6 | M | 0.04 | 610 |
| | 7 | N | 0.025 | 560 |
| | 8 | B | 0.08 | 470 |
| | 9 | D | 0.015 | 1080 |
| | 10 | G | 0.02 | 940 |

In the Table 3, Examples 2 and Examples 4 to 6 in which L₁₀ life was termination time were manufactured by tested materials of Examples B, and D to F and the amount of C was from 0.5 to 0.7 mass %, the amount of Si was from 0.5 to 1.5 mass %, and the amount of Cr was 3.5 to 5.0 mass %, each being within the recommended range, and the center line average roughness for the raceway surface was within the recommended range of from 0.025 to 0.075 μmRa in each of the examples.

Example 1 was manufactured from example tested material A and, while the amount of C was 1.0 mass %, the amount of Cr was 3.0 mass % and the center line average roughness for the raceway surface was 0.04 mRa which was within the recommended range of the invention, flaking accompanied by structural change was caused in 2 out of 10 since the amount of Si and the amount of Cr were somewhat lower compared with those of Examples 2, 4 to 6. However, they showed twice long time compared with Comparative Example 2 (equal with the center line average roughness for the raceway surface=0.04 μmRa) made of SUJ2 (Cr amount: 1.5 mass %) to be described later.

Example 3 was manufactured from the example tested material C in which the amount of C was 0.08 mass %, the amount of Cr was 4.0 mass % and the center line average roughness for the raceway surface was 0.05 μmRa which were within the recommended range of the invention. However, when compared with Examples 2, 4 to 6, since the amount of C was larger and fixing for C was somewhat lowered, flaking occurred in one out of 10 and the L₁₀ life was 1420 hrs.

Examples 7 and 8 were prepared from example tested materials G, H in which the amount of C was 0.6 mass %, 1.2 mass %, and the amount of Cr was 6.0 mass % in both of them, and the center line average roughness for the raceway surface was 0.07 μmRa and 0.05 μmRa, respectively. Since the amount of Cr was high in any of them, while flaking accompanied by structural change did not occur, flaking originated from eutectic carbides occurred and the L₁₀ life was 1480 hrs and 1220 hrs, respectively.

Comparative Examples 1 and 2 were manufactured from bearing steel, 2nd class (SUJ2) . While the center line average roughness for the raceway surface was 0.04 μmRa within the recommended range of the invention in Comparative Example 2, the center line average roughness for the raceway surface was 0.015 μmRa which was at about the surface roughness of a usual bearing in Comparative Example 1. Particularly, Comparative Example 1 could not suppress the rotation slip of the rolling element to cause flaking accompanied by structural change since the amount of Cr was not appropriate and the center line average roughness for the raceway surface was neither appropriate, and the L₁₀ life was 320 hrs. Further, Comparative Example 2 showed a longer life by so much as the center line average roughness for the raceway surface was within the recommended range of the invention and the L₁₀ life was 630 hrs.

Comparative Example 3 was manufactured from comparative example tested material J with addition of Mo and V to the steel material, 2nd class (SUJ2) and the rotation slip of the rolling element could be suppressed with the center line average roughness for the raceway surface being 0.07 μmRa. However, since the amount of Cr was as low as 1.45 mass %, it caused flaking accompanied by structural change and the L₁₀ life was 460 hrs.

Comparative Example 4 was manufactured from comparative tested material K and the rotation slip of the rolling element could be suppressed with the center line average roughness for the raceway surface being 0.035 I Ra. However, since the amount of Cr was also lower as 2.5 mass % compared with each of the examples, it caused flaking accompanied by structural change and the L₁₀ life was 760 hrs.

Comparative Example 5 was manufactured from comparative test material L and rotation slip of the rolling element could be suppressed with the center line average roughness for the raceway surface being 0.05 μmRa. However, Cr was as high as 6.5 mass %, and it caused flaking being originated from eutectic carbides and the L₁₀ life was 580 hrs.

Comparative Example 6 was manufactured from comparative tested material M in which the amount of C was 0.40 mass %, the amount of Cr was 4.5 mass %, and the center line average roughness for the raceway surface was 0.04 μmRa. While the rotation slip of the rolling element could be suppressed under the effect of the center line average roughness for the raceway surface, since the amount of C was as low as 0.4 mass %, hardness required as the bearing could not be obtained and the L₁₀ life was 610 hrs.

Comparative Example 7 was manufactured from comparative example tested material N and the rotation slip of the rolling element could be suppressed with the center line average roughness for the raceway surface being 0.025 μmRa. However, since the amount of C was high, fixing of C was lowered and the L₁₀ life was 560 hrs.

Comparative Examples 8 to 10 were within the recommended range of the invention for the compositional ingredients as shown in Table 2. However, since the center line average roughness for the raceway surface of Comparative Example 8 was 0.08 μmRa, metal contact increased between the inner and outer rings and the rolling element to cause flaking and the L₁₀ life was 470 hrs. Further, since the center line average roughness for the raceway surface was 0.015 μmRa and 0.02 μmRa, respectively, in Comparative Examples 9 and 10, flaking accompanied by structural change occurred in 2 and 3 out of 10, respectively, and the L₁₀ life was 1080 hrs and 940 hrs respectively. However, when compared with Comparative Example 1 made of SUJ2, the life was as long as 3 to 4 times.

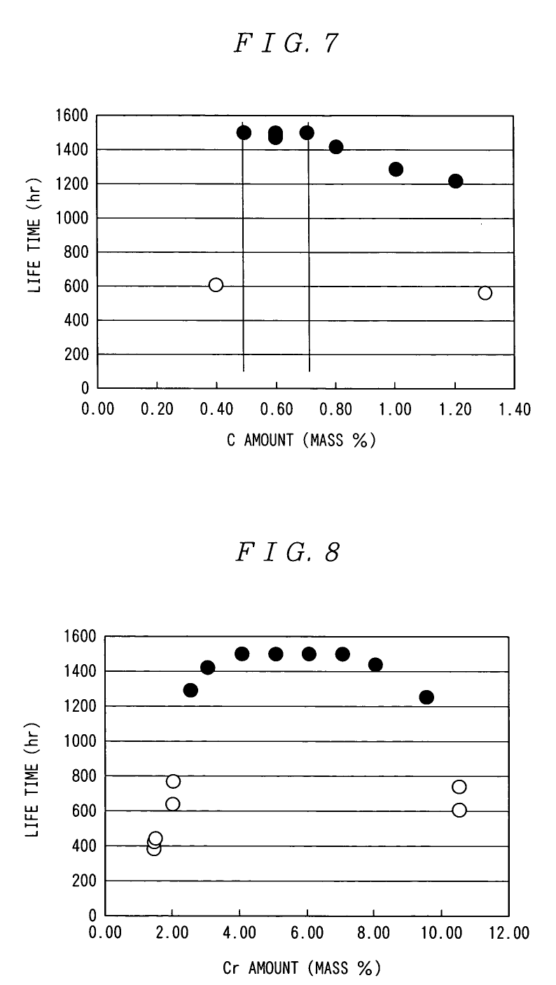

FIG. 7 shows a relation between the amount of C and the life with respect to Examples 1 to 8 and Comparative Example 7 in which the center line average roughness for the raceway surface is within the recommended range of the present invention and the amount of Cr is within the recommended range according to the present invention. As apparent from the drawings, the optimum ingredient range for the amount of C is 0.5 to 1.2 mass %. If the amount of C is smaller, hardness required as the bearing can not be obtained, whereas if it is more, the stability of the structure becomes insufficient to cause flaking. Further, as can be seen from the drawing, it is desirable that the amount of C is restricted to 0.7 mass % or less for stabilization of the structure.

Then, description is to be made to a second embodiment of a rolling element according to the present invention. At first, the following Table 4 shows the chemical ingredients for the tested materials in the examples and the comparative examples used in this embodiment. Numerical values with underlines are those out of the recommended range of the invention. α value in the table is the value in the right side for the above mentioned formula: (C %≦−0.05×Cr % −0.12×(Mo %+V %)+1.41) and only Comparative Examples M′ and N′ are out of the recommended range of the present invention.

TABLE 4

| | Tested | Steel composition (mass %) | | | | | | |
|---|---|---|---|---|---|---|---|---|
| | material | C | Si | Mn | Cr | Mo | V | α value |
| Example | A′ | 1.00 | 0.20 | 0.50 | 2.50 | 0.20 | 0.20 | 1.24 |
| | B′ | 1.20 | 1.0 | 0.40 | 3.00 | | | 1.26 |
| | C′ | 0.80 | 0.50 | 1.0 | 4.00 | 2.00 | | 0.97 |
| | D′ | 0.60 | 0.45 | 0.50 | 5.00 | 0.40 | | 1.11 |
| | E′ | 0.70 | 1.50 | 0.20 | 6.00 | | 0.20 | 1.09 |
| | F′ | 0.50 | 1.00 | 0.50 | 7.00 | 0.50 | | 1.00 |
| | G′ | 0.60 | 0.75 | 0.80 | 8.00 | 0.10 | | 1.00 |
| | H′ | 0.75 | 1.0 | 0.40 | 9.50 | 0.50 | 1.0 | 0.76 |
| Comp. | I′ | 0.95 | 0.35 | 0.38 | 1.45 | | | 1.34 |
| Example | J′ | 0.95 | 0.35 | 0.38 | 1.50 | 0.50 | 0.20 | 1.25 |
| | K′ | 0.80 | 0.50 | 0.40 | 2.00 | 0.50 | | 1.25 |
| | L′ | 0.55 | 1.0 | 0.50 | 10.50 | 1.00 | 0.50 | 0.71 |
| | M′ | 0.85 | 1.00 | 0.30 | 4.10 | 4.30 | 0.20 | 0.67 |
| | N′ | 1.30 | 0.80 | 0.80 | 4.00 | 0.50 | 0.20 | 1.13 |

Identical deep grooved ball bearings with those in the first embodiment were manufactured by the steel of the tested material and then hardening by heating at 830 to 1050° C., oil cooling and tempering at 180 to 460° C. were conducted in the same manner as in the first embodiment. Further, like the first embodiment, it was controlled such that the surface hardness HRC was from 58 to 64, the amount of the retained austenite was from 0 to 20% for the inner and the outer rings and the rolling element, the surface roughness of the rolling element was from 0.003 to 0.010 μmRa, and the surface roughness of the inner and outer rings was from 0.015 to 0.020 μmRa. Then, the tested bearings were assembled on the frontal side of the secondary pulley of the belt-type continuously varying transmission and a life test was conducted under the same conditions as those in the first embodiment.

The calculated life for the tested bearing was 1567 hrs like the first embodiment and, accordingly, the test termination time was defined as 1500 hrs and the test was terminated at the instance the vibrations increased to five times the initial vibrations. Upon testing, test specimens were prepared each by the number of 10 from the tested steel materials of Examples A′ to I′ and Comparative Examples J′ to N′, the time till the occurrence of abnormality such as flaking was measured, and the L₁₀ life was determined based on the result of the test specimens by the number of 10. Further, in a case where no abnormality such as flaking occurred for all 10 test specimens till the test termination time the L₁₀ life was defined as 1500 hrs. Table 5 shows the result of the life test.

TABLE 5

| | Test | Tested | | L₁₀ life | | |
|---|---|---|---|---|---|---|
| | piece | material | γR (%) | (hr) | Fracture state | |
| Example | 11 | A′ | 4 | 1290 | 2/10 | flaked |
| | 12 | B′ | 10 | 1420 | 1/10 | flaked |
| | 13 | C′ | 12 | 1500 | No flaking | |
| | 14 | D′ | 8 | 1500 | No flaking | |
| | 15 | E′ | 0 | 1500 | No flaking | |
| | 16 | F′ | 5 | 1500 | No flaking | |
| | 17 | G′ | 12 | 1440 | 1/10 | flaked |
| | 18 | H′ | 3 | 1250 | 2/10 | flaked |
| Comp. | 11 | I′ | 10 | 380 | 10/10 | flaked |
| Example | 12 | I′ | 3 | 420 | 10/10 | flaked |
| | 13 | J′ | 3 | 440 | 9/10 | flaked |
| | 14 | K′ | 8 | 770 | 7/10 | flaked |
| | 15 | K′ | 0 | 640 | 7/10 | flaked |
| | 16 | L′ | 2 | 610 | 8/10 | flaked |
| | 17 | L′ | 12 | 740 | 7/10 | flaked |
| | 18 | M′ | 5 | 420 | 10/10 | flaked |
| | 19 | N′ | 8 | 390 | 10/10 | flaked |

Rolling bearings of Examples 13 to 15 were manufactured from the tested materials C′ to E′ and dip hardening was conducted as the heat treatment. Further, Example 16 was manufactured from the tested material F′ and carburizaton was conducted as heat treatment. In both of them, the amount of C was from 0.5 to 0.8 mass % and the amount of Cr from was 4.0 to 7.0 mass %, being within the recommended range of the present invention, and they satisfy the condition that the amount of C is at the α value or less. Accordingly, they did not cause flaking in the life test and the L₁₀ life was 1500 hrs. When the hardness of the raceway surface was measured after the test, it was HRC of from 60 to 63 in all Examples 13 to 16 and they had a hardens required as bearing steel.

Example 11 was manufactured from the tested material A′ in which the amount of C was 1.0 mass %, and the amount of Cr was 2.5 mass % being within the recommended range of the present invention. However, since the amount of Cr was smaller compared with Examples 13 to 16, heat was generated when the rolling element caused rotation slip, which lowered the hardness and caused flaking in 2 out of 10. However, when compared with SUJ2 (Cr amount: 1.5 mass %) of the comparative examples, particularly, Comparative Examples 11 and 12 to be described later, it showed a longer life of three times or more.

Example 12 was manufactured from the tested material B′ in which the amount of C was 1.2 mass % and the amount of Cr was 3.0 mass %, being within the recommended range of the present invention. However, since the amount of Cr was somewhat smaller compared with Examples 13 to 16, hardness was lowered, or eutectic carbides were precipitated because of the large amount of C and, as a result, the L₁₀ life was 1420 hrs.

Examples 17 and 18 were manufactured from the tested materials G′ and H′ respectively in which the amount of C was 0.6 mass % and 0.75 mass % and the amount of Cr was 8.0 mass % and 9.0 mass %, respectively, being within the recommended range of the present invention. Since the amount of Cr was larger in both of them, while shortening of the life due to the lowering of the hardness was not observed, eutectic carbides were formed because of the large amount of C. Then, flaking was originated therefrom and the L₁₀ life was 1440 hrs and 1250 hrs, respectively.

On the contrary, both of Comparative Examples 11 and 12 were manufactured from SUJ2 and the retained austenite (γR) was controlled to 10% and 3%, respectively, by changing the heat treatment conditions. Then, since the amount of Cr was not at the optimal value in each of them, heat was generated due to the metal contact between the rolling element and the inner and outer rings to shorten the life by the lowering of the hardness. In fact, when the raceway surface of the bearing was observed, grinding traces were present nowhere and the hardness of the raceway surface was HRC of 55 or less both in Comparative Examples 11 and 12. Further, the amount of retained austenite gave scarce effect on the life and it is considered that optimization of the alloying ingredient such as Cr is an effective means.

Comparative Example 13 was manufactured from the tested material J′ by adding Mo and V to SUJ2. Also in this case, since the amount of Cr was not at the optimum value, the life was shortened by the lowering of the hardness. Further, both of Comparative Examples 14 and 15 were manufactured from the tested material K′ in which the amount of C was 0.8 mass % and the amount of Cr was 2.0 mass % and, particularly, the amount of Cr was smaller than the recommended range of the present invention. When the amount of retained austenite γR in Comparative Example 14 was changed to 8% and the amount of retained austenite γR was changed to 0% in Comparative Example 15 by the change of the heat treatment condition, flaking occurred in 7 out of 10 due to insufficiency of the amount of Cr, and the life was short in both of the cases.

Both of Comparative Examples 16 and 17 were manufactured from the tested material L′ in which the amount of C was 0.55 mass %, and the amount of Cr was 10.5 mass % and, particularly, the amount of Cr was larger than the recommended range of the present invention. Also in this case, the amount of retained austenite γR was changed to 2% and 12% respectively. As a result, since the amount of Cr was larger, shortening of life due to the lowering of the hardness was not observed. However, since the amount of Cr was excessively large and eutectic carbides were formed and flaking was originated therefrom, the L₁₀ life was short as 610 hrs and 740 hrs, respectively.

Comparative Examples 18 and 19 were manufactured from the tested materials M′ and N′, respectively, and the chemical ingredients per se were within the recommended range of the present invention except for Mo. However, since the amount of C was larger than the α value described above in both of them, eutectic carbides were formed. Then, stresses concentrated to the periphery of them and faking was originated from the sites, so that the L₁₀ life was short as 420 hrs and 390 hrs, respectively. However, when compared with SUJ2, since the amount of Cr was larger, lowering of the hardness after the test was not observed and the hardness of the raceway surface was HRC of 62 in both of them.

Further, FIG. 8 shows a relation between the amount of Cr and the life of Examples 11 to 18 and Comparative Examples 11 to 17 except for Comparative Examples 18 and 19. As apparent from the drawing, the optimum ingredient range for the amount of Cr is 2.5 to 9.5 mass %. When the amount of Cr is less than the range, hardness required as the bearing can not be obtained in a case where heat is generated by metal contact. Further, when the amount of Cr is more than the range, eutectic carbides are formed to cause flaking thereby shortening the life. For further making the life longer, it is desirable that the amount of Cr is 4.0 to 7.0 mass %. Further, as for the heat treatment, it is considered that identical effect can be obtained also by any of dip hardening, carburization and carbonitridation.

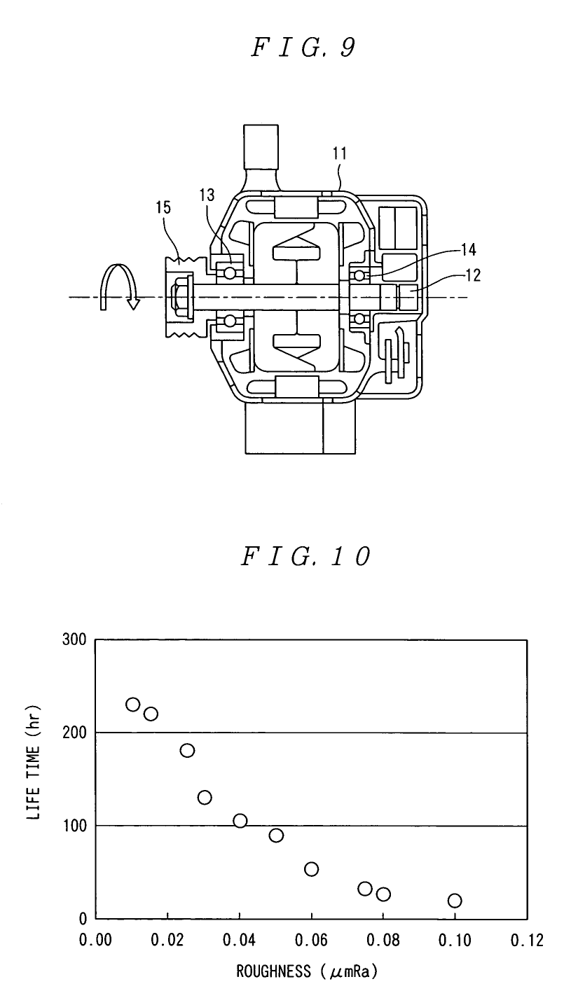

Then, description is to be made to a third embodiment of a rolling bearing according to the present invention. The embodiment concerns a bearing to be used being assembled in an alternator as a rolling bearing for use in an engine auxiliary equipment. In this embodiment, rolling bearings of various examples and comparative examples were assembled on the front of a cantilever type life tester shown in FIG. 3 and an actual alternator shown in FIG. 9 and a life test was conducted.

The rotary body, a so-called rotor part of the alternator shown in FIG. 9 is contained inside a housing 11 and a rotational shaft 12 thereof is supported rotationally by two bearings 13 and 14. A left end shown in the drawing of the rotational shaft 12 protrudes out of the housing 11 and a driving pulley 15 is attached to the protruding portion. That is, the rotational shaft 12 at the end of which the driving pulley 15 is attached is supported on the two bearings 13 and 14 in a cantilever manner. Then, by the rotation of the driving pulley 15 by an engine, the rotor rotates together with the rotational shaft 2 to generate AC current in the coils. Accordingly, the bearing 13 on the side of the driving pulley 15 more tends to undergo vibration or load. The front side means the side of the driving pulley 15.

Upon life test, the rolling bearings for the examples and the comparative examples were manufactured by using a bearing steel, 2nd class (SUJ2) for inner and outer rings and rolling elements, forming them each into a predetermined shape, and applying hardening by heating at 830 to 880° C., oil-cooling and then tempering at 180 to 240° C. It was controlled such that the surface hardness was HRC of from 57 to 64, and the amount of retained austenite γR was 0 to 20% for the inner and outer rings and the rolling elements and the surface roughness was from 0.003 to 0.010 μmRa for the rolling element.

Then, in the cantilever type life tester shown in FIG. 3, the rotational speed was 3900 min⁻¹, and turbine oil R068 was used for the lubricant. Further, both in the examples and the comparative examples, JIS bearing designation 6206 was used for the tested bearing and the bearing clearance was 10 to 15 μm, the load condition was at: P (applied load)/C (dynamic load rating)=0.30, and the test temperature was set constant at 80° C.

Further, in the actual alternator test, test was conducted under the condition, for example, of switching the rotational speed between 3500 and 18000 min⁻¹ on every predetermined time, for example, of about 9 sec. Further, both for the examples and the comparative examples, deep grooved ball bearings each of 17 mm inner diameter, 47 mm outer diameter and 14 mm width were used as the tested bearings, the bearing clearance was 10 to 15 μm, the load condition was at: P (applied load)/C (dynamic load rating)=0.10, and the test temperature was set constant at 80° C. E grease was used for the grease.

In the life test, rolling bearings of Examples a″ to f″ with the center line average roughness for the raceway surface being within the recommended range and rolling bearings of Comparative Examples g″ to j″ out of the recommended range were provided. Then, they were attached respectively to the cantilever type life tester shown in FIG. 3 and the actual alternator shown in FIG. 9 and the life test was conducted. Table 6 shows the center line average roughness for the raceway surface thereof and the result of the life test. In the table, numeral values with underlines show those out of the recommended range of the present invention.

TABLE 6

| | | Surface | L₁₀ life (hr) | |
|---|---|---|---|---|
| | Test | Roughness | Cantilever type | Actual |
| | piece | (μmRa) | life tester | alternator test |
| Example | a″ | 0.025 | 220 | 450 |
| | b″ | 0.03 | 210 | 580 |
| | c″ | 0.04 | 180 | 610 |
| | d″ | 0.05 | 140 | 570 |
| | e″ | 0.06 | 110 | 550 |
| | f″ | 0.075 | 40 | 430 |
| Comp. | g″ | 0.01 | 280 | 240 |
| Example | h″ | 0.015 | 260 | 290 |
| | i″ | 0.08 | 30 | 300 |
| | j″ | 0.1 | 25 | 170 |

Among them, FIG. 10 shows a relation between the life time in the life test by the cantilever type life tester and the center line average roughness for the raceway surface. As apparent from the drawing, the life tends to be longer as the center line average roughness for the raceway surface is smaller under usual working conditions as in the cantilever type life tester. It is considered to be attributable to that the oil film parameter increased by making the raceway surface smooth, disconnection of the oil film was suppressed to lower the degree of metal contact between the inner and outer rings and the rolling elements.

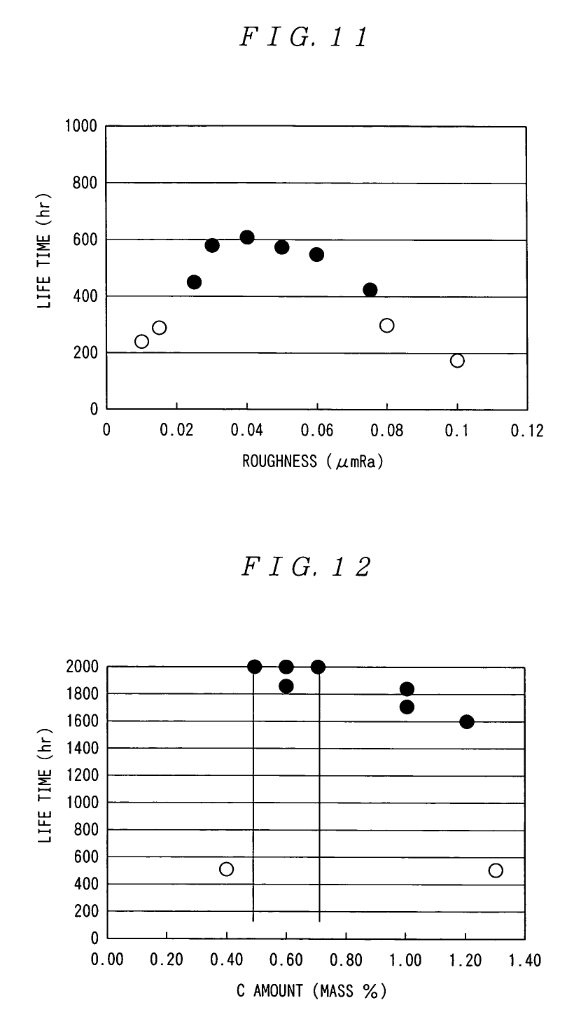

On the other hand, FIG. 11 shows a relation between the life time in the life test by the actual alternator and the center average roughness for the raceway surface. As apparent from the drawing, different from the cantilever type life tester, life is shortened at 0.010 μmRa and 0.015 μmRa in a region where the center line average roughness for the raceway surface is small. It is considered that in a region where the center line average roughness for the raceway surface was less than 0.025 μm Ra, sliding of the rolling element increased to evolve hydrogen by the formation of a fresh surface or hydrogen evolved by the shearing stress exerting on the grease or oil, by which flaking accompanied by structural change occurred to shorten the life.

Further, it is considered that life was shortened in a region where the center line average roughness for the raceway surface exceeded 0.075 μmRa, since metal contact increased between the inner and outer rings and the rolling element to cause usual flaking.

Then, as shown in Table 7, Examples A″ to H″ in which the chemical ingredients of the steel materials for the bearing ring were within the recommended range of the present invention and Comparative Examples I″ to N″ in which they were out of the recommended range of the present invention were prepared to manufacture rolling bearings for the life test by the actual alternator. Numerical values with underlines in the table are for ingredients out of the present recommended range of the present invention.

TABLE 7

| | Tested | Steel composition (mass %) | | | | | |
|---|---|---|---|---|---|---|---|
| | piece | C | Si | Mn | Cr | Mo | V |
| Example | A″ | 1.00 | 0.60 | 0.50 | 2.50 | 0.20 | 0.20 |
| | B″ | 0.60 | 1.00 | 0.40 | 3.00 | | |
| | C″ | 0.50 | 0.70 | 1.00 | 4.00 | 2.00 | |
| | D″ | 0.60 | 0.80 | 0.50 | 4.50 | 0.40 | |
| | E″ | 0.70 | 1.50 | 0.20 | 5.00 | | 0.20 |
| | F″ | 0.50 | 1.00 | 0.50 | 6.00 | 0.50 | |
| | G″ | 0.60 | 0.75 | 0.80 | 6.50 | 0.10 | |
| | H″ | 1.20 | 1.00 | 0.40 | 9.50 | 0.50 | 1.0 |
| Comp. | I″ | 0.95 | 0.35 | 0.38 | 1.45 | | |
| Example | J″ | 0.95 | 0.35 | 0.38 | 3.50 | 0.50 | 0.20 |
| | K″ | 0.80 | 0.50 | 0.40 | 4.00 | 0.50 | |
| | L″ | 0.45 | 1.00 | 0.50 | 10.50 | 1.00 | 0.50 |
| | M″ | 0.40 | 1.00 | 0.40 | 4.50 | 0.50 | 0.20 |
| | N″ | 1.30 | 0.80 | 0.80 | 5.00 | 0.50 | 0.20 |

The steel materials of the compositions described above were formed each into the shape of a rolling bearing for the life test by the actual alternator, applied with dip hardening and then finished by grinding. In this case, the grinding condition was changed to control the center line average roughness for the raceway surface as shown in Table 8. Further, SUJ2 was used for the rolling element, and it was controlled such that the surface hardness was set to HRC of from 57 to 64 and, the amount of retained austenite was set from 0 to 20% for the inner and outer rings and the rolling elements, and the surface roughness was set from 0.003 to 0.020 μmRa for the rolling element.

Table 8 shows the result of the life test together. The test conditions are identical with those described above. Since the calculated life is 1770 hrs, the termination time was defined as 2000 hrs, and when vibrations increased to five times the initial vibrations, it was defined as the life time. The number of test specimens was 10 for each of the types and the L₁₀ life was determined based on the result for the test specimens by the number of 10. In a case where all ten test specimens caused no abnormality such as seizure or flaking till the termination time, the L₁₀ life was defined as 2000 hours.

TABLE 8

| | | | Surface | |
|---|---|---|---|---|
| | Test | Tested | roughness | L₁₀ life |
| | piece | material | (μmRa) | (hr) |
| Example | 21 | A″ | 0.04 | 1220 |
| | 22 | B″ | 0.025 | 1840 |
| | 23 | B″ | 0.05 | 2000 |
| | 24 | C″ | 0.045 | 2000 |
| | 25 | D″ | 0.04 | 2000 |
| | 26 | E″ | 0.05 | 2000 |
| | 27 | F″ | 0.05 | 2000 |
| | 28 | G″ | 0.07 | 1860 |
| | 29 | H″ | 0.05 | 1610 |
| Comp. | 21 | I″ | 0.015 | 280 |
| Example | 22 | J″ | 0.04 | 540 |
| | 23 | J″ | 0.05 | 420 |
| | 24 | K″ | 0.035 | 810 |
| | 25 | L″ | 0.05 | 680 |
| | 26 | M″ | 0.04 | 520 |
| | 27 | N″ | 0.025 | 510 |
| | 28 | B″ | 0.08 | 1120 |
| | 29 | D″ | 0.015 | 1240 |
| | 30 | G″ | 0.02 | 1150 |

As apparent from Table 8, rolling bearings of Examples 23 to 27 were manufactured from the tested materials of Examples B″ to F″ and dip hardening was conducted as the heat treatment. However, the present invention is not restricted to the dip hardened steel. In each of them, the amount of C was 0.5 to 0.7 mass %, and the amount of Cr was 3.0 to 6.0 mass %, which were within the recommended range of the present invention and the center average roughness for the raceway surface was from 0.040 to 0.050 mRa which was within the recommended range of the present invention. Accordingly, they did not cause flaking also in the life test and the L₁₀ life was 2000 hrs.

Further, Example 21 was manufactured from the tested material of Example A″ in which the amount of C was 1.0 mass % and the amount of Cr was 2.5 mass % which were within the recommended range of the invention, and the center average roughness for the raceway surface was at 0.040 μmRa which was also within the recommended range of the present invention. However, since the amount of Cr was smaller in Example 21 compared with Examples 23 to 27, flaking accompanied by structural change occurred in 2 out of 10. However, when compared with comparative examples to be described later, particularly, Comparative Example 22 (center line average roughness for the raceway surface was identical as 0.040 μmRa) manufactured from SUJ2 (Cr amount: 1.5 mass %), it showed longer life of 3 to 5 times.

Further, Example 22 was manufactured from the tested material of Example B″ in which the amount of C was 0.6 mass % and the amount of Cr was 3.0 mass % which were within the recommended range of the present invention, and the center line average roughness for the raceway surface was also at 0.025 μmRa as within the recommended range of the invention. While Example 22 comprises identical chemical ingredients with those in Example 23, since the center line average roughness for the raceway surface was favorable compared with Example 23, rotation slip of the rolling element could not be suppressed. Therefore, flaking accompanied by structural change occurred in 2 out of 10 and the L₁₀ life was 1840 hrs.

Examples 28 and 29 were manufactured from the tested materials of Examples G″ and H″ respectively in which the amount of C was 0.6 mass % and 1.2 mass % and the Cr amount was 6.5 mass % in each of the cases. Further, the center line average roughness for the raceway surface was 0.070 μmRa and 0.050 μmRa, respectively. Each of them was within the recommended range of the present invention and, since the amount of Cr was particularly larger, flaking accompanied by structural change did not occur. However, flaking originated from the eutectic carbides by the formation of the eutectic carbides and the L₁₀ life was 1970 hrs and 1520 hrs, respectively.

On the contrary, Comparative Examples 21 and 22 were manufactured from bearing steel, 2nd class (SUJ2) and also the center average roughness for the raceway surface was 0.015 mRa in Comparative Example 21 which was identical with that in usual rolling bearing. However, as the bearing for use in the alternator, since both the center line average roughness for the raceway surface and the amount of Cr were out of the recommended range of the invention, rotation slip of the rolling element could not be suppressed. As a result, flaking accompanied by structural change occurred and the L₁₀ life of Comparative Example 21 was 280 hrs. On the contrary, Comparative Example 22 tended to show longer life by so much as the center line average roughness for the raceway surface increased and the L₁₀ life was 540 hrs.

Comparative Examples 23 and 24 were manufactured from tested materials of Comparative Examples J″ and K″ respectively. However, since the center line average roughness for the raceway surface was 0.050 μmRa and 0.035 μmRa, respectively, rotation slip of the rolling element could be suppressed. However, since the amount of Si was 0.35 mass % and 0.50 mass % respectively which was smaller being out of the recommended range of the present invention respectively, flaking accompanied by structural change occurred and the L₁₀ life was 420 hrs and 810 hrs respectively.

Comparative Example 25 was manufactured from the tested material of Comparative Example L″, and since the center line average roughness for the raceway surface was 0.050 μmRa, the rotation slip of the rolling element could be suppressed. However, since the amount of Cr was as large as 10.5 mass % being out of the recommended range of the present invention, eutectic carbides were formed and flaking originated from the eutectic carbides and the L₁₀ life was 680 hrs.

Comparative Example 26 was manufactured from the tested material of Comparative Example M″ in which the amount of C was 0.40 mass %, the amount of Cr was 4.5 mass % and the center line average roughness for the raceway surface was 0.040 μmRa. While the rotation slip of the rolling element could be suppressed by the center line average roughness for the raceway surface, since the amount of C was 0.40 mass % which was smaller being outside of the recommended range of the present invention, hardness required as the bearing could not be obtained and the L₁₀ life was 520 hrs.

Comparative Example 27 was manufactured from the tested material of Comparative Example N″ and rotation slip of the rolling element could be suppressed by controlling the center line average roughness for the raceway surface to 0.025 μmRa. However, since the amount of C was larger being outside of the recommended range of the present invention, fixing of C was lowered and the L₁₀ life was reduced to 510 hrs.

Comparative Examples 28 to 30 were manufactured from the tested materials of Examples B″, D″, and G″, respectively, and the chemical ingredients satisfies the recommended range of the invention. However, since the center line average roughness for the raceway surface was 0.080 μmRa in Comparative Example 28, metal contact between the inner and outer the rings and rolling element increased, to cause flaking and the L₁₀ life was 1120 hrs.

Referring to Comparative Examples 29 and 30, since the center line average roughness for the raceway surface was 0.015 μmRa and 0.020 μmRa, respectively, flaking accompanied by structural change occurred in 2 to 3 out of 10 and the L₁₀ life was 1240 hrs and 1150 hrs, respectively. However, when compared with Comparative Example 21, the life was longer by 3 to 4 times.

Then, FIG. 12 shows a relation between the amount of C and the life with respect to Examples 21 to 28 and Comparative Examples 26 and 27 (the center line average roughness for the raceway surface was within the recommended range and the amount of Cr was also within the recommended range) . As apparent from the drawing, the optimal ingredient range for the amount of C is 0.5 to 1.2 mass %. When the amount of C is less than the range, hardness required as the bearing can not be obtained and, whereas if it is more than the range, stability of the structure becomes insufficient to cause flaking, so that the life is shortened. For further stabilization of the structure, it is desirable that the amount of C is 0.7 mass % or less and, further, the optimal ingredient range for the amount of Cr is from 3.0 to 6.0 mass %. Furthermore, it is preferred to use steel materials of the chemical ingredients described above to control the center line average roughness for the raceway surface from 0.025 to 0.75 μmRa.

Then, description is to be made to a fourth embodiment of the rolling bearing according to the present invention. In this embodiment, a flaking reproduction test and a seizure test were conducted as the life test for the rolling bearing. For the flaking reproduction tester, a rapid acceleration/deceleration tester described in Japanese Unexamined Patent Publication No. Hei 9-89724 was used. Then, the test was conducted under the conditions, for example, of switching the rotational speed between 9000 min⁻¹ and 18000 min⁻¹ on every predetermined period, for example, of about 9 seconds.

Further, JIS bearing designation 6303 was used as the tested bearing both for the examples of the present invention and the comparative examples, the bearing clearance was set to 10 to 15 μm, the loading condition was at: P (applied load)/C (dynamic load rating)=0.10, and the test temperature was set constant at 80° C. Since the calculation life of the bearing is 1350 hrs, the test termination time was defined as 2000 hrs. The test was interrupted when vibration values increased as far as 5 times the initial vibrations and absence or presence of flaking was confirmed. The test was conducted for each kind of bearing each by the number of 10.

Further, the rapid acceleration/deceleration tester was used also for the seizure test. However, the rotational speed was set constant at 2000 min⁻¹, the bearing temperature was at 140° C., and a radial load was at 98N, and the test was conducted continuously. The conditions for the bearing were identical with those for the flaking reproduction test. Then, the test was terminated when seizure occurred and the outer ring temperature of the bearing increased to 150C or higher. Further, in a case where the outer ring temperature for the bearing did not rise to 150° C. or higher even after the test for 1000 hrs, the test was terminated. The test was conducted for each type of bearings each by the number of 10.

The grease used for the tested bearing was prepared as described below. A base oil mixed with a diisocyanate and a base oil mixed with an amine were mixed and stirred to react the diisocyanate and the amine. An amine type antioxidant dissolved previously to the base oil was added to the semi-solid product obtained by heating and stirred sufficiently. After gradual cooling, carbon black was added and they were passed through a roll mill to obtain a grease. The consistency of the grease was controlled to NLGI No. 1 to No. 3. Table 9 shows various properties of the grease.

TABLE 9

| | |
|---|---|
| Kind of thickener | Diurea compound |
| Amount of thickener | 15 mass % |
| Kind of base oil | Poly α-olefin |
| Kinetic viscosity of base oil at 40° C. | 50 mm²/s |
| Mixed consistency (NLGI grade) | No. 3 |

Upon each of the life tests described above, tested materials of Examples a′ to h′, and Comparative Examples i′ to n′ shown in Table 10 were used for the inner and outer rings of bearings and used after applying usual heat treatment (hardening by heating at 830 to 1050° c, oil cooling and then tempering at 160 to 240° C.). As apparent from Table 10, in the tested materials for each of Examples a′ to h′, all the ingredient contents of the alloy are within the recommended range of the present invention. On the contrary, in Comparative Example i′, the amount of Si is smaller being out of the recommended range of the present invention and also the amount of Cr is smaller being out of the recommended range of the present invention. Further, in Comparative Example j′ and Comparative Example k′, the amount of Si is smaller being out of the recommended range of the present invention. Further, in Comparative Example 1′, the amount of Cr is larger out of the recommended range of the present invention. Further, in Comparative Example m′, the amount of C is smaller being out of the recommended range of the present invention. Further, in Comparative Example n′, the amount of C is larger being out of the recommended range of the invention.

It was controlled such that the surface hardness was HRC of from 57 to 63 and the retained amount of austenite was from 0 to 20% for the inner and outer rings and the rolling element and the raceway surface roughness for the inner and outer rings was from 0.010 to 0.040 μm Ra. Further, SUJ2 (bearing steel, 2nd class) was used for the rolling element, and the surface roughness was from 0.003 to 0.010 μm Ra.

TABLE 10

| | Tested | Steel composition (mass %) | | | | | |
|---|---|---|---|---|---|---|---|
| | material | C | Si | Mn | Cr | Mo | V |
| Example | a′ | 1.20 | 0.60 | 0.50 | 2.50 | 0.20 | 0.30 |
| | b′ | 0.80 | 0.80 | 0.40 | 2.80 | | |
| | c′ | 0.50 | 0.75 | 2.00 | 3.00 | 1.50 | |
| | d′ | 0.70 | 0.80 | 0.50 | 4.50 | 0.40 | |
| | e′ | 0.70 | 1.50 | 0.10 | 5.00 | 0.10 | 0.20 |
| | f′ | 0.65 | 1.00 | 0.50 | 6.00 | 0.40 | |
| | g′ | 0.60 | 0.75 | 0.80 | 7.50 | 2.00 | 0.10 |
| | h′ | 0.70 | 1.00 | 0.40 | 9.50 | 0.30 | 1.00 |
| Comp. | i′ | 0.95 | 0.35 | 0.35 | 1.50 | | |
| Example | j′ | 0.95 | 0.35 | 0.40 | 3.50 | 0.50 | 0.20 |
| | k′ | 0.80 | 0.50 | 0.40 | 6.00 | 0.50 | |
| | l′ | 0.60 | 1.00 | 0.35 | 10.50 | 1.00 | 0.50 |
| | m′ | 0.40 | 1.00 | 0.40 | 4.50 | 0.50 | 0.20 |
| | n′ | 1.30 | 0.80 | 0.80 | 6.50 | 0.50 | 0.30 |

Rolling bearings of Examples 31 to 38 were manufactured by using the tested materials of Examples a′ to h′ and rolling bearings of Comparative Examples 31 to 36 were manufactured by using the tested materials of Comparative Examples i′ to n′. Then, the life test described previously was conducted to each of the rolling bearings. Table 11 shows the result of the test.

TABLE 11

| | Test | Tested | Flaking test | | |
|---|---|---|---|---|---|
| | piece | material | Life time (L₁₀) | Flaking | |
| Example | 31 | a′ | 1080 | 4/10 | flaked |
| | 32 | b′ | 1400 | 3/10 | flaked |
| | 33 | c′ | 1790 | 2/10 | flaked |
| | 34 | d′ | 1860 | 2/10 | flaked |
| | 35 | e′ | 1960 | 1/10 | flaked |
| | 36 | f′ | 2000 | No flaking | |
| | 37 | g′ | 1860 | 1/10 | flaked |
| | 38 | h′ | 1490 | 2/10 | flaked |
| Comp. | 31 | i′ | 170 | 10/10 | flaked |
| Example | 32 | j′ | 650 | 7/10 | flaked |
| | 33 | k′ | 540 | 8/10 | flaked |
| | 34 | l′ | 420 | 10/10 | flaked |
| | 35 | m′ | 810 | 5/10 | flaked |
| | 36 | n′ | 680 | 6/10 | flaked |

The rolling bearings of Examples 33 to 37 shown in Table 11 were manufactured from the tested materials of Examples c′to g′ and dip hardening was conducted as heat treatment. However, the present invention is not restricted to the dip hardening. The amount of C was within the range from 0.5 to 0.7 mass % and the amount of Cr was within the range from 3.0 to 7.5 mass % in each of them, which were within the recommended range of the present invention. Accordingly, they tended to show longer life in the life test, the L₁₀ life was the calculated life, which was 1500 hrs or longer.

In Example 36, the amount of C was 0.65 mass %, the amount of Cr was 6.0 mass %, flaking did not occur, and the L₁₀ life was 2000 hrs. Example 31 was manufactured from the tested materials of Example a′ in which the amount of C was 1.2 mass %, and the amount of Cr was 2.5 mass %. Compared with Examples 33 to 37, since the amount of Cr was somewhat smaller, flaking accompanied by structural change occurred in 4 out of 10. However, when compared with comparative examples to be described, particularly, with Comparative Example 32 (the center line average roughness for the raceway surface was equal as 0.05 μm Ra) manufactured from SUJ2 (amount of Cr: 1.5%), it tended to show a longer life of 3 to 5 times. Further, Example 32 was manufactured from the tested material of Example b′ in which the amount of C was 0.8 mass % and the amount of Cr was 2.8 mass %. Since the amount of Cr was increased compared with Example 31, Example 32 tended to show a longer life and the L₁₀ life was 1400 hrs. Example 38 was manufactured from the tested material of Example h′ in which the amount of C was 0.7 mass %, and the amount of Cr was 9.5 mass %. Since the amount of Cr was larger, while flaking accompanied by structural change did not occur, eutectic carbides were formed and flaking originated therefrom, so that the L₁₀ life was 1490 hrs.

On the contrary, Comparative Example 31 was manufactured from bearing steel, 2nd class (SUJ2) and since the amount of Cr was smaller, flaking accompanied by structural change occurred and the L₁₀ life was 170 hrs. Further, Comparative Examples 32 and 33 were manufactured from the tested materials of Comparative Example j′ and Comparative Example k′, respectively, in which the amount of Si was 0.35 mass % and 0.50 mass, respectively, which was smaller compared with the examples. Accordingly, flaking accompanied by structural change occurred and the L₁₀ life was 640 hrs and 540 hrs respectively. Further, Comparative Example 34 was manufactured from the tested material of Comparative Example 1′ in which the amount of Cr was as large as 10.5 mass %. Accordingly, eutectic carbides were formed and flaking was originated therefrom, and the L₁₀ life was 420 hrs. Further, Comparative Example 35 was manufactured from the tested material of Comparative Example m′ in which the amount of C was 0.40 mass %, and the amount of Cr was 4.5 mass %. Since the amount of C was as small as 0.4 mass %, hardness required as the bearing could not be obtained and the L₁₀ life was 810 hrs. Further, Comparative Example 36 was manufactured from the tested material of Comparative Example n′ and since the amount of C was large, fixing of C was lowered and the L₁₀ life was 510 hrs.

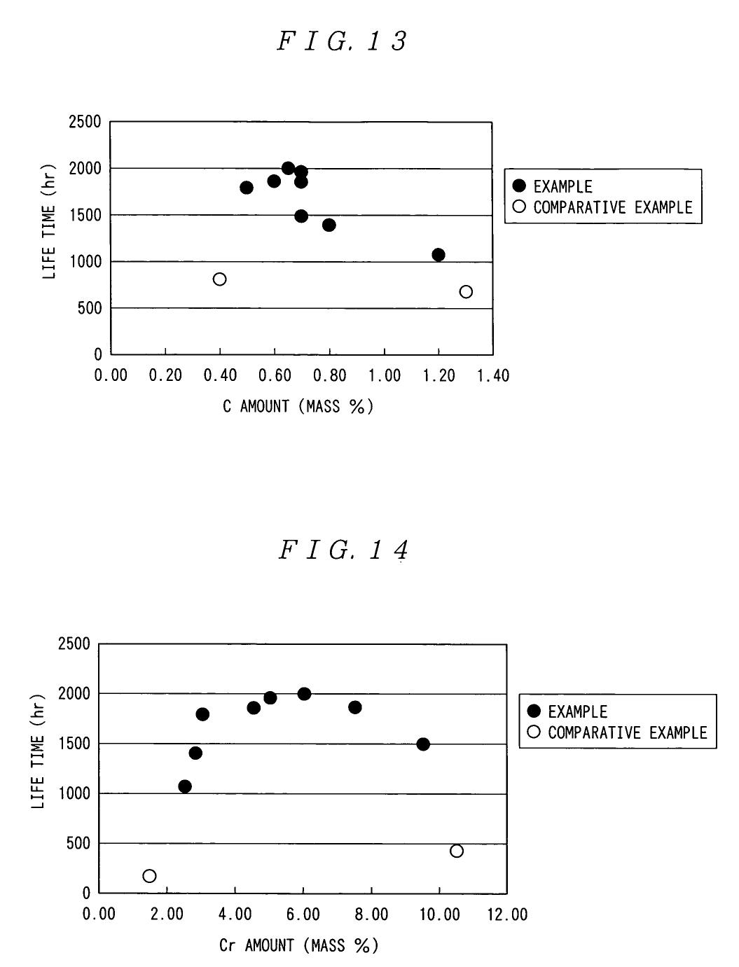

FIG. 13 shows a relation between the amount of C and the life in the life test for Examples 31 to 38 and Comparative Examples 35 and 36. As apparent from the drawing, the optimal ingredient range for the amount of C is from 0.5 to 1.2 mass %. In a case where the amount of C is smaller, hardness required as the bearing can not be obtained and, on the contrary, if it is larger, the stability of the structure is insufficient to cause flaking and shorten the life. For further stabilization of the structure, it is desirable that the amount of C is 0.7 mass % or less. In the same manner, FIG. 14 shows a relation between the amount of Cr and the life in the life test. As apparent from the drawing, the optimal ingredient range for Cr is from 2.5 to 9.5 mass %. In a case where the amount of Cr was smaller, flaking accompanied by structural change occurred and, on the contrary, in a case when it was larger, flaking originated from eutectic carbides. For further extending the life, it is desirable that the amount of Cr is from 3.0 to 6.0 mass %.

Then, various amounts of conductive substances were blended to the greases shown in Table 9. Then, a flaking test and a seizure test for rolling bearings lubricated with greases blended with the conductive substances were conducted under the circumstance where static electricity was generated to the inner and outer rings as in the actual alternator. The inner and outer rings, and the rolling elements were constituted with bearing steel, 2nd class (SUJ2) both for the examples and the comparative examples, and applied with usual heat treatment (hardening by heating at 830 to 1050° C., oil cooling and then tempering at 160 to 240° C.) . Thus, it was controlled such that the surface hardness was HRC of from 57 to 63, the retained amount of austenite was from 0 to 20% for the inner and outer rings and the rolling element, the raceway roughness was from 0.010 to 0.040 μmRa for the inner and outer rings, and the surface roughness was from 0.003 to 0.101 μmRa for the rolling element.

Table 12 shows the result of the test. The recommended range for the blending ratio of the conductive substance was from 0.1 to 10 mass % based on the entire amount of the grease, and the blending ratio of the conductive substance was within the recommended range in each of Examples 41 to 50.

TABLE 12

| | | Conductive | | | | | |
|---|---|---|---|---|---|---|---|
| | | material | Flaking test | | | Seizure test | |
| | Test | blend ratio | Life time | | | Life time | |
| | piece | (mass %) | (L₁₀) | Flaking | | (L₁₀) | Seizure |
| Example | 41 | 0.1 | 1120 | 2/10 | flaked | 1000 | No seizure |
| | 42 | 0.2 | 1170 | 2/10 | flaked | 1000 | No seizure |
| | 43 | 0.5 | 1770 | 1/10 | flaked | 1000 | No seizure |

| 44 | 1.5 | 1800 | No flaking | 1000 | No seizure | |
|---|---|---|---|---|---|---|
| 45 | 2 | 1880 | No flaking | 1000 | No seizure | |
| 46 | 3.5 | 2000 | No flaking | 1000 | No seizure | |
| 47 | 5 | 2000 | No flaking | 1000 | No seizure | |
| 48 | 7 | 2000 | No flaking | 980 | 1/10 | seizure |
| 49 | 7.5 | 2000 | No flaking | 910 | 1/10 | seizure |
| 50 | 10 | 2000 | No flaking | 820 | 2/10 | seizure |

| | | | | | | | |
|---|---|---|---|---|---|---|---|
| Comp. | 41 | 0 | 320 | 10/10 | flaked | 1000 | No seizure |
| Example | 42 | 0.05 | 580 | 10/10 | flaked | 1000 | No seizure |

| | | | | | | |
|---|---|---|---|---|---|---|
| 43 | 12 | 2000 | No flaking | 358 | 6/10 | seizure |
| 44 | 13 | 2000 | No flaking | 320 | 7/10 | seizure |
| 45 | 15 | 2000 | No flaking | 310 | 10/10 | seizure |
| 46 | 20 | 2000 | No flaking | 210 | 10/10 | seizure |

At first, the result of the flaking test is to be considered. In Examples 46 to 50, occurrence of flaking was not observed till 2000 hours in all ten specimens. This is considered that the inner ring and the outer ring could be conducted electrically upon rotation of the bearing by blending the conductive substance by from 3.5 to 10 mass % in a circumstance of causing flaking accompanied by structural change. It is considered, for example, that static electricity generated between the belt and the pulley of the alternator could be eliminated easily with no electric discharge between inner ring and the outer ring.

In Examples 41 to 45, flaking occurred in one or two out of 10. This is considered that the conductivity during rotation of the bearing was not sufficient since the blending amount of the conductive substance was smaller compared with Examples 46 to 50.

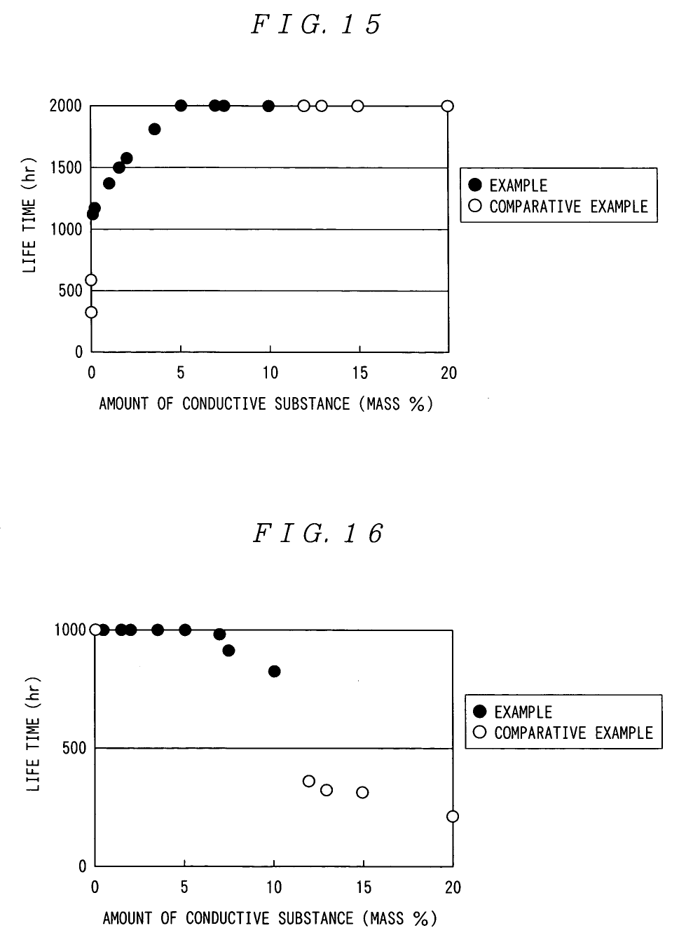

On the contrary, in Comparative Example 41, flaking occurred in all ten specimens since the conductive substance was not blended with the grease. Further, since the conductive substance was blended by 0.05 mass % to the grease in Comparative Example 42, the life was longer compared with Comparative Example 41. However, flaking occurred in all ten specimens and the L₁₀ life was as short as 580 hrs. It is considered that potential difference was generated between the inner ring and the outer ring to cause electric discharging phenomenon since the blending amount of the conductive substance was not sufficient in each of them. On the contrary, in Comparative Examples 43 to Comparative Example 46 with a sufficient blending amount of the conductive substance, flaking did not occur even reaching 2000 hrs and they tended to show a long life at least in the flaking test. FIG. 15 shows the result of the flaking test.

Then, the result of the seizure test is considered. In Examples 41 to 47, occurrence of seizure was not recognized even when reaching 1000 hrs in all ten specimens. Further, in Examples 48, 49 and 50, the conductive substance was blended by 7.0 mass %, 7.5 mass %, and 10 mass %, respectively, which lowered consistency of the grease and seizure occurred in one or two out of 10. Further, in Comparative Examples 42 to 46, which showed good result in the flaking test, seizure occurred in 6 to 10 out of 10. This is because the consistency of the grease was lowered like in Examples 48 to 50. FIG. 16 shows the result of the seizure test.

In view of the result of the test, it can be seen that the amount of the conductive substance blended with the grease is preferably from 0.1 to 10 mass % based on the entire amount of the grease. In a case where the blending amount of the conductive substance was smaller, no sufficient conductivity could be provided and in a case where it was larger, the grease was hardened to possibly shorter the seizure life. For making the conductivity and the seizure life more favorably, it is more preferred that the amount is from 0.5 to 5 mass % based on the entire amount of the grease.

Then, a flaking test and a seizure test were conducted by using the tested materials of Examples c′ to g′ in Table 10 in which the alloy ingredients of the bearings were within the recommended range for the rolling bearing according to the present invention, while changing the blending amount of the conductive substance variously in the same manner as described above. As a heat treatment, usual heat treatment (hardening by heating at 830 to 1050° C., oil cooling and then tempering at 160 to 240° C.) was applied to control the surface hardness to HRC of from 57 to 63 and the amount of retained austenite from 0 to 20% for the inner and outer rings and the rolling element, and the raceway surface roughness of the inner and outer rings from 0.01 to 0.040 μmRa. Further, the rolling element was constituted with SUJ2 (bearing steel, 2nd class) and the surface roughens was controlled to 0.003 to 0.010 μmRa. Table 13 shows the result of the test.

TABLE 13

| | | | | Flaking test | | Seizure test | |
|---|---|---|---|---|---|---|---|
| | | | Conductive | Life | | Life | |
| | Test | Tested | material blend | time | | time | |
| | piece | material | ratio (mass %) | (L₁₀) | Flaking | (L₁₀) | Seizure |
| Example | 51 | c′ | 5 | 2000 | No Flaking | 1000 | No seizure |
| | 52 | d′ | 2 | 2000 | No Flaking | 1000 | No seizure |
| | 53 | e′ | 1 | 2000 | No Flaking | 1000 | No seizure |
| | 54 | f′ | 2 | 2000 | No flaked | 1000 | No seizure |
| | 55 | g′ | 0.5 | 2000 | No Flaking | 1000 | No seizure |
| Comp. | 51 | d′ | 0 | 1860 | 2/10 flaked | 1000 | No seizure |
| Example | 52 | d′ | 7 | 2000 | No flaking | 970 | 1/10 seizure |

As shown in Table 13, rolling bearings of Examples 51 to 55 were manufactured from the tested materials of Examples c′ to g′ in which the amount of C was from 0.5 to 0.7 mass % and the amount of Cr was from 4.0 to 7.5 mass % in each of them which were within the recommended range of the alloy ingredient for the rolling bearing of the present invention. Accordingly, they tended to showed longer life in any of the tests, the L₁₀ life was the calculated life and occurrence of flaking was not observed even when reaching 2000 hrs in the flaking test.

On the contrary, as apparent from Comparative Examples 51 and 52, in a case where any of the alloying ingredient and the blending amount of the conductive substance was out of the recommended range, the flaking life and the seizure life were shortened. Then, when it is intended for longer life in both of the cases, it is preferred that they are within the recommended range of the present invention. Further, preferably, the amount of C is from 0.5 to 0.7 mass %, the amount of Cr is from 3.0 to 6.0 mass % and the blending amount of the conductive substance in the grease is from 0.5 to 5.0 mass %. cl (II) Embodiment of the Invention for Solving the Second Subject

(1) Description is to be made to a rolling bearing for use in an engine auxiliary equipment or a gas heat pump and lubricated with grease (fifth embodiment).

In this embodiment, a flaking reproduction test and a seizure test were conducted as the life test for the rolling bearing. For the flaking reproduction tester, a rapid acceleration/deceleration tester described in Japanese Unexamined Patent Publication No. Hei 9-89724 was used for example. Then, test was conducted under the conditions, for example, of switching the rotational speed between 9000 min⁻¹ and 18000 min⁻¹ on every predetermined period of about 9 seconds.

Further, JIS bearing designation 6303 was used as the tested bearing both for the examples of the present invention and the comparative examples, the bearing clearance was from 10 to 15 μm, the load condition was at: P (applied load)/C (dynamic load rating)=0.15, and the test temperature was set constant at 80° C. Since the calculated life of the bearing was 480 hrs, the test termination time was defined as 1000 hrs. The test was interrupted when vibration values increased as far as 5 times the initial vibrations and absence or presence of flaking was confirmed. The test was conducted for each type of bearing each by the number of 10.

Further, the rapid acceleration/deceleration tester was used also for the seizure test. However, the test was conducted continuously by setting the rotational speed constant at 2000 min⁻¹, setting the bearing temperature at 140° C., and a radial load was at 98N. The type of the bearing and the conditions were identical with those for the flaking reproduction test. Then, the test was terminated when seizure occurred and the outer ring temperature for the bearing increased to 150° C. or higher. Further, in a case where the outer ring temperature of the bearing did not increased to 150° C. or higher, even after the test of 1000 hrs, the test was terminated. The test was conducted for each type of bearing each by the number of 10.

The grease used for the tested bearing was prepared as described below. A base oil mixed with a diisocyanate and a base oil mixed with an anime was mixed and stirred to react the diisocyanate and the amine. An amine type antioxidant dissolved previously to the base oil was added to the semi-solid product obtained by heating and stirred sufficiently. After gradual cooling, carbon black was added and they were passed through a roll mill to obtain a grease. The consistency of the grease was controlled to NLGI No. 1 to No. 3. Various properties of the grease were identical with those in Table 9 described above.

Upon each of the life test described above, tested materials for Examples A2 to H2, and Comparative Examples I2 to N2 shown in Table 14 were used for the inner and outer rings of bearings and used after applying usual heat treatment (hardening by heating at 830 to 1050° c, oil cooling and then tempering at 160 to 240° C.). As apparent from Table 14, in each of the tested materials for Examples A2 to H2, all of the alloy ingredient contents were within the recommended range of the present invention. On the contrary, in Comparative Examples I2 to K2, the amount of Si was smaller being out of the recommended range of the present invention and the amount of Cr was also smaller being out of the recommended range of the present invention. Further, in Comparative Example L2, the amount of Cr was larger being out of the recommended range of the present invention. Further, in Comparative Example M2, the amount of Mo was larger being out of the recommended range of the present invention. Further, in Comparative Example N2, the amount of C was larger being out of the recommended range of the present invention.

The rolling element was constituted with SUJ2 (bearing steel, 2nd class). Further, it was controlled such that the surface roughness was HRC of from 57 to 63 and the amount of retained austenite was from 0 to 20% for the inner and outer rings and the rolling element. Then, it was controlled such that the center average roughness for the raceway surface was from 0.015 to 0.20 μmRa for the outer ring (fixed ring), at 0.020 μmRa for the inner ring and from 0.003 to 0.010 μmRa for the rolling element.

TABLE 14

| | Tested | Steel composition (mass %) | | | | | | α |
|---|---|---|---|---|---|---|---|---|
| | material | C | Si | Mn | Cr | Mo | V | value |
| Example | A2 | 0.9 | 0.60 | 0.50 | 2.50 | 0.20 | 0.20 | 1.24 |
| | B2 | 1.20 | 1.0 | 0.4 | 3.0 | | | 1.26 |
| | C2 | 0.80 | 0.65 | 1.0 | 4.0 | 2.00 | | 0.97 |
| | D2 | 0.55 | 0.80 | 0.50 | 7.0 | 0.40 | | 1.01 |
| | E2 | 0.75 | 1.50 | 0.20 | 9.5 | | 0.20 | 0.91 |
| | F2 | 0.70 | 1.0 | 0.50 | 13.0 | 0.50 | | 0.70 |
| | G2 | 0.50 | 0.75 | 0.80 | 15.0 | 0.10 | 1.00 | 0.53 |
| | H2 | 0.55 | 1.0 | 0.40 | 17.0 | 0.10 | | 0.55 |
| Comp. | I2 | 0.95 | 0.35 | 0.38 | 1.45 | | | 1.34 |
| Example | J2 | 0.95 | 0.35 | 0.38 | 1.50 | 0.50 | 0.20 | 1.25 |
| | K2 | 0.80 | 0.50 | 0.40 | 2.0 | 0.50 | | 1.25 |
| | L2 | 0.55 | 1.0 | 0.50 | 20.0 | 1.0 | 0.50 | 0.23 |
| | M2 | 0.85 | 1.0 | 0.30 | 4.10 | 4.30 | 0.70 | 0.61 |
| | N2 | 1.30 | 0.80 | 0.80 | 4.00 | 0.50 | 0.20 | 1.13 |

Rolling bearings of Examples 101 to 109 were manufactured by using the tested materials of Examples A2 to H2 and rolling bearings of Comparative Examples 101 to 105 were manufactured by using tested materials of Comparative Examples I2 N2. Then, the flaking reproduction test described above was conducted to each of the rolling bearings. Table 15 shows the result of the test. Numerical values with unerlines in the table are those with the center line average roughness for the raceway surface being out of the recommended range of the invention.

TABLE 15

| | |
|---|---|
| Surface | Flaking test |

| | Tested | roughness | L₁₀ life | Flaking | |
|---|---|---|---|---|---|
| | material | (μmRa) | (hr) | state | |
| Example | 101 | 0.025 | 630 | 2/10 | flaked |
| | 102 | 0.03 | 880 | 2/10 | flaked |
| | 103 | 0.04 | 1000 | No flaking | |
| | 104 | 0.05 | 1000 | No flaking | |
| | 105 | 0.06 | 1000 | No flaking | |
| | 106 | 0.08 | 1000 | No flaking | |
| | 107 | 0.095 | 950 | 1/10 | flaked |
| | 108 | 0.12 | 780 | 2/10 | flaked |
| | 109 | 0.15 | 610 | 2/10 | flaked |
| Comp. | 101 | 0.015 | 210 | 10/10 | flaked |
| Example | 102 | 0.02 | 280 | 10/10 | flaked |
| | 103 | 0.16 | 330 | 10/10 | flaked |
| | 104 | 0.18 | 270 | 10/10 | flaked |
| | 105 | 0.2 | 190 | 10/10 | Flaked |

For Examples 103 to 106, occurrence of flaking was not observed for all the specimens by the number of 10 even reaching 1000 hrs. This is considered that the life was improved since the rotation slip was less caused to the rolling element since the center line average roughness for the raceway surface in the fixed ring tending to often suffer from flaking was rough (usually, 0.02 μmRa or less), although this was a region where the oil film parameter A was lowered.

Further, it is considered that although Examples 101 and 102 showed long life, the life was shorten compared with Examples 103 to 107 since rotation slip tended to be caused for the rolling element because the raceway surface was smooth.

Further, Examples 107 to 109 also had long life but they tended to cause metal contact since the oil film parameter A was smaller compared with Examples 103 to 106. Accordingly, early flaking accompanied by structural change occurred in one or two out of 10 and surface originated flaking occurred to the outer ring (fixed ring). Since the grinding traces were scarcely confirmed even when the raceway surface of the flaked outer ring was observed, it is considered that metal contact occurred at a considerably high frequency, loading to the surface originated flaking.

On the contrary, in Comparative Examples 101 and 102, the surface roughness was at the same level as the raceway surface of usual ball bearings, or it was at the same level as that of the raceway surface of usual ball bearings applied with super finishing. Accordingly, the oil film parameter A increased to suppress metal contact. However, sliding or metal contact tended to be caused under the circumstance where high temperature and large vibration exert as in the bearings for use in engine auxiliary equipments. Accordingly, when only the surface roughness for the raceway surface was improved, the life was rather shortened and the L₁₀ life was about ¼ for the calculated life.

Further, in Comparative Examples 103 to 105 with the raceway surface coarser than that of Examples 101 to 109, since the oil parameter A was small, metal contact occurred between the rolling element and the inner and outer rings. Accordingly, surface originated flaking occurred to shorten the life.

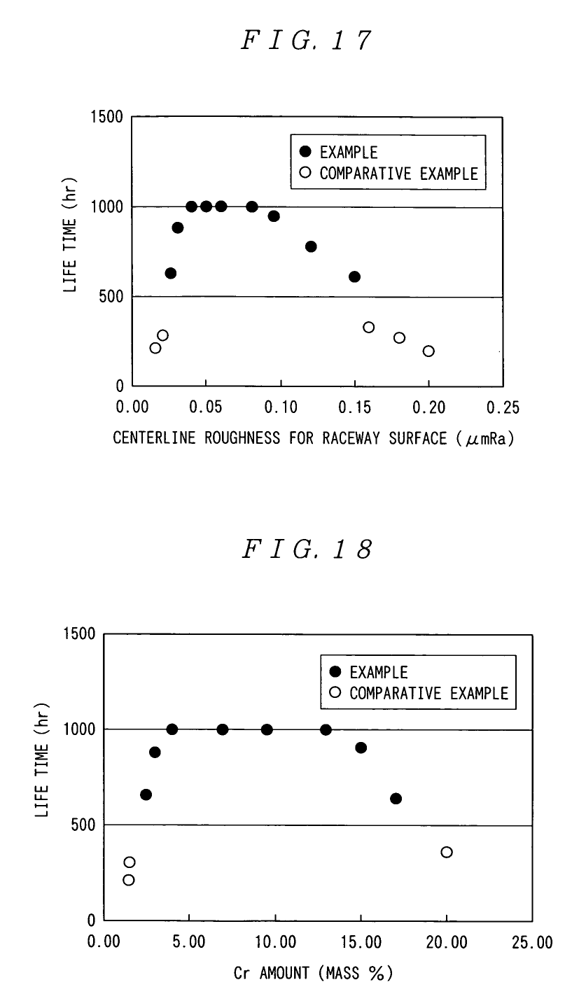

FIG. 17 shows a relation between the center line average roughness for the raceway surface and the life in the flaking reproduction test for Examples 101 to 109 and Comparative Examples 101 to 105.

Then, description is to be made for the result of conducting the flaking reproduction test in the same manner as described above for the bearings as shown in Table 16.

TABLE 16

| | | | | | Flaking test | | |
|---|---|---|---|---|---|---|---|
| | Tested | Tested | | | L₁₀ life | Flaking | |
| | piece | material | Heat treatment | | (hr) | state | |
| Example | 111 | A2 | dip hardening | 830° C. × 2 hr | 660 | 2/10 | flaked |
| | 112 | B2 | dip hardening | 830° C. × 2 hr | 880 | 1/10 | flaked |
| | 113 | C2 | dip hardening | 850° C. × 2 hr | 1000 | No flaking | |
| | 114 | D2 | Carburization | 930° C. × 2 hr | 1000 | No flaking | |
| | 115 | E2 | dip hardening | 960° C. × 2 hr | 1000 | No flaking | |
| | 116 | F2 | dip hardening | 1000° C. × 2 hr | 1000 | No flaking | |
| | 117 | G2 | Carburization | 1000° C. × 2 hr | 910 | 1/10 | flaked |
| | 118 | H2 | dip hardening | 1050° C. × 2 hr | 640 | 2/10 | flaked |
| Comp. | 111 | I2 | dip hardening | 830° C. × 2 hr | 210 | 10/10 | flaked |
| Example | 112 | J2 | dip hardening | 830° C. × 2 hr | 300 | 7/10 | flaked |
| | 113 | K2 | dip hardening | 1050° C. × 2 hr | 340 | 8/10 | flaked |
| | 114 | L2 | dip hardening | 1050° C. × 2 hr | 360 | 7/10 | flaked |
| | 115 | M2 | dip hardening | 960° C. × 2 hr | 410 | 10/10 | flaked |
| | 116 | N2 | dip hardening | 1000° C. × 2 hr | 350 | 10/10 | flaked |

Rolling bearings of Examples 113 to 116 shown in Table 16 manufactured from the tested materials C2 to F2. As the heat treatment, dip hardening was applied for the tested materials C2, E2, and F2, while carburization was applied for the tested material D2. In each of them, the amount of C ranged from 0.5 to 0.9 mass % and the amount of Cr ranged from 3.0 to 13.0 mass % which were within the recommended range of the invention. Accordingly, they tended to show longer life in the life test and the L₁₀ life was 1000 hrs or more.

Further, the rolling bearing of Example 111 was manufactured from the tested material A2. While Example 111 had a long life, flaking accompanied by structural change occurred in 2 out of 10 since the amount of Cr was somewhat smaller compared with Examples 113 to 116. However, it showed longer life when compared with each of the comparative examples to be described later.

Further, the rolling bearing of Example 112 was manufactured from the tested material B2. Since the amount of Cr was larger in Example 112 than in Example 111, it had somewhat longer life.

Further, rolling bearings of Examples 117 and 118 were manufactured from the tested materials G2 and H2. In Examples 117 and 118, since the amount of Cr was larger, flaking accompanied by structural change did not occur. However, since eutectic carbides were formed and flaking occurred being originated therefrom, the L₁₀ life was somewhat shorter compared with Examples 113 to 116.

On the contrary, while Comparative Example 111 was manufactured from bearing steel, 2nd class (SUJ2), since the amount of Cr an the amount of Si were not at optimal values, flaking accompanied by structural change occurred to shorten the life.

Further, Comparative Examples 112 and 113 were manufactured from the tested materials J2 and K2, respectively and the amount of Si was lower compared with each of the examples described above. Therefore, flaking accompanied by structural change occurred to shorten the life.

Further, Comparative Example 114 was manufactured from the tested material L2 in which the amount of Cr was large. Therefore, eutectic carbides were formed and flaking occurred being originated therefrom to shorten the life.

Further, Comparative Examples 115 and 116 were manufactured from the tested materials M2 and N2, respectively in which the amount of C was larger than the ax value. Therefore, fixation of C was lowered and eutectic carbides were formed to shorten the life.

FIG. 18 shows a relation between the amount of Cr and the life in the flaking reproduction test for Examples 111 to 118 and Comparative Examples 111 to 114.

As apparent from the drawing, the optimal ingredient range for the amount of Cr was from 2.5 to 17.0 mass %. In a case where the amount of Cr was smaller, the stability of the structure was insufficient tending to cause flaking accompanied by structural change to shorten the life. Further, in a case where the amount of Cr was larger, eutectic carbides were formed to shorten the life. For further stabilizing the structure and improving the life, the amount of Cr is more preferably from 4.0 to 13.0 mass %. For preventing lowering of fixation for C and formation of eutectic carbides, it is necessary that the α value is more than the amount of C.

Then, various amounts of conductive substance were blended with the grease described above (identical with those shown in Table 9). Then, a flaking test and a seizure test for rolling bearings lubricated with a grease blended with the conductive substances were conducted under a circumstance where static electricity was generated to the inner and outer rings as in the actual alternator.

The inner and outer rings and the rolling element were constituted with the bearing steel, 2nd class(SUJ2) and applied with usual heat treatment (hardening by heating at 830 to 1050° C., oil-cooling and then tempering at 160 to 240° C.). Thus, it was controlled such that the surface hardness HRC was from 57 to 63, the amount of retained austenite was from 0 to 20% for the inner and outer rings and the rolling element, the surface roughness for the raceway surface was from 0.010 to 0.040 μmRa for the inner and outer rings, and the surface roughness was from 0.003 to 0.010 μmRa for the rolling element.

Table 17 shows the result of the test. The recommended range for the blending amount of the conductive substance is from 0.1 to 10 mass % based on the entire amount of grease, and the blending amount of the conductive substance in each of Examples 121 to 130 is within the recommended range.

TABLE 17

| | | Conductive | | | | | |
|---|---|---|---|---|---|---|---|
| | | material blending | Flaking test | | | Seizure test | |
| | Test | amount | L₁₀ life | | | L₁₀ life | |
| | piece | (mass %) | (hr) | Flaking | | (hr) | Seizure |
| Example | 121 | 0.1 | 660 | 2/10 | flaked | 1000 | No seizure |
| | 122 | 0.2 | 720 | 2/10 | flaked | 1000 | No seizure |
| | 123 | 0.5 | 800 | 1/10 | flaked | 1000 | No seizure |
| | 124 | 1.5 | 940 | 1/10 | flaked | 1000 | No seizure |

| 125 | 2.0 | 1000 | No flaking | 1000 | No seizure | |
|---|---|---|---|---|---|---|
| 126 | 3.5 | 1000 | No flaking | 1000 | No seizure | |
| 127 | 5.0 | 1000 | No flaking | 1000 | No seizure | |
| 128 | 7.0 | 1000 | No flaking | 1000 | No seizure | |
| 129 | 7.5 | 1000 | No flaking | 910 | 1/10 | seized |
| 130 | 10.0 | 1000 | No flaking | 820 | 2/10 | seized |

| | | | | | | | |
|---|---|---|---|---|---|---|---|
| Comp. | 121 | 0 | 210 | 10/10 | flaked | 1000 | No seizure |
| Example | 122 | 0.05 | 310 | 10/10 | flaked | 1000 | No seizure |

| | | | | | | |
|---|---|---|---|---|---|---|
| 123 | 12.0 | 1000 | No flaking | 330 | 6/10 | seized |
| 124 | 13.0 | 1000 | No flaking | 300 | 7/10 | seized |
| 125 | 15.0 | 1000 | No flaking | 270 | 10/10 | seized |
| 126 | 20.0 | 1000 | No flaking | 230 | 10/10 | seized |

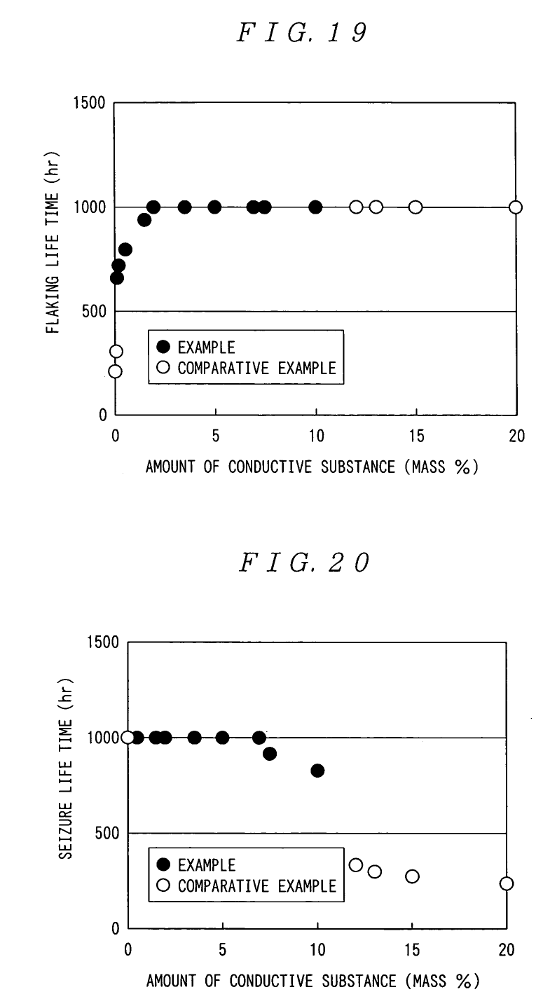

At first, the result of the flaking test is to be considered referring to Table 17 and FIG. 19. FIG. 19 is a graph showing a relation between the blending amount of the conductive substance and the flaking life for Examples 121 to 130 and Comparative Examples 121 to 126.

In Examples 125 to 130, occurrence of flaking was not observed in all ten specimens even when reaching 1000 hrs. This is considered to be attributable to that the inner ring and the outer ring can be electrically conducted during rotation of the bearing by blending the conductive substance by 3.5 to 10 mass % in the grease in a circumstance of causing flaking accompanied by structural change. As a result, it is considered that static electricity generated between the belt and the pulley of the alternator could be removed with no discharge between the inner ring and the outer ring.

In Examples 121 to 124, flaking occurred in one or two out of 10. This is considered to be attributable to the insufficiency of the electroconductivity during rotation of the bearing since the blending amount of the conductive substance was smaller compared with Examples 125 to 130.

On the contrary, flaking occurred in all ten specimens in Comparative Example 121 since the conductive substance was not blended with the grease. Further, in Comparative Example 122, since the conductive substance was blended by 0.05 mass % with the grease, it showed a longer life compared with Comparative Example 121. However, it showed a short life causing flaking in all ten specimens. This is considered to be attributable to that the potential difference was formed between the inner ring and the outer ring due to the insufficiency of the blending amount of the conductive substance in each of them to cause electric discharge.

Then, the result of the seizure test is to be considered referring to Table 17 and FIG. 20. FIG. 20 is a graph showing a relation between the blending amount of the conductive substance and the seizure life for Examples 121 to 130 and Comparative Examples 121 to 126.

In Examples 121 to 128, occurrence of seizure was not observed in all ten specimen even reaching 1000 hrs. Further, in Examples 129 and 130, the conductive substance was blended by 7.5 mass %, and 10 mass % respectively, but this lowered the consistency of the grease causing seizure in one or two outs of 10.

On the contrary, while Comparative Examples 123 to 126 showed long life in the flaking test but caused seizure in 6 to 10 out of 10 in the seizure test. It is considered to be attributable to the lower consistency of the grease although the conductivity was favorable since the conductive substance was blended in a great amount.

From the result of the two life tests, it can be seen that the amount of the conductive substance blended with the grease is preferably from 0.1 to 10 mass % based on the entire amount of the grease. In a case where the blending amount of the conductive substances is less than 0.1 mass %, no sufficient conductivity can be provided. On the other hand, when it is more than 10 mass %, the grease is hardened to possibly lower the seizure life. For improving the conductivity and the seizure life, the blending amount of the conductive substance is more preferably from 0.5 to 5 mass % based on the entire amount of the grease.

Then, the same flaking test and the seizure test as described above were conducted for the bearings of Examples 131 to 145 as shown in Table 18 (for flaking test, the test termination time was defined as 2000 hrs). In the bearings described above, three factors, that is, the kind of the tested materials consisting the bearing, the surface roughness for the raceway surface and the amount of the conducive substance blended with the grease were combined in various ways as shown in Table 18.

As the heat treatment, usual heat treatment (hardening by heating at 830 to 1050° C., oil-cooling and then tempering at 160 to 240° C.), was applied to control the surface hardness HRC from 57 to 63 and the amount of retained austenite from 0 to 20% for the inner and outer rings and the rolling element, and the raceway surface roughness from 0.01 to 0.040 μm for inner and outer rings. Further, the rolling element was constituted with SUJ2 (bearing steel, 2nd class), and the surface roughness was from 0.003 to 0.010 μmRa.

TABLE 18

| | | | | Conductive | | | | |
|---|---|---|---|---|---|---|---|---|
| | | | | material | | | Seizure test | |
| | | Surface | | blending | Flaking test | | L₁₀ life | |
| | Test | roughness | Tested | amount | L₁₀ life | | time | |
| | piece | (μm Ra) | material | (mass %) | (hr) | Flaking | (hr) | Seizure |
| Example | 131 | 0.06 | I2 | 0 | 1420 | 4/10 flaked | 1000 | No seizure |
| | 132 | 0.015 | E2 | 0 | 1490 | 3/10 flaked | 1000 | No seizure |
| | 133 | 0.015 | I2 | 5.0 | 1440 | 3/10 flaked | 1000 | No seizure |
| | 134 | 0.04 | C2 | 0 | 1870 | 1/10 flaked | 1000 | No seizure |
| | 135 | 0.06 | E2 | 0 | 2000 | No flaking | 1000 | No seizure |
| | 136 | 0.08 | F2 | 0 | 1770 | 2/10 flaked | 1000 | No seizure |
| | 137 | 0.025 | I2 | 2.0 | 1830 | 1/10 flaked | 1000 | No seizure |
| | 138 | 0.06 | I2 | 5.0 | 2000 | No flaking | 1000 | No seizure |
| | 139 | 0.08 | I2 | 7.0 | 1920 | 1/10 flaked | 1000 | No seizure |
| | 140 | 0.015 | C2 | 0.5 | 1890 | 1/10 flaked | 1000 | No seizure |
| | 141 | 0.015 | E2 | 5.0 | 2000 | No flaking | 1000 | No seizure |
| | 142 | 0.015 | F2 | 7.0 | 1910 | 1/10 Flaking | 1000 | No seizure |
| | 143 | 0.04 | A2 | 0.2 | 2000 | No flaking | 1000 | No seizure |
| | 144 | 0.06 | C2 | 3.5 | 2000 | No flaking | 1000 | No seizure |
| | 145 | 0.095 | E2 | 7.0 | 2000 | No flaking | 1000 | No seizure |

Examples 131 to 133 correspond to Examples 105, 115 and 127 described above respectively. Seizure did not occur till 1000 hrs and flaking occurred between 1400 and 1500 hrs.

Further, Examples 134 to 136 are bearings constituted with steels of larger amount of Cr with the center line average roughness for the raceway surface being coarser than that of usual bearings. Examples 137 to 139 are bearings with the center line average roughness for the raceway surface being coarser than that of usual bearings and sealed with a conductive grease. Examples 140 to 142 are bearings constituted with steels of larger amount of Cr and sealed with a conductive grease. Since the bearings described above satisfy two out of the three factors described above, they were outstandingly excellent in the flaking life over Examples 131 to 133.

Further, since Examples 143 to 145 satisfy all the three factors described above, flaking life was further excellent and flaking did not occur even when reaching 2000 hrs. As described above, flaking life is more excellent when more factors are satisfied among the three factors described above.

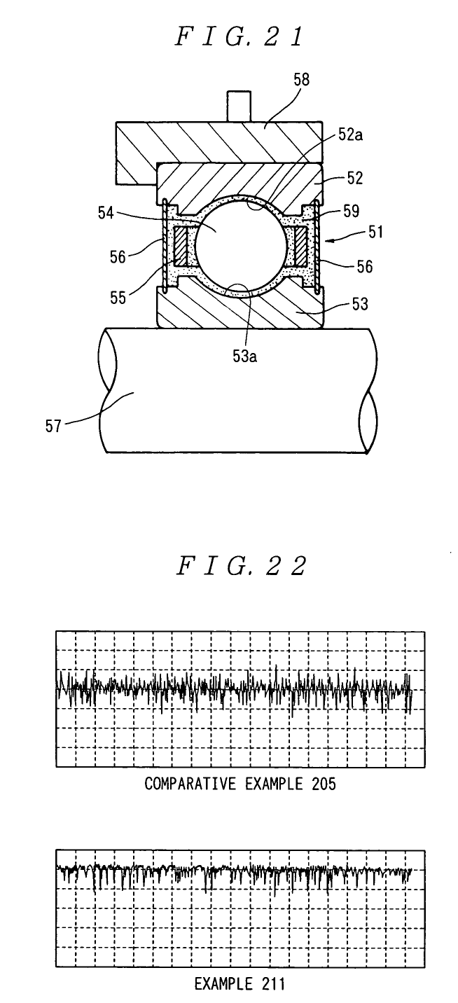

(2) Then, another embodiment (sixth embodiment) of a rolling bearing for use in an engine auxiliary equipment or a gas heat pump and lubricated with grease is to be described with reference to the cross sectional view of FIG. 21.

A rolling bearing 51 in FIG. 21 is a deep groove ball bearing of JIS bearing designation 6303 in which an outer ring 52 is fixed to a housing 58 as a fixed ring while an inner ring 53 is fitted over a shaft 57 as a rotational ring. Further, plural rolling elements 54 held by a cage 55 are arranged between the raceway surface 52a of the outer ring 52 and the raceway surface 53a of the inner ring 53, and seal members 56, 56 are mounted between the outer ring 52 and the inner ring 53 at the positions on both sides of the cage 55.

Further, a grease 59 is sealed in a space surrounded with the seal members 56, 56. Then, in the rolling bearing 51, the inner ring 53 rotates along with the rotation of a shaft 57, and vibration and load caused by the rotation exert from the shaft 57 by way of the inner ring 53 and the rolling element 54 to a loading zone of the outer ring 52.

The inner and outer rings 52 and 53 were constituted with a high carbon chromium bearing steel SUJ2. Then, for the outer ring 53, a steel material formed into a predetermined shape was applied with hardening and tempering and then finishing fabrication by grinding under various conditions thereby varying the center average roughness and skewness for the raceway surface to various values (refer to Table 19). Further, for the inner ring 53, after applying the same treatment as for the outer ring 53, finishing fabrication by grinding was applied to control the center line average roughness for the raceway surface to about 0.01 to 0.03 μm. The rolling element 54 is a steel ball made of SUJ2 corresponding to ball grade 20.

FIG. 22 shows examples (Example 211 and Comparative Example 205) as a result of measuring the center average roughness for the raceway surface of the outer ring 52.

TABLE 19

| | | Center line | | | |
|---|---|---|---|---|---|
| | Test | average roughness | | Kind of | |
| | piece | (μmRa) | Skewness | grease | Life |
| Example | 201 | 0.018 | −0.521 | A | 2.78 |
| | 202 | 0.024 | −1.091 | A | 3.84 |
| | 203 | 0.035 | −1.981 | A | 4.88 |
| | 204 | 0.035 | −2.310 | A | 5.91 |
| | 205 | 0.037 | −3.581 | A | 6.06 |
| | 206 | 0.051 | −4.482 | A | 6.47 |
| | 207 | 0.077 | −2.107 | A | 6.25 |
| | 208 | 0.019 | −0.810 | B | 4.56 |
| | 209 | 0.022 | −1.023 | B | 6.25 |
| | 210 | 0.034 | −1.560 | B | 6.88 |
| | 211 | 0.037 | −2.822 | B | 7.19 |
| | 212 | 0.033 | −4.210 | B | 7.03 |
| | 213 | 0.059 | −3.623 | B | 7.50 |
| | 214 | 0.021 | −1.091 | C | 6.97 |
| | 215 | 0.029 | −1.210 | C | 7.44 |
| | 216 | 0.041 | −2.333 | C | 7.91 |
| | 217 | 0.058 | −3.542 | C | 8.16 |
| | 218 | 0.031 | −3.884 | C | 8.06 |
| Comp. | 201 | 0.017 | 0.216 | A | 1.00 |
| Example | 202 | 0.022 | 0.412 | A | 0.81 |
| | 203 | 0.023 | −0.317 | A | 1.25 |
| | 204 | 0.028 | −0.382 | A | 1.44 |
| | 205 | 0.052 | −0.378 | A | 1.94 |
| | 206 | 0.022 | 0.221 | B | 1.75 |
| | 207 | 0.028 | −0.313 | B | 1.88 |
| | 208 | 0.026 | −0.189 | C | 2.00 |
| | 209 | 0.009 | −0.511 | A | 1.94 |
| | 210 | 0.089 | 0.406 | A | 1.97 |

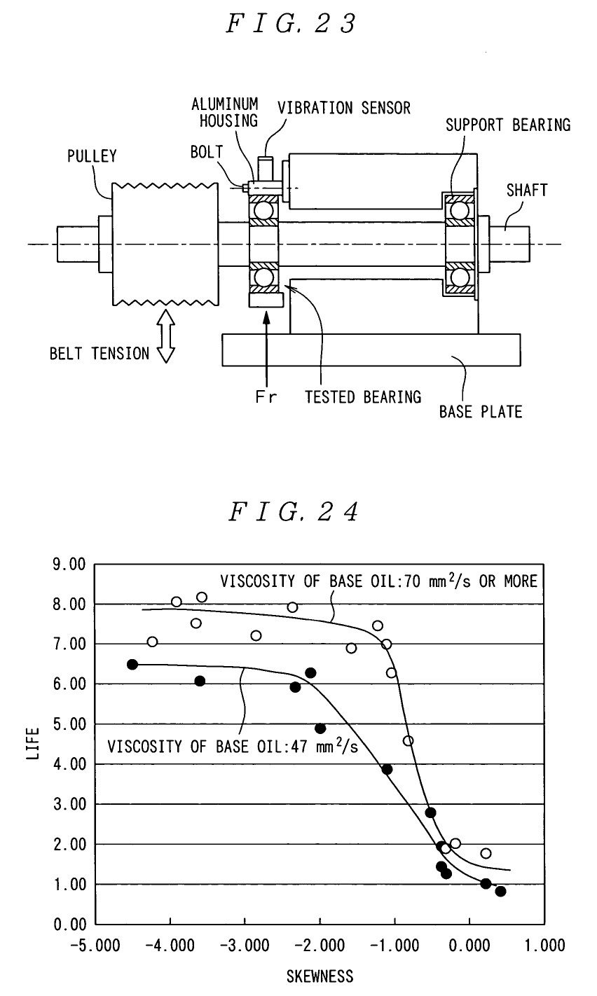

Life for the deep groove ball bearings under grease lubrication was evaluated. The grease lubrication life test was conducted by using a tester as shown in FIG. 23. Then, assuming the use in engine auxiliary equipments, a rapid acceleration/deceleration test of switching the rotational speed (between 9000 min⁻¹ and 18,000 min⁻¹) on every predetermined time (for example, on every 9 sec) was conducted.

The time up to the occurrence of flaking in the bearings was defined as a life, which was indicated by a relative value with the bearing life of Comparative Example 201 being assumed as 1. Since the calculated life of the deep groove ball bearing under the conditions described above is 1350 hrs, the test termination time was defined as 3000 hrs which is twice or more the calculated life and, in a case where flaking did not occur up to the test termination time, the life was defined as 3000 hrs.

The loading condition for the grease lubrication life test was at: P (dynamic equivalent load)/C (fundamental dynamic load rating)=0.10, and one of three types of urea-based grease of different viscosity of the base oil (No. A to No. C) was used for the lubricant. The viscosity of the base oil in each of the greases is 47.3 mm²/s for No. A grease, 79.0 mm²/s for No. B grease and 103.0 mm²/s for No. C grease.

As can be seen from the test result shown in Table 19, since the bearing of Examples 201 to 218 had a center line average roughness for the raceway surface of the fixed ring of from 0.01 to 0.08 μmRa and the skewness thereto of −5.0 to −0.5, they had long life. It is considered that this is attributable to high lubricant retainability due to concave parts at the surface of the raceway surface and suppression of decomposition of the lubricant or water content contained in the lubricant in the contact surface due to reduced number of protrusions tending to cause electric discharge.

Particularly, the life was longer in a case where the skewness was from −5.0 to −1.0 and, further, a bearing having a viscosity for the base oil of the grease was 70 mm²/s or more did not cause flaking at all even after 2000 hrs.

On the contrary, the life was short in each of the Comparative Examples 201 to 210. For example, in Comparative Example 209, since the center average roughness for the raceway surface was excessively small, oil film was not formed sufficiently to cause rotation slip of the rolling element in the circumstance in which vibrations, etc. Then, since a shearing stress was loaded on the grease to evolve hydrogen, the bearing life was shortened.

Further, in Comparative Example 210, since the center line average roughness for the raceway surface was excessively large, an oil film could not be formed sufficiently to cause metal contact between the raceway surface and the rolling element. Then, since flaking occurred to the raceway surface, the bearing life was shortened.

FIG. 24 shows a relation between the skewness on the raceway surface and the bearing life in a case where the center average roughness for the raceway surface is from 0.01 to 0.08 μmRa. It can be seen also from the graph that the skewness on the raceway surface has a great influence on the life of the bearing.

Then, bearings having the same constitution as those of the rolling bearing 51 described above, only the grease being changed were provided. That is, greases blended with various amounts of conductive substances (carbon black) to the greases shown in Table 19 were filled inside the bearings. Then, a flaking test and a seizure test for rolling bearings lubricated with greases blended with conductive substances were conducted in a circumstance where static electricity is generated between the inner and outer rings as in actual alternators. The test conditions were at a constant rotational speed of 20,000 min⁻¹, at a bearing temperature of 160° C. and under a radial load of 98N in both of the tests. Then, the time at which seizure occurred to the bearing and the temperature of the outer ring reached 165° was defined as the seizure life and the test termination time was defined as 3000 hrs. Further, the time till flaking occurred to the bearing was defined as the flaking life and the test termination time was defined as 3,000 hrs.

Table 20 shows the result of both of the tests. The numerical values for the flaking life shown in the table are shown by relative values assuming the flaking life of the bearing of Comparative Example 211 as 1.

TABLE 20

| | | | | | Conductive | | |
|---|---|---|---|---|---|---|---|
| | | Center line | | | material | | |
| | | average | | | blending | Seizure | |
| | Test | roughness | | Grease | amount | life | Flaking |
| | piece | (μmRa) | Skewness | (base) | (mass %) | (hr) | life |
| Example | 219 | 0.017 | −0.621 | A | 9.9 | 857 | 17.97 |
| | 220 | 0.023 | −1.231 | A | 5.0 | 1000 or more | 18.22 |
| | 221 | 0.036 | −2.289 | A | 2.1 | 1000 or more | 17.77 |
| | 222 | 0.038 | −3.785 | A | 0.1 | 1000 or more | 10.01 |
| | 223 | 0.022 | −0.920 | B | 4.0 | 1000 or more | 19.22 |
| | 224 | 0.037 | −2.822 | B | 4.0 | 1000 or more | 20.45 |
| | 225 | 0.033 | −4.210 | B | 4.0 | 1000 or more | 22.21 |
| | 226 | 0.045 | −3.723 | B | 4.0 | 1000 or more | 21.23 |
| | 227 | 0.021 | −1.061 | C | 4.0 | 1000 or more | 23.34 |
| | 228 | 0.023 | −1.220 | C | 4.0 | 1000 or more | 23.35 |
| | 229 | 0.048 | −3.542 | C | 4.0 | 1000 or more | 24.31 |
| | 230 | 0.037 | −3.884 | C | 4.0 | 1000 or more | 24.29 |
| Comp. | 211 | 0.019 | 0.223 | A | 0 | 845 | 1.00 |
| Example | 212 | 0.022 | −0.391 | B | 0 | 1000 or more | 1.69 |
| | 213 | 0.022 | −0.320 | A | 12.2 | 350 | 16.63 |
| | 214 | 0.028 | −0.482 | A | 12.5 | 432 | 17.56 |
| | 215 | 0.028 | −0.313 | B | 12.3 | 310 | 18.79 |
| | 216 | 0.026 | −0.189 | C | 12.2 | 280 | 19.21 |

As can be seen from the result of the test shown in Table 20, in the bearings of Examples 219 to 230, since the center line average roughness for the raceway surface was from 0.01 to 0.08 μmRa, the skewness thereof was from −5.0 to −0.5 for the fixed ring and, further, predetermined amounts of conductive substances were blended in the greases, they did not cause flaking accompanied by structural change to provide long life. Particularly, seizure did not occur even after 1000 hrs except for Example 219 with the blending amount of the conductive substance as high as 9.9 mass %. Then, in view of the comparison with the result shown in Table 19, it was confirmed that the life was improved by blending the conductive substance with the grease.

As can be seen from the results, an extremely high flaking life can be attained while ensuring the seizure life by blending the conductive substance by the prescribed amount to the grease while controlling the center line average roughness and the skewness for the raceway surface of the fixed ring to the predetermined range as described above.

Then, the flaking test and the seizure test were conducted in the same manner as described above for rolling bearings in which inner and outer rings were constituted with a steel containing from 2.0 to 16.0 mass % of Cr (refer to Table 21). The constitution of the bearings is substantially identical with those of the rolling bearing 51 described above except for the amount of Cr in which the greases blended with the conductive substance were filled.

TABLE 21

| | | | | | | | Conductive | | |
|---|---|---|---|---|---|---|---|---|---|
| | | | | Center line | | | material | | |
| | | | | average | | | blending | Seizure | |
| | Test | Cr amount | Hardness | roughness | | Grease | amount | life | Flaking |
| | piece | (mass %) | (HRC) | (μmRa) | Skewness | (base) | (mass %) | (hr) | life |
| Example | 231 | 2.0 | 63.2 | 0.029 | −1.921 | A | 0.0 | 1000 or more | 9.81 |
| | 232 | 2.0 | 63.2 | 0.028 | −1.871 | C | 0.0 | 1000 or more | 12.33 |
| | 233 | 2.0 | 63.2 | 0.028 | −1.881 | A | 4.0 | 1000 or more | 24.92 |
| | 234 | 2.0 | 63.2 | 0.027 | −1.903 | C | 4.0 | 1000 or more | 27.83 |
| | 235 | 3.0 | 62.2 | 0.022 | −1.229 | A | 0.0 | 1000 or more | 12.19 |
| | 236 | 4.0 | 61.9 | 0.036 | −2.314 | A | 0.0 | 1000 or more | 13.22 |
| | 237 | 4.0 | 57.8 | 0.038 | −3.645 | A | 0.0 | 1000 or more | 14.33 |
| | 238 | 5.0 | 56.1 | 0.045 | −1.781 | C | 0.0 | 1000 or more | 17.33 |
| | 239 | 5.0 | 61.8 | 0.036 | −2.487 | A | 0.0 | 1000 or more | 16.05 |
| | 240 | 5.0 | 61.8 | 0.035 | −2.381 | C | 0.0 | 1000 or more | 18.09 |
| | 241 | 5.0 | 61.8 | 0.036 | −2.444 | A | 4.0 | 1000 or more | No flaking |
| | 242 | 5.0 | 61.8 | 0.032 | −2.502 | C | 4.0 | 1000 or more | No flaking |
| | 243 | 5.0 | 61.8 | 0.037 | −2.556 | C | 0.0 | 1000 or more | 18.03 |
| | 244 | 7.0 | 62.2 | 0.033 | −4.002 | C | 0.0 | 1000 or more | 23.47 |
| | 245 | 9.0 | 60.4 | 0.034 | −3.718 | C | 0.0 | 1000 or more | 28.61 |
| | 246 | 13.0 | 61.8 | 0.021 | −1.278 | A | 0.0 | 1000 or more | No flaking |
| | 247 | 13.0 | 61.8 | 0.023 | −1.119 | C | 0.0 | 1000 or more | No flaking |
| | 248 | 13.0 | 61.8 | 0.024 | −1.121 | C | 4.0 | 1000 or more | No flaking |
| | 249 | 13.0 | 58.4 | 0.038 | −1.989 | A | 0.0 | 1000 or more | No flaking |
| | 250 | 16.0 | 59.6 | 0.029 | −1.386 | A | 0.0 | 1000 or more | No flaking |
| Comp. | 217 | 1.5 | 62.4 | 0.019 | 0.301 | A | 0.0 | 830 | 1.00 |
| Example | 218 | 1.5 | 62.4 | 0.022 | −0.301 | C | 0.0 | 820 | 1.88 |
| | 219 | 3.0 | 62.2 | 0.024 | 0.201 | A | 0.0 | 825 | 4.88 |
| | 220 | 17.0 | 61.8 | 0.025 | 0.412 | A | 0.0 | 645 | 5.31 |
| | 221 | 17.0 | 61.8 | 0.028 | −1.021 | A | 4.0 | 785 | 5.19 |

The amount of the alloying ingredients other than Cr in the steel constituting the bearings for each of the examples was from 0.65 to 0.70 mass % of C, from 0.5 to 1.0 mass % of Si and from 0.3 to 0.5 mass % of Mn. Further, the bearings of the comparative examples were constituted each with SUJ2 comprising 1.5 mass % of Cr or SUS 440C comprising 17 mass % of Cr.

Inner and outer rings were manufactured by forming steel materials each into a predetermined shape and applying hardening and tempering. After hardening and tempering, the inner and outer rings was applied with finishing fabrication by grinding, and finishing fabrication by grinding was applied under various conditions only to the fixed ring (outer ring), to change the center line average roughness and the skewness for the raceway surface (refer to Table 21). For the rotational ring (inner ring), the center line average roughness for the raceway surface was controlled to about 0.01 to 0.03 μm.

Table 21 shows the result of a flaking test and a seizure test. Conditions in both of the tests were quite identical with the conditions in both of the tests in Table 20. Further, the numerical values for the flaking life shown in Table 21 are shown by relative values assuming the flaking life of the bearing of Comparative Example 217 being assumed as 1.

In the bearings of Examples 231 to 250, since the center line average surface and the skewness for the raceway surface are within the preferred range described above, and the amount of Cr in the steel constituting the fixed ring was 2.0 mass % or more, both the flaking life and the seizure life were long. Particularly, those in which a conductive substance was blended by a predetermined amount in the grease showed extremely long flaking life.

On the contrary, in the bearings of Comparative Examples 217 and 128, since the skewness was out of the preferred range described above, and the amount of Cr in the steel constituting the fixed link was small, flaking life was short. Further, while the bearing of Comparative Example 219 was an example having 3.0 mass % of the amount of Cr in the steel constituting the fixed ring, since the skewness was out of the preferred range described above, the flaking life was poor compared with the examples. Further, in the bearings of the Comparative Examples 220 and 221, since the amount of Cr was large in the steel constituting the fixed ring and a number of coarse eutectic carbides formed in the solidifying process were present, they showed short life irrespective of the center line average roughness and the skewness on the raceway surface

As has been described above, the flaking life and the seizure life can be made extremely longer by controlling the amount of Cr in the steel constituting the fixed ring to 2.0 to 16.0 mass %, and blending the predetermined amount of the conductive substance (0.1 to 10 mass %) with the grease, while controlling the center line average roughness and the skewness for the raceway surface of the fixed ring to the predetermined range as described above.

In this embodiment, while the fixed ring often tending to cause flaking satisfied each of the conditions described above regarding the center line average roughness, the skewness and the amount of Cr, the rotational ring may also satisfy each of the conditions.

(3) Then, an embodiment of a rolling bearing for use in an engine auxiliary equipment or a gas heat pumps, and lubricated with grease which is particularly suitable to the application use described above (seventh embodiment) is to be described.

At first, each of the ingredients constituting the grease is to be described.

(For Base Oil)

There is no particular restriction on the kind of the base oil usable for the grease and any of those used generally as the base oil for the grease can be used with no problems. However, for avoiding generation of abnormal sounds due to insufficiency of fluidity at a low temperature and seizure caused by insufficiency of oil film at high temperature, the kinetic viscosity of the base oil at 40° C. is preferably from 10 to 400 mm²/s, more preferably, from 20 to 250 mm²/s and, further preferably, from 40 to 150 mm²/s.

Specific examples of the base oil can include, for example, mineral oil type lubricants, synthesis oil type lubricants and natural oil type lubricants.

The mineral oil type lubricant can include paraffinic mineral oils, naphthenic mineral oils and mixed oils thereof which may be refined for use by at least one of vacuum distillation, oil deasphalting, solvent extraction, hydrogenblysis, solvent dewaxing, sulfuric acid cleaning, white clay purification, hydrogenating refining, etc.

Further, the synthesis oil type lubricant can include, for example, synthesis hydrocarbon oils (aliphatic, aromatic), ester oils and ether oils.

The aliphatic synthesis hydrocarbon oils can include, for example, poly-α-olefins such as normal paraffin, isoparaffin, polybutene, polyisobutylene, 1-decene oligomer, and co-oligomer of 1-decene and ethylene, or hydrogenated products thereof. Further, the aromatic synthesis hydrocarbon oils can include, for example, alkyl benzenes such as monoalkyl benzene and dialkyl benzene and alkyl naphthalenes such as monoalkyl naphthalene, dialkyl napnthalene and polyalkyl naphthalene.

The ester oils can include, for example, diester oils such as dibutyl sebacate, di-2-ethylhexyl sebacate, dioctyl adipate, diisodecyl adipate, ditridecyl adipate, ditridecyl glutalate, and methyl acetyl cineolate, aromatic ester oils such as trioctyl trimellitate, tridecyl trimellitate, and tetraoctyl pyromellitate, polyol ester oils such as trimethylolpropane capriate, trimethylolpropane pelargonate, pentaerythritol-2-ethylhexanoate and pentaerythritol pelargonate, and complex ester oils as an oligo ester of a mixed fatty acid of a monobasic acid and a dibasic acid and a polyhydric alcohol.

The ether oils can include, for example, polyglycols such as polyethylene glycol, polypropylene glycol, polyethtylene glycol monoether, polypropylene glycol monoether, and phenyl ether oils such as monoalkyl triphenyl ether, alkyl diphenyl ether, dialkyl diphenyl ether, tetraphenyl ether, pentaphenyl ether, monoalkyl tetraphenyl ether, and dialkyl tetraphenyl ether.

Other synthesis oil lubricants than those described above can include, for example, tricresyl phosphate, silicone oil and perfluoro alkyl ether.

Further, natural oil type lubricant can include, for example, oil and fat type oils such as beef tallow, lard, soybean oil, rapeseed oil, bran oil, coconut oil, palm oil, palm nuclei oil for hydrogenated products thereof.

The base oils may be used alone or two or more of them may be properly combined for use.

(For Diurea Compound)

At least one of diurea compounds of the chemical formulae (1) to (3) described above is added as a thickening agent to the grease

R₁ in the chemical formulae (1) and (2) represents an aromatic ring-containing hydrocarbon group (7 to 12 carbon atoms in total). They can include, specifically, toluyl group, xylyl group, t-butylphenyl group, benzyl group, and methylbenzyl group.

Further, R₂ in the chemical formulae (1) to (3) represents a bivalent aromatic ring-containing hydrocarbon group (6 to 15 carbon atoms in total). They can include specifically a linear or branched alkylene group, cyclalkylene group and aromatic group.

Further, R₃ in the chemical formulae (2) and (3) represents a cyclohexyl group or an alkylcyclohexyl group (7 to 12 carbon atoms in total). Specifically, they can include, for example, methyl cyclohexyl group, dimethyl cyclohexyl group, propyl cyclohexyl group, isopropyl cyclohexyl group, 1-methyl-3-propyl cyclohexyl group, butyl cyclohexyl group, pentyl cyclohexyl group, pentylmethyl cyclohexyl group, and hexyl cyclohexyl group.

Further, it is necessary that the content of the diurea compounds of the chemical formulae (1) to (3) in the grease satisfies the condition represented by the formula (4) above. That is, it is preferred that the content of the diurea compound for the chemical formulae (1) to (3) in total is from 5 to 35 mass % based on the entire grease.

In a case where it is less than 5 mass %, since the effect as the thickening agent is insufficient, the grease is not sufficiently greasy, or the amount of grease leaked from the inside of the bearing increases. For suppressing such a problem, the content of the diurea compounds of the chemical formulae (1) to (3) in total is, more preferably, 10 mass % or more and, further preferably, 13 mass % or more based on the entire grease.

On the other hand, in a case where it exceeds 35 mass %, since the grease is hardened excessively, the lubricating performance is insufficient. For suppressing such a problem, the content of the diurea compounds of the chemical formulae (1) to (3) in total is, more preferably, 30 mass % or less and, further preferably, 25 mass % or less based on the entire grease.

Further, it is necessary that the content of the diurea compounds of the chemical formulae (1) to (3) satisfies the condition represented by the formula (5) described above. That is, the value (W₁+0.5×W₂)/(W₁+W₂+W₃) is, preferably, from 0 to 0.55. In a case where the value exceeds 0.55, the seizure life at a high temperature is shortened and, in order to make the seizure life longer at a high temperature, the value is, more preferably, from 0.1 to 0.4 and, further preferably, from 0.2 to 0.3.

(For Naphthenate as Additive)

A naphthenate is added to the grease as an additive. There is no particular restriction on the kind of the naphthenic acid but it is preferably a saturated carboxylic acid. Specific examples of such naphthenate can include, for example, saturated mononuclear carboxylate (CₙH₂ₙ₋₁COOM), saturated polynuclear carboxylate (CₙH₂ₙ₋₃COOM), and derivatives thereof. Further, as the saturated mononuclear carboxylate, those compounds represented by the following chemical formulae (12) and (13) are preferred. 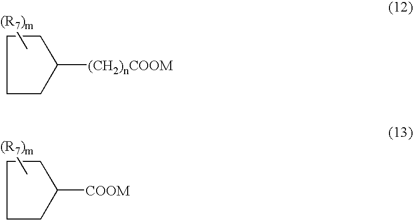
in which R₇ in the chemical formulae (12) and (13) represents a hydrocarbon group such as alkyl group, alkenyl group, aryl group or aralkyl group. Further, M represents a metal element such as Co, Mn, Zn, Al, Ca, Ba, Li, Mg, and Cu. Such naphthenates may be used alone, or two or more of them may be combined properly for use.

The content of the naphthenate is, preferably, from 0.1 to 10 mass % based on the entire grease. In a case where it is less than 0.1 mass %, no sufficient rust-preventive effect can be provided to the grease. On the other hand, in a case where it exceeds 10 mass %, the grease is softened and the grease tends to be leaked from the bearing. For suppressing such a problem, the content of the naphthenate is, preferably, from 0.25 to 5 mass % based on the entire grease.

(For Succinic Acid or Derivative Thereof as Additive)

Succinic acid or derivatives thereof is added as an additive to the grease. While there is no particular restriction on the type, they can include, for example, succinic acid, alkyl succinic acid, alkyl succinic acid half ester, alkenyl succinic acid, alkenyl succinic acid half ester and succinic acid imide. Such succinic acid or the derivatives thereof may be used alone or two or more of them may be properly combined for use.

The content of succinic acid or the derivatives thereof is, preferably, from 0.1 to 10 mass % based on the entire grease. In a case where it is less than 0.1 mass %, no sufficient rust-preventive effect can be provided to the grease. On the other hand, in a case where it exceeds 10 mass %, grease is softened and the grease tend to leak from the bearing. For suppressing such a problem, the content of succinic acid or the derivative thereof is, more preferably, from 0.25 to 5 mass % based on the grease.

(For Metal Compound as Additives)

For improving the flaking life and the seizure life at a high temperature, at least one of the metal compounds of the chemical formulae (6) to (11) described above is added to the grease as an additive.

R₄ in the chemical formulae (6) and (7) represents a hydrocarbon group with a number of carbon atoms of 1 to 18. R₄ in one identical molecule may be hydrocarbon groups of an identical type or may be hydrocarbon groups of different types. The hydrocarbon group represented by R₄ can include, for example, alkyl group, cycloalkyl group, alkenyl group, aryl group, alkylaryl group, and arylalkyl group. More specifically, they can include, particularly preferably, 1,1,3,3-tetramethylbutyl group, 1,1,3,3-tetramethyhexyl group, 1,1,3-trimethylhexyl group, 1,3-dimethylbutyl group, 1-methylundecanic group, 1-methylhexyl group, 1-methylpentyl group, 2-ethylbutyl group, 2-ethylhexyl group, 2-methylcyclohexyl group, 3-heptyl group, 4-methylcyclohexyl group, n-butyl group, isobutyl group, isopropyl group, isoheptyl group, isopentyl group, undecyl group, aicosyl group, ethyl group, octadecyl group, octyl group, cyclooctyl group, cyclododecyl group, cyclopentyl group, dimethylcyclohexyl group, decyl group, tetradecyl group, docosyl group, dodecyl group, tridecyl group, trimethylcyclohexyl group, nonyl group, propyl group, hexadecyl group, hexyl group, heptadecyl group, heptyl group, pentadecyl group, pentyl group, methyl group, tertiarybutyl cyclohexyl group, tertiarybutyl group, 2-hexenyl group, 2-methalyl group, allyl group, undecenyl group, oleyl group, decenyl group, vinyl group, butenyl group, hexenyl group, heptadecenyl group, tolyl group, ethylphenyl group, isopropylphenyl group, tertiarybutylphenyl group, secondary pentylphenyl group, n-hexylphenyl group, tertiary octylphenyl group, isononylphenyl group, n-dodecylphenyl group, phenyl group, benzyl group, 1-phenylmethyl group, 2-phenylethyl group, 3-phenylpropyl group, 1,1-dimethylbenzyl group, 2-phenylisopropyl group, 3-phenylhexyl group, benzhydryl group and biphenyl group. The hydrocarbon groups may have an ether bond.

Further, M in the chemical formulae (6) and (7) represents a metal element and it can include, specifically, Sb, Bi, Sn, Ni, Te, Se, Fe, Cu, Mo, and Zn.

Further, R₅ in the chemical formulae (8) to (10) represents hydrogen or a hydrocarbon group of 1 to 18 carbon atoms. R₅ in one identical molecule may be of an identical group or different groups. Among the zinc compounds represented by the chemical formulae (8) to (10), zinc mercapto benzothiazolate in which each R₅ in the chemical formula (8) is hydrogen, zinc benzoamide thiophenolate which is a compound in which each R₅ in the chemical formula (9) is hydrogen and zinc mercapto benzoimidazolate which is a compound in which R₅ in the chemical formula (10) is hydrogen.

Further, R₆ in the chemical formula (11) represents a hydrocarbon group of 1 to 18 carbon atoms.

The metal compounds represented by the chemical formulae (6) to (11) may be used alone or two or more of them may be combined properly for use. However, the content is, preferably, from 0.1 to 10 mass % based on the entire grease. In a case where it is less than 0.1 mass %, it is difficult to improve the flaking life and the seizure life at high temperature sufficiently. On the other hand, in a case where it exceeds 10 mass %, the metal compound and the bearing material may possibly take place reaction and the seizure life at a high temperature may possibly be shortened. Further, since the metal compounds described above are relatively expensive, this results in increase of the grease cost. For suppressing such a problem, the content of the metal compound is, more preferably, from 0.5 to 10 mass % based on the entire grease.

(For Other Additives)

For further improving various performances, various additives may be added as required to the grease. For example, additives used generally for grease such as metal soap, gelling agent, anti-oxidant, extreme pressure agent, oily agent, rust-preventing agent, metal passivating agent or viscosity index improver may be used alone or as a combination of two or more of them.

The gelling agent can include, for example, benton and silica gel, and the anti-oxidant can include, for example, amine type, phenol type or sulfur type anti-oxidant. Further, the extreme pressure agent can include, for example, hydrogen chloride type or sulfur type extreme pressure agents, and oily agents can include, for example, fatty acids and animal and plant oils. Further, the rust-preventing agent can include, for example, sorbitan ester, and the metal passivating agent can include, for example, benzotriazole and sodium nitrite. Further, the viscosity index improver can include, for example, polymethacrylate, polyisobutene and polystyrene.

There is no particular restriction for the content of the additives in total so long as it is within the extent of not deteriorating the purpose of the present invention and usually it is 20 mass % or less based on the entire grease. In a case where it is added by more than 20 mass %, no further improvement for the addition effect can be expected, as well as this decreases the amount of the base oil relatively to possibly lower the lubricating effect.

(For Manufacturing Method of Grease)

When the grease is prepared, the diurea compound, naphthenate, succinic acid or derivatives thereof described above and, optionally, the metal compounds described above are added to the base oil and mixed uniformly. However, the diurea compound can be synthesized from the starting material thereof in the base oil. Accordingly, the grease can be prepared also by adding the naphthenate or the like after synthesizing the diurea compound.

Then, rolling bearings filled with the grease as described above to the inside are to be described. In this embodiment, a flaking reproduction test and a seizure test were conducted as the life test for the rolling bearings. For the flaking reproduction tester, a rapid acceleration/deceleration tester described in Japanese Unexamined Patent Publication No. Hei 9-89724 was used, for example. Then, the test was conducted under the condition, for example, of switching the rotational speed between 9000 min⁻¹ and 18000 min⁻¹ on every predetermined time of about 9 sec.

For both of examples of the present invention and comparative examples, JIS bearing designation 6303 (17 mm inner diameter, 47 mm outer diameter, and 14 mm width) was used for the tested bearing, the bearing clearance was 10 to 15 μm, the loading condition was at: P (applied load)/C (dynamic load rating)=0.10, and the test temperature was set constant at 80° C. Since the calculated life of the bearing is 1350 hrs, the test termination time was defined as 2000 hrs. When the vibration value increased up to five times the initial vibrations, the test was interrupted and the absence or presence of flaking was confirmed. Test was conducted for each type of bearings each by the number of 10.

Further, the rapid acceleration/deceleration tester was used also for the seizure test. However, the test was conducted continuously at a constant rotational speed of 2000 min⁻¹, at a bearing temperature of 180° C. and under a radial load of 98 N. The type of the tested bearings and the conditions were identical with those for the flaking reproduction test. Then, when seizure occurred and the temperature of the bearing outer ring increased to 190° C. or higher, the test was terminated. Further, in a case where the temperature of the bearing outer ring did not increase to 190° C. or higher even after the test for 1000 hrs, the test was terminated. The test was conducted for each type of bearings each by the number of 10.

Further, a rust-preventive test for bearing was also conducted. The tested bearings used were identical with those described above but provided with a contact type rubber seal. The test method is as described below. At first, 2.3 g of grease was sealed to the inside of the bearing, which was rotated at 1800 min⁻¹ for one min. After stopping the rotation, 0.5 ml of 0.5 mass % saline was injected to the inside of the bearing, which was further rotated at 1800 min⁻¹ for one min. After leaving the bearing in a circumstance at 52° C., 100% RH for 48 hrs, the raceway surface for the inner and outer rings of the bearing was observed to investigate the amount of rust formed. Then, it was evaluated as “1” in a case where rust was not formed, “2” in a case where small rust was formed but the number thereof was three or less and as “3” in a case where four or more small rusts were formed.

In each of the tests described above, tested materials of Examples A3 to H3 and Comparative Examples I3 to K3 shown in Table 22 were used for the inner and outer rings of the bearings, which were applied with usual heat treatment (hardening by heating at 830 to 1050° C., oil cooling and then tempering at 160 to 240° C.) and used. The rolling element was constituted with SUJ2 (bearing steel, 2nd class). Further, it was controlled such that the surface hardness HRC was from 57 to 63 and the amount of retained austenite was from 0 to 20% for the inner and the outer rings and the rolling elements. It was controlled such that the center line average roughness for the raceway surface of the inner and outer rings was from 0.010 to 0.40 μmRa, and the center line average roughness on the surface of the rolling element was from 0.003 to 0.010 μmRa.

TABLE 22

| | Tested | Steel composition (mass %) | | | | | | α | | |
|---|---|---|---|---|---|---|---|---|---|---|
| | material | C | Si | Mn | Cr | Mo | V | value | Heat treatment | |
| Example | A3 | 0.9 | 0.20 | 0.50 | 2.50 | 0.20 | 0.20 | 1.24 | Dip hardening | 830° C. × 2 hr |
| | B3 | 1.20 | 1.0 | 0.40 | 3.0 | | | 1.26 | Dip hardening | 830° C. × 2 hr |
| | C3 | 0.80 | 0.50 | 1.0 | 4.0 | 2.00 | | 0.97 | Dip hardening | 850° C. × 2 hr |
| | D3 | 0.55 | 0.45 | 0.50 | 7.0 | 0.40 | | 1.01 | Carburization | 930° C. × 2 hr |
| | E3 | 0.75 | 1.50 | 0.20 | 9.5 | | 0.20 | 0.91 | Dip hardening | 960° C. × 2 hr |
| | F3 | 0.70 | 1.0 | 0.50 | 13.0 | 0.50 | | 0.70 | Dip hardening | 1000° C. × 2 hr |
| | G3 | 0.50 | 0.75 | 0.80 | 15.0 | 0.10 | 1.0 | 0.53 | Carburization | 1000° C. × 2 hr |
| | H3 | 0.55 | 1.0 | 0.40 | 17.0 | 0.10 | | 0.55 | Dip hardening | 1050° C. × 2 hr |
| Comp. | I3 | 0.95 | 0.35 | 0.38 | 1.45 | | | 1.34 | Dip hardening | 830° C. × 2 hr |
| Example | J3 | 0.80 | 0.50 | 0.40 | 2.0 | 0.50 | | 1.25 | Dip hardening | 830° C. × 2 hr |
| | K3 | 0.55 | 1.0 | 0.50 | 20.0 | 1.0 | 0.50 | 0.23 | Dip hardening | 1050° C. × 2 hr |

Then, in accordance with the procedures shown below, grease of Examples 301 to 336 and Comparative Examples 301 to 311 having the compositions as shown in Tables 23 to 27 were prepared. At first, a base oil mixed with dimethylmethane diisocyanate and a base oil mixed with an amine (p-toluidine and/or cyclohexylamine) were mixed, stirred under heating to react dimethylmethane diisocyanate and the amine. In this case, it was conditioned such that the amounts of dimethylmethane diisocyanate and the amine were at a predetermined molar ratio and the total amount of both of them was a predetermined amount. A base oil prepared by dissolving various kinds of additives was added to the thus obtained semi-solid products and stirred sufficiently, which were then passed through a roll mill to obtain a grease.

TABLE 23

| | | | Example | Example | Example | Example | Example | Example |
|---|---|---|---|---|---|---|---|---|
| | | | 301 | 302 | 303 | 304 | 305 | 306 |
| Tested specimen | | | A3 | B3 | C3 | D3 | E3 | F3 |
| Thickener | Diisocyanate (mol) | | 1 | 1 | 1 | 1 | 1 | 1 |
| | Monoamine | p-toluidine | 1 | 1 | 1 | 1 | 1 | 1 |
| | (mol) | | | | | | | |
| | | cyclohexylamine | 1 | 1 | 1 | 1 | 1 | 1 |

| | | | | | | | |
|---|---|---|---|---|---|---|---|
| | W1 + W2 + W3 (mass %) | 18 | 18 | 18 | 18 | 18 | 18 |
| | (W1 + 0.5 × W2) | 0.5 | 0.5 | 0.5 | 0.5 | 0.5 | 0.5 |
| | (W1 + W2 + W3) | | | | | | |
| Base oil | PAO (mass %) | 80 | 80 | 80 | 80 | 80 | 80 |
| | Ether (mass %) | — | — | — | — | — | — |
| | Ester (mass %) | — | — | — | — | — | — |
| Additive | Zinc naphthenate (mass %) | 1.0 | 1.0 | 1.0 | 1.0 | 1.0 | 1.0 |
| | Succinate ester (mass %) | 1.0 | 1.0 | 1.0 | 1.0 | 1.0 | 1.0 |
| | ZnDTC (mass %) | — | — | — | — | — | — |
| | ZnDTP (mass %) | — | — | — | — | — | — |
| | NiDTC (mass %) | — | — | — | — | — | — |

| | | | | | | |
|---|---|---|---|---|---|---|
| Barium sulfonate (mass %) | — | — | — | — | — | — |
| Flaking life (hrs) | 1690 | 1880 | 2000 | 2000 | 2000 | 2000 |
| Seizure life (hrs) | 1000 | 1000 | 1000 | 1000 | 1000 | 1000 |
| Evaluation for rust-preventing effect | | | | | | |

| | | | | | Comp. | Comp. | Comp. |
|---|---|---|---|---|---|---|---|
| | | | Example | Example | Example | Example | Example |
| | | | 307 | 308 | 301 | 302 | 303 |
| Tested specimen | | | G3 | H3 | I3 | J3 | K3 |
| Thickener | Diisocyanate (mol) | | 1 | 1 | 1 | 1 | 1 |
| | Monoamine | p-toluidine | 1 | 1 | 1 | 1 | 1 |
| | (mol) | | | | | | |
| | | cyclohexylamine | 1 | 1 | 1 | 1 | 1 |

| | | | | | | |
|---|---|---|---|---|---|---|
| | W1 + W2 + W3 (mass %) | 18 | 18 | 18 | 18 | 18 |
| | (W1 + 0.5 × W2) | 0.5 | 0.5 | 0.5 | 0.5 | 0.5 |
| | (W1 + W2 + W3) | | | | | |
| Base oil | PAO (mass %) | 80 | 80 | 80 | 80 | 80 |
| | Ether (mass %) | — | — | — | — | — |
| | Ester (mass %) | — | — | — | — | — |
| Additive | Zinc naphthenate (mass %) | 1.0 | 1.0 | 1.0 | 1.0 | 1.0 |
| | Succinate ester (mass %) | 1.0 | 1.0 | 1.0 | 1.0 | 1.0 |
| | ZnDTC (mass %) | — | — | — | — | — |
| | ZnDTP (mass %) | — | — | — | — | — |
| | NiDTC (mass %) | — | — | — | — | — |

| | | | | | |
|---|---|---|---|---|---|
| Barium sulfonate (mass %) | — | — | — | — | — |
| Flaking life (hrs) | 2000 | 1880 | 1020 | 1200 | 1300 |
| Seizure life (hrs) | 1000 | 890 | 1000 | 1000 | 510 |
| Evaluation for rust-preventing effect | | | | | |

TABLE 24

| | | | Example | Example | Example | Example | Example | Example |
|---|---|---|---|---|---|---|---|---|
| | | | 309 | 310 | 311 | 312 | 313 | 314 |
| Tested specimen | | | E3 | E3 | E3 | E3 | E3 | E3 |
| Thickener | Diisocyanate (mol) | | 1 | 5 | 2 | 1 | 2 | 2 |
| | Monoamine | p-toluidine | 0 | 1 | 1 | 1 | 1 | 1 |
| | (mol) | | | | | | | |
| | | cyclohexyl- | 2 | 9 | 3 | 1 | 3 | 3 |
| | | amine | | | | | | |
| | W1 + W2 + W3 (mass %) | | 18 | 18 | 18 | 18 | 18 | 18 |
| | (W1 + 0.5 × W2) | | 0 | 0.1 | 0.25 | 0.5 | 0.25 | 0.25 |
| | (W1 + W2 + W3) | | | | | | | |
| Base oil | PAO (mass %) | | 80 | 80 | 80 | 80 | 79 | 79 |
| | Ether (mass %) | | — | — | — | — | — | — |
| | Ester (mass %) | | — | — | — | — | — | — |
| Additive | Zinc naphthenate | | 1.0 | 1.0 | 1.0 | 1.0 | 1.0 | 1.0 |
| | (mass %) | | | | | | | |
| | Succinate ester | | 1.0 | 1.0 | 1.0 | 1.0 | 1.0 | 1.0 |
| | (mass %) | | | | | | | |
| | ZnDTC (mass %) | | — | — | — | — | 1.0 | — |
| | ZnDTP (mass %) | | — | — | — | — | — | 1.0 |
| | NiDTC (mass %) | | — | — | — | — | — | — |
| Barium sulfonate (mass %) | | | — | — | — | — | — | — |
| Flaking life (hrs) | | | 2000 | 2000 | 2000 | 2000 | 2000 | 2000 |
| Seizure life (hrs) | | | 700 | 780 | 800 | 730 | 950 | 920 |
| Evaluation for rust-preventing effect | | | 2 | 2 | 2 | 2 | 2 | 1 |
| | | | Example | Example | Example | Example | Example | Example |
| | | | 315 | 316 | 317 | 318 | 319 | 320 |
| Tested specimen | | | E3 | E3 | E3 | E3 | E3 | E3 |
| Thickener | Diisocyanate (mol) | | 2 | 2 | 2 | 2 | 2 | 2 |
| | Monoamine | p-toluidine | 1 | 1 | 1 | 1 | 1 | 1 |
| | (mol) | | | | | | | |
| | | cyclohexyl- | 3 | 3 | 3 | 3 | 3 | 3 |
| | | amine | | | | | | |

| | | | | | | | |
|---|---|---|---|---|---|---|---|
| | W1 + W2 + W3 (mass %) | 18 | 18 | 18 | 18 | 18 | 18 |
| | (W1 + 0.5 × W2) | 0.25 | 0.25 | 0.25 | 0.25 | 0.25 | 0.25 |
| | (W1 + W2 + W3) | | | | | | |
| Base oil | PAO (mass %) | 70 | 72 | — | — | — | — |
| | Ether (mass %) | — | — | 80 | 79 | — | — |
| | Ester (mass %) | — | — | — | — | 80 | 79 |
| Additive | Zinc naphthenate | 1.0 | 5 | 1.0 | 1.0 | 1.0 | 1.0 |
| | (mass %) | | | | | | |
| | Succinate ester | 1.0 | 5 | 1.0 | 1.0 | 1.0 | 1.0 |
| | (mass %) | | | | | | |
| | ZnDTC (mass %) | — | — | — | 1.0 | — | 1.0 |
| | ZnDTP (mass %) | — | — | — | — | — | — |
| | NiDTC (mass %) | 1.0 | — | — | — | — | — |

| | | | | | | |
|---|---|---|---|---|---|---|
| Barium sulfonate (mass %) | — | — | — | — | — | — |
| Flaking life (hrs) | 2000 | 2000 | 2000 | 2000 | 2000 | 2000 |
| Seizure life (hrs) | 920 | 650 | 800 | 930 | 750 | 880 |
| Evaluation for rust-preventing effect | 2 | 2 | 2 | 2 | 2 | 2 |

TABLE 25

| | | | Example | Example | Example | Example | Example |
|---|---|---|---|---|---|---|---|
| | | | 321 | 322 | 323 | 324 | 325 |
| Tested specimen | | | E3 | E3 | E3 | E3 | E3 |
| Thickener | Diisocyanate (mol) | | 2 | 2 | 2 | 2 | 2 |
| | Monoamine | p-toluidine | 1 | 1 | 1 | 1 | 1 |
| | (mol) | | | | | | |
| | | cyclohexylamine | 3 | 3 | 3 | 3 | 3 |
| | W1 + W2 + W3 (mass %) | | 18 | 18 | 18 | 18 | 18 |
| | (W1 + 0.5 × W2) | | 0.25 | 0.25 | 0.25 | 0.25 | 0.25 |
| | (W1 + W2 + W3) | | | | | | |
| Base oil | PAO (mass %) | | 80.9 | 80.5 | 78 | 76 | 71 |
| | Ether (mass %) | | — | — | — | — | — |
| | Ester (mass %) | | — | — | — | — | — |
| Additive | Zinc naphthenate (mass %) | | 0.1 | 0.5 | 3 | 5 | 10 |
| | Succinate ester (mass %) | | 1.0 | 1.0 | 1.0 | 1.0 | 1 |
| | ZnDTC (mass %) | | — | — | — | — | — |
| | ZnDTP (mass %) | | — | — | — | — | — |
| | NiDTC (mass %) | | — | — | — | — | — |
| Barium sulfonate (mass %) | | | — | — | — | — | — |
| Flaking life (hrs) | | | 2000 | 2000 | 2000 | 2000 | 1890 |
| Seizure life (hrs) | | | 900 | 850 | 750 | 700 | 550 |
| Evaluation for rust-preventing effect | | | 2 | 2 | 2 | 2 | 2 |
| | | | Example | Example | Example | Example | Example |
| | | | 326 | 327 | 328 | 329 | 330 |
| Tested specimen | | | E3 | E3 | E3 | E3 | E3 |
| Thickener | Diisocyanate (mol) | | 2 | 2 | 2 | 2 | 2 |
| | Monoamine | p-toluidine | 1 | 1 | 1 | 1 | 1 |
| | (mol) | | | | | | |
| | | cyclohexylamine | 3 | 3 | 3 | 3 | 3 |

| | | | | | | |
|---|---|---|---|---|---|---|
| | W1 + W2 + W3 (mass %) | 18 | 18 | 18 | 18 | 18 |
| | (W1 + 0.5 × W2) | 0.25 | 0.25 | 0.25 | 0.25 | 0.25 |
| | (W1 + W2 + W3) | | | | | |
| Base oil | PAO (mass %) | 80.9 | 80.5 | 78 | 76 | 71 |
| | Ether (mass %) | — | — | — | — | — |
| | Ester (mass %) | — | — | — | — | — |
| Additive | Zinc naphthenate (mass %) | 1.0 | 1.0 | 1.0 | 1.0 | 1.0 |
| | Succinate ester (mass %) | 0.1 | 0.5 | 3 | 5 | 10 |
| | ZnDTC (mass %) | — | — | — | — | — |
| | ZnDTP (mass %) | — | — | — | — | — |
| | NiDTC (mass %) | — | — | — | — | — |

| | | | | | |
|---|---|---|---|---|---|
| Barium sulfonate (mass %) | — | — | — | — | — |
| Flaking life (hrs) | 2000 | 2000 | 2000 | 2000 | 1850 |
| Seizure life (hrs) | 930 | 900 | 800 | 730 | 580 |
| Evaluation for rust-preventing effect | 1 | 2 | 2 | 2 | 1 |

TABLE 26

| | | | Example | Example | Example | Example | Example | Example |
|---|---|---|---|---|---|---|---|---|
| | | | 331 | 332 | 333 | 334 | 335 | 336 |
| Tested specimen | | | E3 | E3 | E3 | E3 | E3 | E3 |
| Thickener | Diisocyanate (mol) | | 2 | 2 | 2 | 2 | 2 | 2 |
| | Monoamine | p-toluidine | 1 | 1 | 1 | 1 | 1 | 1 |
| | (mol) | cyclohexylamine | 3 | 3 | 3 | 3 | 3 | 3 |

| | | | | | | | |
|---|---|---|---|---|---|---|---|
| | W1 + W2 + W3 (mass %) | 18 | 18 | 18 | 18 | 18 | 18 |
| | (W1 + 0.5 × W2) | 0.25 | 0.25 | 0.25 | 0.25 | 0.25 | 0.25 |
| | (W1 + W2 + W3) | | | | | | |
| Base oil | PAO (mass %) | 79.9 | 79.5 | 77 | 75 | 70 | 68 |
| | Ether (mass %) | — | — | — | — | — | — |
| | Ester (mass %) | — | — | — | — | — | — |
| Additive | Zinc naphthenate (mass %) | 1.0 | 1.0 | 1.0 | 1.0 | 1.0 | 1.0 |
| | Succinate ester (mass %) | 1.0 | 1.0 | 1.0 | 1.0 | 1.0 | 1.0 |
| | ZnDTC (mass %) | 0.1 | 0.5 | 3 | 5 | 10 | 12 |
| | ZnDTP (mass %) | — | — | — | — | — | — |
| | NiDTC (mass %) | — | — | — | — | — | — |

| | | | | | | |
|---|---|---|---|---|---|---|
| Barium sulfonate (mass %) | — | — | — | — | — | — |
| Flaking life (hrs) | 2000 | 2000 | 2000 | 2000 | 2000 | 2000 |
| Seizure life (hrs) | 850 | 900 | 980 | 890 | 830 | 750 |
| Evaluation for rust-preventing effect | 2 | 2 | 2 | 2 | 2 | 2 |

TABLE 27

| | | | Comp. | Comp. | Comp. | Comp. | Comp. | Comp. | Comp. | Comp. |
|---|---|---|---|---|---|---|---|---|---|---|
| | | | Example | Example | Example | Example | Example | Example | Example | Example |
| | | | 304 | 305 | 306 | 307 | 308 | 300 | 310 | 311 |
| Tested specimen | | | E3 | E3 | E3 | E3 | E3 | E3 | E3 | E3 |
| Thickener | Diisocyanate (mol) | | 2 | 1 | 2 | 2 | 2 | 2 | 2 | 2 |
| | Monoamine | p-toluidine | 3 | 2 | 1 | 1 | 1 | 1 | 1 | 1 |
| | (mol) | | | | | | | | | |
| | | cyclohexylamine | 1 | 0 | 3 | 3 | 3 | 3 | 3 | 3 |

| | | | | | | | | | |
|---|---|---|---|---|---|---|---|---|---|
| | W1 + W2 + W3 (mass %) | 18 | 20 | 18 | 18 | 18 | 18 | 18 | 18 |
| | (W1 + 0.5 × W2) | 0.75 | 1 | 0.25 | 0.25 | 0.25 | 0.25 | 0.25 | 0.25 |
| | (W1 + W2 + W3) | | | | | | | | |
| Base oil | PAO (mass %) | 80 | 78 | 79.95 | 79.95 | 69 | 69 | 80 | 79 |
| | Ether (mass %) | — | — | — | — | — | — | — | — |
| | Ester (mass %) | — | — | — | — | — | — | — | — |
| Additive | Zinc naphthenate (mass %) | 1.0 | 1.0 | 0.05 | 1.0 | 12.0 | 1.0 | — | — |
| | Succinate ester (mass %) | 1.0 | 1.0 | 1.0 | 0.05 | 1.0 | 12.0 | — | — |
| | ZnDTC (mass %) | — | — | — | — | — | — | — | 1 |
| | ZnDTP (mass %) | — | — | — | — | — | — | — | — |
| | NiDTC (mass %) | — | — | — | — | — | — | — | — |

| | | | | | | | | |
|---|---|---|---|---|---|---|---|---|
| Barium sulfonate (mass %) | — | — | — | — | — | — | 2 | 2 |
| Flaking life (hrs) | 2000 | 2000 | 2000 | 2000 | 1030 | 1110 | 450 | 440 |
| Seizure life (hrs) | 380 | 300 | 800 | 780 | 350 | 300 | 400 | 430 |
| Evaluation for rust-preventing effect | 2 | 2 | 3 | 3 | 1 | 1 | 2 | 2 |

As the base oil, one of poly-α-olefin hydrogenation product (kinetic viscosity at 40° C. of 47 mm²/s), dialkyldipheyl ether (kinetic viscosity at 40° C. of 100 mm²/s), or pentaerythritol tetraester (kinetic viscosity at 40° C. of 33 mm²/s) was used. In Tables 23 to 27, the poly-α-olefin hydrogenation products is indicated as “PAO”, dialkyl diphenyl ether is indicated as “ether”, and pentaerythritol tetraester is indicated as “ester”, respectively.

Further, as the additive, zinc naphthenate (zinc content: 10 mass %), alkenyl succinic acid half ester (total acid value: 155 mg KOH/g), zinc dialkyl dithiocarbamate, zinc dialkyl dithiophosphate, nickel dialkyl dithiophosphate, barium sulfonate (total acid value: 30 mg KOH/g) were used. In Tables 23 to 27, alkenyl succinic acid half ester is indicated as “succinate”, the zinc dialkyl dithiocarbamate is indicated as “ZnDTC”, the zinc dialkyl dithiophosphate is indicated as “ZnDTP”, and the nickel dialkyl dithiophosphate is indicated as “NiDTC”, respectively.

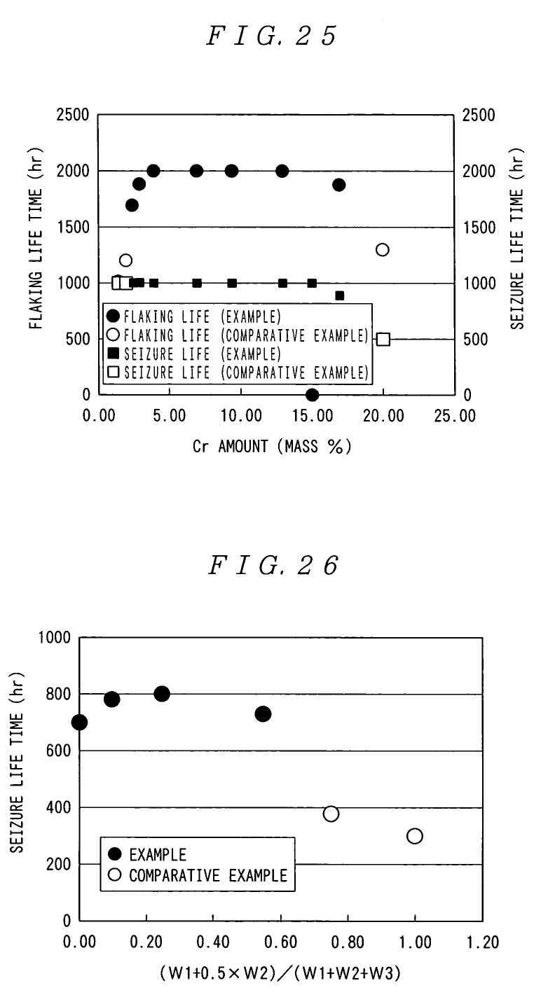

The greases as shown in Tables 23 to 27 were filled in the inside of the bearings described above, and the flaking reproduction test, the seizure test and the rust-preventing test described above were conducted. The results are shown in Tables 23 to 27 and also shown in the graphs of FIGS. 25 to 29.

FIG. 25 is a graph showing a relation between the amount of Cr in the steel constituting the bearing, and the flaking life and the seizure life of bearings. As can be seen from the graphs, the amount of Cr is, preferably, from 2.5 to 17.0 mass %. In a case where it is less than 2.5 mass %, flaking accompanied by structural change tends to occur. On the other hand, in a case where it exceeds 17.0 mass %, while flaking accompanied by structural change less occurs, coarse carbides are formed to lower the general life. Further, in a case where the amount of Cr exceeds 17.0 mass %, since the heat conductivity of the steel is lowered, the temperature of the bearing rises tending to cause seizure. For improving the flaking life, the seizure life and the general life further, the amount of Cr is, more preferably, from 3.0 to 15.0 mass % and, further preferably, from 4.0 to 13.0 mass %.

FIG. 26 is a graph showing a relation between the value of the formula (5) described above, that is, the value (W₁+0.5×W₂)/(W₁+W₂+W₃) and the seizure life. As can be seen from the graph, in a case where the value exceeds 0.55, since the lubricating performance of the grease becomes insufficient, seizure tends to occur at a high temperature.

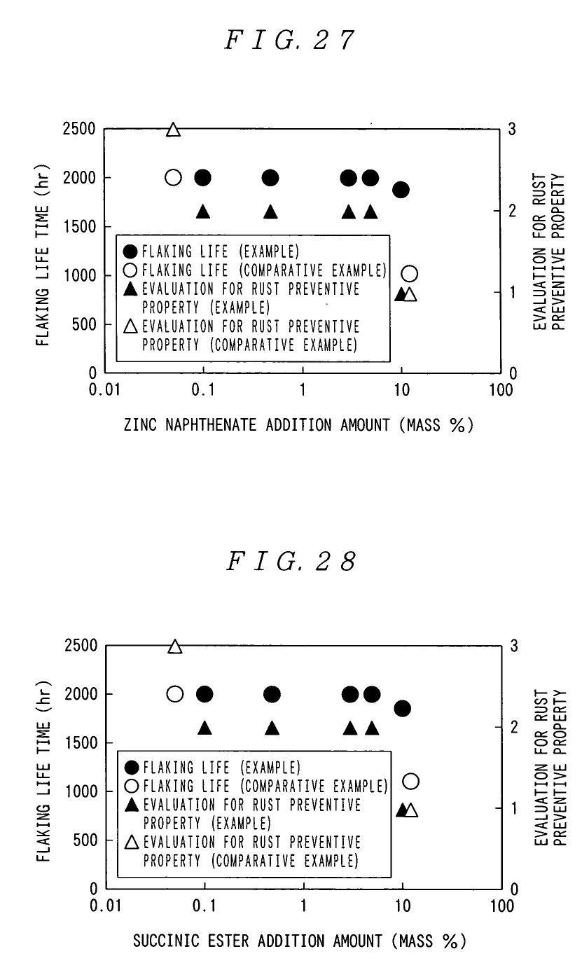

FIG. 27 is a graph showing a relation between the addition amount of zinc naphthenate and the evaluation for the flaking life and the rust-preventing property. Further, FIG. 28 is a graph showing a relation between the succinic ester and the evaluation for the flaking life and the rust-preventing property. As can be seen from both of the drawing, in a case where the addition amount for each of zinc naphthenate and succinic ester is less than 0.1 mass % based on the entire grease, the rust-preventing property is insufficient. On other hand, in a case where it exceeds 10 mass %, since the grease is softened and the grease tends to be leaked from the inside of the bearing, so that the flaking life is shortened.

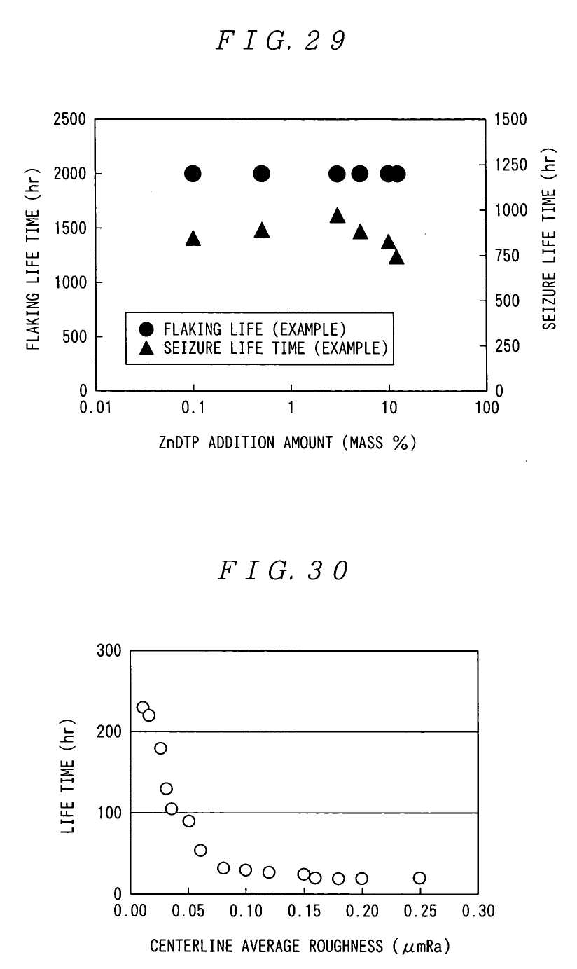

FIG. 29 is a graph showing a relation between the addition amount of ZnDTP and the flaking life and the seizure life.

(4) Then, another embodiment of a rolling bearing used for engine auxiliary equipment or a gas heat pump and lubricated with grease (eighth embodiment) is to be described.

The present inventors have made an earnest study taking notice on the parameter for the surface roughness of the raceway surface of a fixed ring and a rotational ring and, as a result, have obtained the following findings. In this study, a life test by the cantilever type life testing apparatus and a life test by the actual alternator described above were conducted as the life test for the bearings.

In the life test by the cantilever type life testing apparatus, JIS bearing designation 6206 (30 mm inner diameter, 62 mm outer diameter, and 16 mm width) was used as the tested bearing and the life test was conducted under the conditions at a rotational speed of 3900 min⁻¹, with a bearing clearance of 10 to 15 μm, under the loading condition as at: applied load/dynamic load rating (P/C)=0.72 and at a constant test temperature of 80° C. Further, VG68 oil was used for the lubricant.

The life test by the actual alternator test used a JIS bearing designation 6206 identical with that described above as the tested bearing and adopted a condition, for example, of switching the rotational speed between 9000 min⁻¹ and 18000 min⁻¹ on every predetermined time of about 9 sec. Further, the loading condition was as at: P (applied load)/C (dynamic load rating)=0.10, the test temperature was constant at 80° C. and E grease was used for the grease.

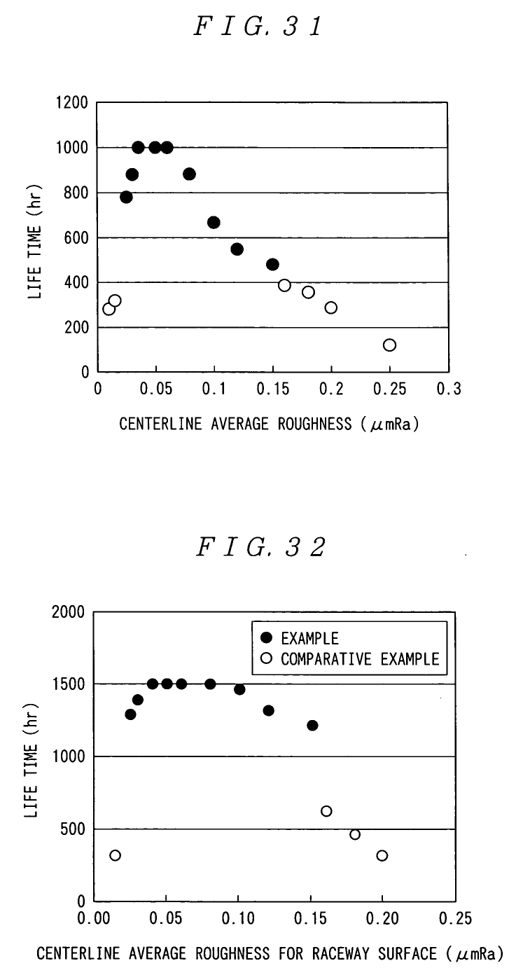

The result of both of tests are shown in Table 28, and graphic indication for each of the results is shown in FIG. 30 and FIG. 31. Both of the life tests were conducted for each type of bearings each by the number of 10 to determine the L₁₀ life.

TABLE 28

| | |
|---|---|
| Surface | L₁₀ life (hr) |

| | Roughness | Cantilever type | Actual alternator |
|---|---|---|---|
| | (μmRa) | life tester | test |
| Example | 0.025 | 180 | 780 |
| | 0.03 | 130 | 880 |
| | 0.035 | 105 | 1000 |
| | 0.05 | 90 | 1000 |
| | 0.06 | 54 | 1000 |
| | 0.08 | 32 | 880 |
| | 0.1 | 30 | 670 |
| | 0.12 | 27 | 550 |
| | 0.15 | 25 | 480 |
| Comp. | 0.01 | 230 | 280 |
| Example | 0.015 | 220 | 320 |
| | 0.16 | 21 | 390 |
| | 0.18 | 20 | 360 |
| | 0.2 | 20 | 290 |
| | 0.25 | 20 | 120 |

Usually, the relation between the life of the rolling bearing and the center line average roughness for the raceway surface is as shown in FIG. 30, in which the life is longer in a case where the center line average roughness is smooth, while the life is shortened as the center line average roughness becomes coarser.

However, in a circumstance where vibrations are generated as in an alternator or in circumstance where shearing stress exerts on the grease, the life is shortened in a case where the center line average roughness for the raceway surface is smooth as shown in FIG. 31 (in a case of less than 0.025 μmRa in FIG. 31). This is attributable to that oil films are not formed sufficiently during rotation of the rolling bearing in a case where the raceway surface is smooth. Accordingly, in the circumstance where vibrations, etc. are generated, rotation slip of the rolling element occurs thereby loading shearing stress on the grease. Then, since hydrogen atoms are evolved, early flaking accompanied by structural change occurs. Further, in a case where the raceway surface is properly rough (in a case of exceeding 0.075 μmRa in FIG. 31), the life is also shortened. This is attributable to excess metal contact formed between the rolling element and the inner and outer rings because of insufficient formation of the oil films on the raceway surface to cause surface originated early flaking. Further, in a case where the raceway surface is properly rough (in a case from 0.025 to 0.075 μmRa in FIG. 31), since moderate metal contact is formed to suppress rotation slip of the rolling element, the life is longer.

By the way, in a case where the center line average for the raceway surface is 0.1 μmRa, L₁₀ life was 670 hrs and, while rolling bearings having long life of 1000 hrs, 1000 hrs, 1000 hrs, 920 hrs and 880 hrs were present, a rolling bearing having a shorter life as 330 hrs was also present. In view of the fact described above, the present inventors considered the presence of an important factor for the life in addition to the center line average roughness for the raceway surface and conducted investigation. As a result, it was found that the average distance Sm for the concave/convex of the raceway surface (JIS B 0601-1994) was an important parameter.

That is, in a case where the center line average roughness for the raceway surface is 0.1 μmRa, when the average distance Sm for concave/convex is smaller than 3 μm, excess metal contact is formed between the rolling element and the inner and outer rings to cause mechanochemical reaction, thereby shortening the life. On the other hand, when the average distance for the concave/convex exceeds 50 μm, since no proper metal contact is formed between the rolling element and the inner and outer rings, rotation slip of the rolling element occurs to cause early flaking accompanied by structural change.

Now, description is to be made to a rolling bearing in which the average distance Sm for concave/convex of the raceway surface was controlled to a predetermined value. In this embodiment, a flaking reproduction test and a seizure test were conducted as the life test for the rolling bearings. As the flaking reproduction tester, a rapid acceleration/deceleration tester described in Japanese Unexamined Patent Publication No. Hei 9-89724 was used, for example. Then, the test was conducted under the condition, for example, of switching the rotational speed between 9000 min⁻¹ and 18000 min⁻¹ on every predetermined time of about 9 sec.

Further, for both of examples and comparative examples of the present invention, JIS bearing designation 6303 (17 mm inner diameter, 47 mm outer diameter, and 14 mm width) was used as the tested bearing, the bearing clearance was 10 to 15 μm, the loading condition was as at: P (applied load)/C (dynamic load rating)=0.10, and the test temperature was set constant at 80° C. Since the calculated life of the bearing is 1350 hrs, the test termination time was defined as 1500 hrs. When the vibration value increased up to five times the initial vibrations, the test was interrupted and the absence or presence of flaking was confirmed. Test was conducted for each type of bearings each by the number of 10.

Further, the rapid acceleration/deceleration tester was used also for the seizure test. However, the test was conducted continuously at a constant rotational speed of 20000 min⁻¹, at a bearing temperature of 140° C. and under a radial load of 98 N. The type of the tested bearing and the conditions were identical with those for the flaking reproduction test. Then, when seizure occurred and the temperature of the bearing outer ring increased to 150° C. or higher, the test was terminated. Further, in a case where the temperature of the bearing outer ring did not increase to 150° C. or higher even after the test for 1000 hrs, the test was terminated. The test was conducted for each type of bearings each by the number of 10.

In each of the tests described above, SUJ2 (bearing steel, 2nd class) was used as the material for the inner and outer rings, and the rolling element of the bearings, which were applied with usual heat treatment (hardening by heating at 830 to 1050° C., oil cooling and then tempering at 160 to 240° C.) and used. Further, it was controlled such that the surface hardness HRC was from 57 to 63 and the amount of retained austenite was from 0 to 20% for the inner and outer rings and the rolling element. Further, it was controlled such that the center line average roughness was 0.020 μmRa for the inner ring raceway surface and the center line average roughness was from 0.003 to 0.010 μmRa for the surface of the rolling element. Then, the flaking reproduction test and the seizure test described above were conducted for various bearings which were different in the center line average roughness and the average distance Sm for the concave/convex on the raceway surface of the outer ring. The results are shown in Table 29. Further, a relation between the center line average roughness for the outer ring raceway surface and the flaking life of the bearing is shown by a graph in FIG. 32.

TABLE 29

| | | Surface | Average distance | |
|---|---|---|---|---|
| | | roughness | for concave/convex | L₁₀ life |
| | Test piece | (μmRa) | (μm) | (hr) |
| Example | 401 | 0.025 | 20 | 1290 |
| | 402 | 0.03 | 10 | 1390 |
| | 403 | 0.04 | 5 | 1500 |
| | 404 | 0.04 | 30 | 1500 |
| | 405 | 0.05 | 10 | 1500 |
| | 406 | 0.06 | 20 | 1500 |
| | 407 | 0.08 | 15 | 1500 |
| | 408 | 0.1 | 3 | 1460 |
| | 409 | 0.12 | 50 | 1320 |
| | 410 | 0.15 | 5 | 1220 |
| Comp. | 401 | 0.015 | 12 | 320 |
| Example | 402 | 0.16 | 20 | 630 |
| | 403 | 0.18 | 10 | 460 |
| | 404 | 0.2 | 10 | 320 |
| | 405 | 0.03 | 1 | 820 |
| | 406 | 0.05 | 70 | 930 |
| | 407 | 0.1 | 2 | 560 |
| | 408 | 0.12 | 70 | 440 |
| | 409 | 0.18 | 2 | 120 |

In the bearings of Examples 403 to 407, occurrence of flanking was not observed even when reaching 1500 hr. It is considered that since the center line average roughness for the raceway surface of the fixed ring is rough as from 0.04 to 0.08 μmRa (usually 0.02 μmRa or less) and the average distance Sm for the concave/convex on the raceway surface is from 5 to 20 μm, rotation slip of the rolling element is suppressed, to improve the life although this is a region where the oil film parameter Λ is decreased.

While the bearing of Examples 401 and 402 had longer life, it is considered that the life was shortened since the raceway surface was smooth compared with Examples 403 to 407 thereby tending to cause rotation slip of the rolling element.

Further, while the bearing of Examples 408 to 410 also had longer life, since the oil film parameter Λ was smaller compared with Examples 403 to 407, metal contact tended to be caused. Accordingly, early flaking accompanied by structural change occurred in one or two out of 10 to cause surface originated flaking to the outer ring (fixed ring). Since grinding traces could scarcely be confirmed even when the raceway surface of the flaked outer ring was observed, it is considered that metal contact occurred at a considerably high frequency leading to surface originated flaking.

On the contrary, the bearing of Comparative Example 401 had a surface roughness at a level identical with the raceway surface of a usual ball bearing, or it was at a level of the surface roughness applied with super-finishing to the raceway surface of a usual ball bearing. Accordingly, the oil film parameter Λ increased to suppress the metal contact. However, in a circumstance in which high temperature and large vibration exert as in the bearing for use in the engine auxiliary equipments, sliding or metal contact tended to be caused. Accordingly, when only the surface roughness for the raceway surface was improved, the life was rather shortened and the L₁₀ life was about ¼ of the calculated life.

Further, in Comparative Examples 402 to 404 with the surface roughness being more than Examples 401 to 410, since the oil parameter A was small, metal contact was formed between the rolling element and the inner and outer rings. Accordingly, surface originated flaking was caused to shorten the life.

Further, in the bearing of Comparative Examples 405 and 407, while the center line average roughness for the raceway surfaces was appropriate, the average distance Sm for the concave/convex on the raceway surface was as small as 1 μm and 2 μm, respectively. Accordingly, an excess metal contact was formed between the rolling element and the inner and outer rings to cause mechanochemical reaction to shorten the life. In the bearing of Comparative Examples 406 and 408, while the center line average roughness for the raceway surface was appropriate, the average distance Sm for the concave/convex of the raceway surface was as large as 90 μm and 70μm, respectively. Accordingly, no appropriate metal contact was formed between the rolling element and the inner and outer rings, which caused rotation slip of the rolling element to generate early flaking accompanied by structural change.

Further, in the bearing of Comparative Example 409, since the center line average roughness for the raceway surface was rough and the average distance Sm for the concave/convex on the raceway surface was small, life was short.

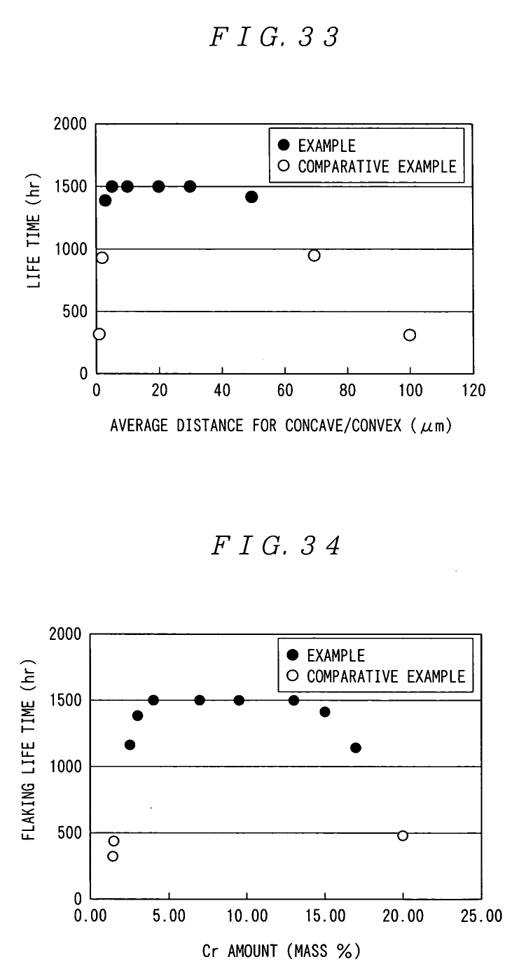

Then, bearings with the center line average roughness for the raceway surface being constant (0.05 μmRa) only for the outer ring (fixed ring) and with different average distance Sm for the concave/convex of the raceway surface were provided and the flaking reproduction test was conducted in the same manner as described above. Table 30 the result. Further, a relation between the average distance Sm for the concave/convex of the outer ring raceway surface and the flaking life of the bearing is shown in the graph of FIG. 33.

TABLE 30

| | | Surface | Average distance | |
|---|---|---|---|---|
| | | roughness | for concave/convex | L₁₀ life |
| | Test piece | (μmRa) | (μm) | (hr) |
| Example | 411 | 0.05 | 3 | 1390 |
| | 412 | 0.05 | 5 | 1500 |
| | 413 | 0.05 | 10 | 1500 |
| | 414 | 0.05 | 20 | 1500 |
| | 415 | 0.05 | 30 | 1500 |
| | 416 | 0.05 | 50 | 1420 |
| Comp. | 411 | 0.05 | 1 | 320 |
| Example | 412 | 0.05 | 2 | 930 |
| | 413 | 0.05 | 70 | 940 |
| | 414 | 0.05 | 100 | 320 |

In the bearings for Examples 412 to 415, since the average distance Sm for the concave/convex on the raceway surface was 5 to 30 μm, occurrence of flaking was not observed even when reaching 1500 hrs. Further, while the bearing of Example 411 had a long life, since the average distance Sm for the concave/convex of the raceway surface was somewhat smaller as 3 μm, metal contact tended to be formed between the rolling element and the outer ring to somewhat shorten the life. Further, while the bearing of Example 416 also had long life, since the average distance Sm for the concave/convex on the raceway surface was somewhat larger as 50 μm, sliding of the rolling element occurred to somewhat shorten the life.

In the contrary, in the bearings of Comparative Examples 411 and 412, since the average distance Sm for the concave/convex on the raceway surface was excessively small, metal contact was formed between the rolling element and the outer ring to shorten the life. Further, in the bearings of Comparative Examples 413 and 414, since the average distance Sm for the concave/convex on the raceway surface was excessively large, early flaking accompanied by structural change occurred due to the sliding of the rolling element to shorten the life.

(5) Then, an embodiment of a rolling bearing used for the solenoid clutch of a gas heat pump air conditioner (GHPA) and lubricated with grease is to be described (ninth embodiment).

In this embodiment, a flaking test for bearings was conducted by incorporating two bearings in the solenoid clutch portion of an actual GHPA, and rotating them at a rotational speed of 500 to 7500 min⁻¹. The tested bearings used were deep groove ball bearings each of 40 mm inner diameter, 80 mm outer diameter and 18 mm width both for the examples and the comparative examples. Then, the bearing clearance was from 10 to 15 μm, the loading condition was as at: P (applied load)/C (dynamic load rating)=0.15 and the test temperature was set constant at 80° C. Further, E grease was used as the lubricant.

Since the calculated life of the bearing is 1150 hrs, the test termination time was determined as 1500 hrs. Then, when the vibration value increased up to five times the initial vibrations, the test was interrupted and absence or presence of flaking was confirmed. The test was conducted for each kind of bearings each by the number of 10 to determine the L₁₀ life. In a case where flaking did not occur to all ten bearings up to the test termination time, the L₁₀ life was determined as 1500 hrs.

In the flaking test, tested materials of Examples A4 to H4 and Comparative Examples I4 to N4 shown in Table 31 were used for the materials of the inner and outer rings of the bearing and applied with usual heat treatment (hardening by heating to 830 to 1050° C., oil cooling and then tempering 160 to 240° C.) and used. As apparent from Table 31, in the tested materials for each of Examples A4 to H4, all alloying ingredient contents were within the recommended range of the invention. Numerical values applied with underlines in Table 31 are those for out of the recommended range of the present invention in view of the alloying ingredient content.

TABLE 31

| | Tested | Steel composition (mass %) | | | | | | α |
|---|---|---|---|---|---|---|---|---|
| | material | C | Si | Mn | Cr | Mo | V | value |
| Example | A4 | 0.9 | 0.60 | 0.50 | 2.50 | 0.24 | 0.20 | 1.24 |
| | B4 | 1.20 | 1.50 | 0.40 | 3.0 | | | 1.26 |
| | C4 | 0.80 | 0.70 | 1.0 | 4.0 | 2.00 | | 0.97 |
| | D4 | 0.55 | 0.80 | 0.50 | 7.0 | 0.40 | | 1.01 |
| | E4 | 0.75 | 0.60 | 0.20 | 9.5 | | 0.20 | 0.91 |
| | F4 | 0.70 | 1.20 | 0.50 | 13.0 | 0.50 | | 0.70 |
| | G4 | 0.50 | 0.75 | 0.80 | 15.0 | 0.10 | 1.00 | 0.53 |
| | H4 | 0.55 | 1.0 | 0.40 | 17.0 | 0.10 | | 0.55 |
| Comp. | I4 | 0.95 | 0.25 | 0.38 | 1.45 | | | 1.34 |
| Example | J4 | 0.95 | 0.80 | 0.38 | 1.50 | | | 1.34 |
| | K4 | 0.80 | 0.50 | 0.40 | 5.0 | 0.50 | | 1.10 |
| | L4 | 0.55 | 1.0 | 0.50 | 20.0 | 1.0 | 0.50 | 0.23 |
| | M4 | 0.85 | 1.0 | 0.30 | 4.10 | 4.30 | 0.70 | 0.61 |
| | N4 | 1.30 | 0.80 | 0.80 | 4.00 | 0.50 | 0.20 | 1.31 |

The rolling element was constituted with SUJ2 (bearing steel, 2nd class). Further, it was controlled such that the surface hardness HRC was from 58 to 64 and the amount of retained austenite was from 0 to 20% for the inner and outer ring and the rolling element. Then, it was controlled such that the center line average roughness for the raceway surface was from 0.015 to 0.020 μmRa for the inner and outer rings and from 0.003 to 0.010 μmRa for the rolling element.

Table 32 shows the result of the flaking test.

TABLE 32

| | | | | | Flaking test | | |
|---|---|---|---|---|---|---|---|
| | Test | Tested | | | L₁₀ life | | |
| | piece | material | Heat treatment | | (hr) | Flaking | |
| Example | 501 | A4 | dip hardening | 830° C. × 2 hr | 1160 | 2/10 | flaked |
| | 502 | B4 | dip hardening | 830° C. × 2 hr | 1380 | 1/10 | flaked |
| | 503 | C4 | dip hardening | 850° C. × 2 hr | 1500 | No flaking | |
| | 504 | D4 | Carburization | 930° C. × 2 hr | 1500 | No flaking | |
| | 505 | E4 | dip hardening | 960° C. × 2 hr | 1500 | No flaking | |
| | 506 | F4 | dip hardening | 1000° C. × 2 hr | 1500 | No flaking | |
| | 507 | G4 | Carburization | 1000° C. × 2 hr | 1410 | 1/10 | flaked |
| | 508 | H4 | dip hardening | 1050° C. × 2 hr | 1140 | 2/10 | flaked |
| Comp. | 501 | I4 | dip hardening | 830° C. × 2 hr | 320 | 10/10 | flaked |
| Example | 502 | J4 | dip hardening | 830° C. × 2 hr | 440 | 7/10 | flaked |
| | 503 | K4 | dip hardening | 1050° C. × 2 hr | 520 | 8/10 | flaked |
| | 504 | L4 | dip hardening | 1050° C. × 2 hr | 480 | 7/10 | flaked |
| | 505 | M4 | dip hardening | 960° C. × 2 hr | 510 | 10/10 | flaked |
| | 506 | N4 | dip hardening | 1000° C. × 2 hr | 470 | 10/10 | flaked |

As can be seen from Table 32, in the bearings of Examples 503 to 506, occurrence of flaking was not observed even reaching 1500 hrs. While the bearings of Examples 501 and 502 had long life, since the amount of Cr was smaller compared with Examples 503 to 506, flaking accompanied by structural change occurred in one or two out of 10 bearings. Further, while the bearings of Examples 507 and 508 also had long life, since the amount of Cr was larger compared with Examples 503 to 506, eutectic carbides were tended to be formed. As a result, flaking originated from eutectic carbides occurred in one or two out of 10 bearings. However, flaking accompanied by structural change did not occur.

On the contrary, while the bearing of Comparative Example 501 was constituted with SUJ2 (bearing steel, 2nd class), since the amount of Cr and the amount of Si were smaller, flaking accompanied by structural change occurred to shorten the life. Further, in the bearing of Comparative Example 502, while the amount of Si was satisfactory, since the amount of Cr was smaller, flaking accompanied by structural change occurred to shorten the life. Further, in the bearing of Comparative Example 503, while the amount of Cr was suitable, since the amount of Si was smaller, flaking accompanied by structural change occurred to shorten the life.

Further, in the bearing of Comparative Example 504, since the amount of Cr was large, eutectic carbides were formed. As a result, flaking originated from the eutectic carbides occurred to shorten the life. Further, in the bearings of Comparative Examples 505 and 506, the amount of C was larger than the α value described above. Accordingly, the fixation of C was deteriorated and coarse carbide were formed to shorten the life.

Now, FIG. 34 shows a relation between the amount of Cr and the flaking life in the test described above for Examples 501 to 508 and Comparative Examples 501 to 504.

As apparent from the figure, the optimal ingredient range for the amount of Cr is 2.5 to 17.0 mass %. In a case where the amount of Cr is smaller, the stability of the structure is insufficient to cause flaking accompanied by structural change to shorten the life. Further, in a case where the amount of Cr is larger, since eutectic carbides are formed, the life is shortened. For further stabilizing structure and making the life longer, the amount of Cr is, more preferably, from 4.0 to 13.0 mass %. It is necessary that the value a is more than the amount of C in order to suppress the lowering of fixation of C and formation of eutectic carbides.

### (III) Embodiment of the Invention for Solving the Third Subject

Since the structure of the rolling bearing of this embodiment (tenth embodiment) is identical with that of the bearing of the sixth embodiment described above, description is to be made with reference to FIG. 21.

The rolling bearing 51 is a deep groove ball bearing of JIS bearing designation 6303 in which an outer ring 52 is fixed as a fixed ring to a housing 58, and an inner ring 53 is fitted as a rotational ring to the outside of a shaft 57. Further, a number of rolling elements 54 held by a cage 55 are arranged between the raceway surface 52a of the outer ring 52 and a raceway surface 53a of the inner ring 53, and seal members 56 and 56 are mounted between the outer ring 52 and the inner ring 53 at positions on both sides of the cage 55.

Further, a grease 59 is sealed in a space surrounded by the seal members 56 and 56. Then, in the rolling bearing 51, the inner ring 53 rotates along with rotation of the shaft 57 and vibration and load caused by the rotation exert from the shaft 57 by way of the inner ring 53 and the rolling element 54 on the loading zone of the outer ring 52.

The inner and outer rings 52 and 53 are constituted with steel materials of the compositions shown in Table 33. That is, the inner and outer ring 52 and 53 are manufactured by hardening the steel material formed each into a predetermined size at 840 to 960° C., applying tempering at 160° C. and then applying finishing fabrication by grinding. However, since hardening was difficult to attain for the Comparative Examples 602 and 603 at the hardening temperature described above, hardening was conducted at 960 to 1000° C. by using a vacuum furnace. The surface roughness of the inner ring and outer ring 52 and 53 was about from 0.01 to 0.04 μm. Further, the rolling element 54 is a steel ball made of SUJ2 corresponding to ball grade 20.

Further, Table 33 shows the hardness (HRC) for the raceway surfaces 52a and 53a of the inner and outer rings 52 and 53, and the value on the light side of the formula calculated from the content for each of the alloying ingredients (α value) together:
C %≦−0.05×Cr %−0.12×(Mo %+V %+W %)+1.41

TABLE 33

| | | | | | | | | | | | Value for | |
|---|---|---|---|---|---|---|---|---|---|---|---|---|
| | Test piece | C | Si | Mn | Cr | Mo | V | W | N | Total for C + N | formula | Hardness |
| Example | 601 | 0.87 | 0.51 | 0.31 | 3.01 | — | — | — | 0.03 | 0.90 | 1.26 | 62.4 |
| | 602 | 0.75 | 1.00 | 0.33 | 3.50 | 1.00 | — | — | 0.05 | 0.80 | 1.12 | 62.6 |
| | 603 | 0.49 | 0.61 | 0.46 | 4.08 | 2.99 | 0.51 | — | 0.13 | 0.62 | 0.79 | 61.8 |
| | 604 | 0.54 | 0.52 | 0.36 | 6.50 | 1.99 | — | 0.97 | 0.15 | 0.69 | 0.73 | 61.1 |
| | 605 | 0.61 | 0.76 | 0.52 | 4.97 | — | — | 1.99 | 0.12 | 0.73 | 0.92 | 62.3 |
| | 606 | 0.59 | 1.01 | 0.33 | 5.02 | — | 1.97 | — | 0.12 | 0.71 | 0.92 | 62.1 |
| | 607 | 0.40 | 0.52 | 0.33 | 6.99 | — | — | — | 0.10 | 0.50 | 1.06 | 59.7 |
| Comp. | 601 | 1.02 | 0.28 | 0.34 | 1.51 | — | — | — | — | 1.02 | 1.33 | 62.2 |
| Example | 602 | 0.80 | 0.33 | 0.34 | 6.85 | — | — | — | — | 0.80 | 1.07 | 61.9 |
| | 603 | 0.96 | 0.33 | 0.34 | 8.02 | 0.50 | — | — | 0.06 | 1.02 | 0.95 | 62.5 |
| | 604 | 0.85 | 0.23 | 0.38 | 2.53 | — | — | — | — | 0.85 | 1.28 | 62.4 |
| | 605 | 0.44 | 0.26 | 0.38 | 5.34 | — | — | — | — | 0.44 | 1.14 | 56.3 |

1) Numerical values in the columns other than that for value for the formula and hardness are on the basis of mass % unit.
2) The formula is: −0.05 × Cr % − 0.12 × (Mo % + V % + W %) + 1.41.
3) The hardness is HRC

Then, the result of evaluating the life under grease lubrication is to be described for the deep groove ball bearings. The grease lubrication life test was conducted by using a tester as shown in FIG. 23. Then, assuming the use in an engine auxiliary equipment, a rapid acceleration/declaration test of switching the number of rotation between (9000 min⁻¹ and 18000 min⁻¹) on every predetermined time (for example, on every 9 sec) was conducted.

The load condition was as at: P (dynamic equivalent load)/C (basic dynamic load rating)=0.10 and a urea type grease mixed with water at a ratio of 2 mass % was used for the lubricant. Then, life test was conducted for each kind of bearings each by the number of 10 and the time till flaking occurred was measured to determine the L₁₀ life. Since the calculated life for the deep groove ball bearing under the condition is 1350 hrs, the test termination time was defined as 1500 hrs. Then, in a case where flaking did not occur till the test termination time in all ten bearings, the L₁₀ life was defined as 1500 hrs.

Table 34 shows the L₁₀ life, the number of bearings causing flaking in the bearings by the number of 10 and the type of the bearing ring causing flaking as a result of the grease lubrication life test. Table 34 also shows absence or presence of coarse carbides with a major diameter larger than 10 μm for an inspected area of 300 mm² together.

TABLE 34

| | | Large | | | |
|---|---|---|---|---|---|
| | | carbide | | Number of | |
| | Test | exceeding | L₁₀ life | flaked | Kind of flaked |
| | piece | 10 μm | (hr) | bearings | bearing ring |
| Example | 601 | none | 980 | 8 | Outer-ring |
| | 602 | none | 1470 | 1 | Outer-ring |
| | 603 | none | 1500 | 0 | — |
| | 604 | none | 1500 | 0 | — |
| | 605 | none | 1500 | 0 | — |
| | 606 | none | 1500 | 0 | — |
| | 607 | none | 1500 | 0 | — |
| Comp. | 601 | none | 150 | 10 | Outer-ring |
| Example | 602 | presence | 780 | 10 | Outer-ring |
| | 603 | presence | 730 | 10 | Outer-ring |
| | 604 | none | 230 | 10 | Outer-ring |
| | 605 | none | 560 | 10 | Outer-ring |

As can be seen from Table 34, in the rolling bearings of Examples 601 and 607, since the compositions for the steel materials constituting the outer rings and the inner rings can satisfy the conditions of the present invention, and since coarse carbides deleterious to the rolling life were not present, they had excellent life compared with the rolling bearing of Comparative Examples 601 to 605, at large vibration and heavy load and under condition where water intrudes. Particularly, the rolling bearings of Examples 602 to 607 with a chromium content of 3.5 mass % or more and the nitrogen content of 0.5 mass % or more were excellent in view of the life.

On the contrary, while Comparative Example 601 was a rolling bearing made of SUJ2, all of ten rolling bearings were fractured by early flaking accompanied by structural change. Further, while Comparative Example 602 satisfies the formula: C %≦−0.05×Cr %−0.12×(Mo %+V %+W %)+1.41, since nitrogen was not added and coarse eutectic carbons were remained somewhat, the life was poor compared with each of the examples.

Further, Comparative Example 603 is an example of not satisfying the formula described above, coarse eutectic carbides were remained and the life was poor compared with each of the examples. Further, in Comparative Example 604, since the chromium content was smaller, life was poor compared with each of the examples. Further, in Comparative Example 605, since the content of carbon and nitrogen in total was less than 0.5 mass % and no sufficient hardness by hardening could be obtained, life was poor compared with each of the examples.

In this embodiment, while the outer ring (fixing ring) and the inner ring (rotational ring) were constituted with an identical species of steel material, only the fixed ring often tending to cause flaking may be constituted with the steel satisfying the condition of the present invention, while the rotational ring and the rolling element may be constituted with usual SUJ2. Then, the life could be made longer than usual while minimizing the increase of the cost.

Then, the result of evaluating the life under oil bath lubrication for deep groove ball bearings of JIS bearing designation 6206 is to be described. The inner ring and the outer ring of the deep groove ball bearing are constituted with the steel material of the composition shown in Table 33 like the deep groove ball bearing of JIS bearing designation 6303. That is, the inner ring and the outer ring were manufactured by hardening a steel material formed into a predetermined size at 840 to 960° C., applying tempering at 160° C. and then applying finishing fabrication by grinding. However, since it was difficult to attain hardness at a hardening temperature as described above for Comparative Examples 602 and 603, hardening was conducted by using a vacuum furnace at 960 to 1000° C. The surface roughness of the inner and the outer ring was about from 0.01 to 0.04 μm. Further, the rolling element was a steel ball made of SUJ2 applied with a carbonitriding treatment corresponding to ball grade 20.

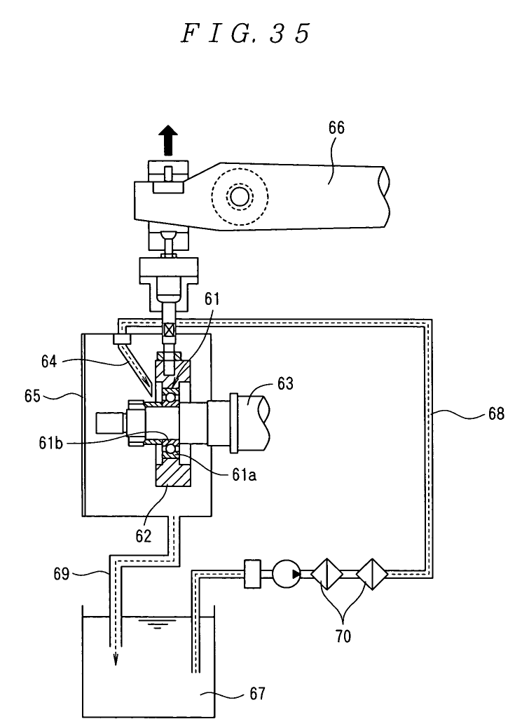

The oil bath lubricating life test was conducted by using a tester as shown in FIG. 35. Then, assuming the use in an actual transmission, a method of conducting the test after forming a foreign body biting flaw to the rolling surface of a bearing at the initial stage of rotation was adopted.

A detailed test method is to be described with reference to FIG. 35. The life tester shown in FIG. 35 comprises a housing 62 to which an outer ring 61a of a tested bearing 61 is attached, a shaft 63 to which an inner ring 61b of the tested bearing 61 is attached and a oil supply nozzle 64 for supplying a lubricant to the inside of the tested bearing 61.

The entire portion of the housing 62 and the portion of the shaft 63 other than the end base are surrounded with an enclosure 65, and the oil supply nozzle 64 is located at an upper portion in the enclosure 65. Further, a load lever 66 for applying a load by way of the housing 62 to the tested bearing 61 is disposed above the outside of the enclosure 65.

With the constitution described above, the tested bearing 61 is adapted to be rotated by the shaft 63 while undergoing load from the load lever 66 and being supplied with the lubricant from the oil supply nozzle 64. The conditions for the oil bath lubrication life test were set at a test load Fr of 9600N, a test temperature of 110° C. and a rotational speed of 3900 min⁻¹ (inner ring rotation).

The oil supply nozzle 64 is connected with an oil tank 67 for storing the lubricant by way of a pipeline 68 such that the lubricant is supplied from the tank 67 to the oil supply nozzle 64. Further, the lubricant supplied to the tested bearing 61 drops in the enclosure 65, passed through a waste oil pipe 69 located below the enclosure 65 and returned to the oil tank 67. Further, a filter 70 for removing foreign bodies in the lubricant is attached to the upstream of the pipeline 68, such that clean lubricant is supplied to the oil supply nozzle 64.

As a lubricant, a commercially available traction oil with a maximum traction coefficient (μ) of 0.09 at 40° C. and 0.07 at 100° C., a dynamic viscosity of 30.8 mm²/s at 40° C. and of 5.31 mm²/s at 100° C. mixed with 5 mass % of tap water was used. The maximum traction coefficient is a value measured by using a two cylindrical tester under the condition at a circumferential rate of 4.1 m/s and a slipping ratio of 5%.

At first, a stainless steel powder at a hardness Hv of 500 and a grain size of 74 to 147 μm was added by 0.005 g to one liter of the lubricant in the oil tank 67 and stirred. Then, while supplying the lubricant without passing through the filter 70 to the tested bearing 61, it was rotated for 3 min and initial indentation was formed to the raceway surface of the tested bearing 61.

Then, the filter 70 was attached to the pipeline 68 and the tested bearing 61 was rotated under supply of the lubricant again. Then, vibrations caused to the tested bearing 61 during rotation were measured and the test was interrupted when the vibration values during rotation reached 5 times the initial vibration value, to examine whether flaking occurred or not on the raceway surface of the tested bearing 61. Life test was conducted for each type of bearings each by the number of 10, and the time till the occurrence of flaking was measured to determine the L₁₀ life.

Since the calculated life of the deep groove ball bearing under the condition was 40 hrs. The test termination time was defined as 200 hrs which was five times thereof. Then, in a case where flaking did not occur in all ten tested bearings until the test termination time, the L₁₀ life was defined as 200 hrs.

Table 35 shows the L₁₀ life, the number of flaked bearings and the kind of flaked bearing rings in the bearings by the number of 10 as the result of the oil bath lubrication life test. Further, in Table 35, the example number and the comparative example number identical with those in Table 33 and Table 34 are attached to bearings constituted with the steel materials of the species identical with the steel materials described Tables 33 and 34. Further, Table 35 also shows the hardness (HRC) for the raceway surface of the inner and outer rings, the amount of retained austenite and presence or absence of coarse carbides with the major diameter exceeding 10 μm for 300 mm² an area to be inspected.

TABLE 35

| | | | Retained | | | | |
|---|---|---|---|---|---|---|---|
| | | | austenite | | | | |
| | | Hardness | amount | Coarse-carbide | L₁₀ life | Number of | Kind of flaked |
| | Test piece | (HRC) | (vol %) | exceeding 10 μm | (hr) | flaked bearing | bearing ring |
| Example | 601 | 62.4 | 9.7 | none | 89 | 8 | Inner ring |
| | 602 | 62.6 | 12.3 | none | 178 | 3 | Inner ring |
| | 603 | 61.8 | 15.6 | none | 200 | 0 | — |
| | 604 | 61.1 | 17.2 | none | 200 | 0 | — |
| | 605 | 62.3 | 16.4 | none | 200 | 0 | — |
| | 606 | 62.1 | 16.2 | none | 200 | 0 | — |
| | 607 | 59.7 | 15.3 | none | 188 | 1 | Inner ring |
| Comp. | 601 | 62.2 | 8.0 | none | 14 | 10 | Inner ring and |
| Example | | | | | | | Outer ring |
| | 602 | 61.9 | 4.7 | presence | 46 | 10 | Inner ring and |
| | | | | | | | Outer ring |
| | 603 | 62.5 | 7.2 | presence | 38 | 10 | Inner ring and |
| | | | | | | | Outer ring |
| | 604 | 62.4 | 7.6 | none | 28 | 10 | Inner ring and |
| | | | | | | | Outer ring |
| | 605 | 56.3 | 2.1 | none | 20 | 10 | Inner ring and |
| | | | | | | | Outer ring |

As can be seen from Table 35, in the rolling bearings of Examples 601 to 607, since the compositions of the steel materials constituting the outer ring and the inner ring satisfy the conditions of the present invention, coarse carbides deleterious to the rolling life were not present and, further, a sufficient amount of retained austenite was present, both of the surface originated flaking from foreign body biting indentation and inside originated flaking caused by formation of white structure could be decreased to improve the life.

Particularly, rolling bearings of Examples 602 to 607 in which the chromium content was 3.5 mass % or more and the amount of austenite was 10 vol % or more were excellent in view of life. Further, rollings bearings of Examples 603 to 606 containing 4 mass % or more of chromium and containing at least one of molybdenum, vanadium, and tungsten were not fractured at all.

On the contrary, the rolling bearing of Comparative Examples 601 to 605 had shorter life compared with each of the examples. Comparative Example 601 was a rolling bearing made of SUJ2, and white structure was confirmed nearly in the entire number of bearings. Further, Comparative Examples 602, 603 were fractured nearly in the entire number of bearings being originated from coarse carbides or indentations. Further, in Comparative Examples 604, while those fractured being originated from the surface were also confirmed, flaking occurred in part from the white structure showing the state of fracture in which both of the them were present together. Further, in Comparative Example 605, no sufficient hardness was obtained, showing the state of fracture in which the surface originated flaking and the inside originated flaking were present together.

As has been described above, in the rolling bearings of this embodiment, since coarse eutectic carbides were not present, structural change to the white structure caused by hydrogen intrusion could be suppressed, and early flaking caused by white structure could be suppressed, they showed long life even at large vibrations and heavy load and under the condition where water intruded.

Further, since the retained austenite was present stably, and the surface originated flaking originating from indentations due to foreign bodies could also be moderated, they had long life even under lubrication with intrusion of foreign bodies.

Further, since it is excellent in the hardenability and has high hardness due to the effect of the nitrogen, it is excellent also in view of productivity.

### (IV) For Embodiment of the Invention for Solving the Fourth Subject

A life test for 4-point contact deep groove ball bearings of examples (example of the invention) and comparative examples are to be described. Both for examples and comparative examples, a 4-point contact single row deep groove ball bearing of 35 mm inner diameter, 50 mm outer diameter and 12 mm width was used and the inner ring, the outer ring and the rolling element were made of an identical test material.

In the life test, the tested materials for the examples and the comparative examples were manufactured from steels having the chemical ingredients shown in Table 36.

TABLE 36

| | Tested | Steel composition (mass %) | | | | | | α |
|---|---|---|---|---|---|---|---|---|
| | material | C | Si | Mn | Cr | Mo | V | value |
| Example | A5 | 0.9 | 0.20 | 0.50 | 2.50 | 0.20 | 0.20 | 1.24 |
| | B5 | 1.20 | 1.0 | 0.40 | 3.0 | | | 1.26 |
| | C5 | 0.80 | 0.50 | 1.0 | 4.0 | 2.00 | | 0.97 |
| | D5 | 0.55 | 0.45 | 0.50 | 7.0 | 0.40 | | 1.01 |
| | E5 | 0.75 | 1.50 | 0.20 | 9.5 | | 0.20 | 0.91 |
| | F5 | 0.70 | 1.0 | 0.50 | 13.0 | 0.50 | | 0.70 |
| | G5 | 0.50 | 0.75 | 0.80 | 15.0 | 0.10 | 1.0 | 0.53 |
| | H5 | 0.55 | 1.0 | 0.40 | 17.0 | 0.50 | | 0.55 |
| Comp. | I5 | 0.95 | 0.35 | 0.38 | 1.45 | | | 1.34 |
| Example | J5 | 0.95 | 0.35 | 0.38 | 1.50 | 0.50 | 0.20 | 1.25 |
| | K5 | 0.80 | 0.50 | 0.40 | 2.0 | 0.50 | | 1.25 |
| | L5 | 0.55 | 1.0 | 0.50 | 20.0 | 1.0 | 0.50 | 0.23 |
| | M5 | 0.85 | 1.00 | 0.30 | 4.10 | 4.30 | 0.70 | 0.61 |
| | N5 | 1.30 | 0.80 | 0.80 | 4.00 | 0.50 | 0.20 | 1.13 |

In the tested materials IS to N5 for the comparative examples in Table 36, numerical values with underlines are those for out of the optimal ingredient range of the present invention. Each of the tested materials was applied with a heat treatment (hardening by heating at 830 to 1050° C. for 2 hours, oil-cooling and then tempering at 180 to 460° C.). It was controlled such that the surface hardness HRC was from 58 to 64 and the average amount of retained austenite γR was from 0 to 12% for the inner and outer rings and the rolling element, the surface roughness was from 0.003 to 0.010 μmRa for the rolling element, and the surface roughness was from 0.015 to 0.020 μmRa for the inner and outer rings. Further, the radius of curvature for the groove (hereinafter referred to as “groove R”) for the bearing raceway surface was from 50.5% to 56.0% for the diameter of the rolling element both for the inner and outer rings.

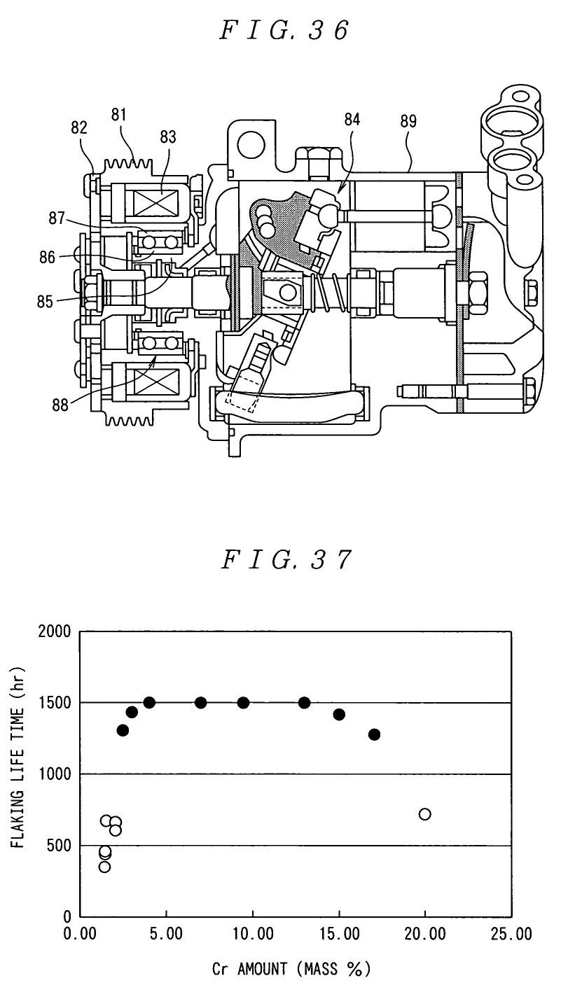

As the life test, two types of test, that is, a flaking test and a seizure test were conducted. At first, the flaking test was conducted by using a compressor of a car air conditioner as shown in FIG. 36.

As shown in FIG. 36, in the compressor for the car air conditioner, power of an engine is transmitted by way of a crank pulley and a belt (both not illustrated) to a solenoid clutch pulley 81. The transmitted power of the engine is transmitted to a compressor 84 by attracting a friction plate 82 formed to the end of the solenoid clutch pulley 81 by the electromagnetic force of the solenoid coil 83 to the compressor 84 to drive the compressor 84. Further, an inner ring 86 of a ball bearing 88 is fixed to a cylindrical portion 85 protruded from a housing 89 so as to cover the driving shaft of the compressor 84, and an outer ring 87 of the ball bearing 88 is press-fitted into the solenoid clutch pulley 81 to thereby rotationally support the solenoid clutch pulley 81.

The ball bearing 88 is applied with a tension by a belt for actuating the solenoid clutch pulley 81, a radial load is loaded by the tension on the ball bearing 88 and a thrust load is further applied upon actuation of the solenoid clutch. Further, the solenoid clutch pulley 81 and the ball bearing 88 are displaced for the axial center positions from each other due to the restriction on the arrangement at the periphery of the engine, and a moment load is applied due to the displacement on the ball bearing 88.

Evaluation for the flaking test was conducted by incorporating four-point contact single row deep groove ball bearings of examples and comparative examples each between the cylindrical portion 85 and the solenoid clutch pulley 81 of the actual solenoid clutch described above and under the following conditions. That is, the rotational speed was 1000 to 15000 min⁻¹, and the bearing clearance was 5 to 15 μm. Further, the load condition was as at: P (applied load)/C (dynamic load rating)=0.15, and the test temperature was set constant at 150° C. E grease was used for the lubricant.

In this case, since the calculated life of the bearing is 1280 hrs, the test termination time was defined as 1500 hrs. Then, when the vibration value increased up to five times the initial vibrations, the test was interrupted and absence or presence of flaking was confirmed. The test was conducted for each kind of bearings each by the number of 10 to determine the L₁₀ life. In a case where flaking did not occur in all ten bearings up to the test termination time, the L₁₀ life was determined as 1500 hrs.

Further, the compressor for the car air conditioner described above was used also for the seizure test. However, the test was conducted continuously at a constant rotational speed of 20000 min⁻¹, at a bearing temperature of 160° C. and under a radial load of 98N. Constitutions for the tested bearing and the like were identical with those in the flaking test. Then, when seizure occurred to rise the bearing outer ring temperature to 165° C. or higher, the test was terminated. Further, in a case where the bearing outer ring temperature did not rise to 165° C. or higher even after the test for 1000 hrs, the test was terminated. The test was conducted for each kind of bearings each by the number of 10.

Table 37 shows the result of the evaluation for the flaking test and the seizure test collectively.

TABLE 37

| | | | | | | Groove of | Groove of | | | | | | |
|---|---|---|---|---|---|---|---|---|---|---|---|---|---|
| | | | | | Mean | inner | outer | Flaking test | | | Seizure test | | |
| | Test | Tested | | | γR | ring | ring | L₁₀ life | Flaking | | L₁₀ life | Seizure | |
| | material | material | Heat treatment | | (%) | R (%) | R (%) | time (hr) | slate | | (hr) | state | |
| Exam. | 701 | A5 | Dip hardening | 830° C. × 2 hr | 4 | 52.0 | 54.5 | 1310 | 2/10 | flaked | 890 | 2/10 | seizure |
| | 702 | B5 | Dip hardening | 830° C. × 2 hr | 10 | 51.0 | 53.0 | 1440 | 1/10 | flaked | 1000 | No seizure | |
| | 703 | C5 | Dip hardening | 850° C. × 2 hr | 12 | 54.0 | 56.0 | 1500 | No flaking | | 1000 | No seizure | |
| | 704 | D5 | Caruburization | 930° C. × 2 hr | 8 | 51.5 | 54.0 | 1500 | No flaking | | 1000 | No seizure | |
| | 705 | E5 | Dip hardening | 960° C. × 2 hr | 0 | 52.5 | 53.5 | 1500 | No flaking | | 1000 | No seizure | |
| | 706 | F5 | Dip hardening | 1000° C. × 2 hr | 5 | 52.5 | 54.0 | 1500 | No flaking | | 1000 | No seizure | |
| | 707 | G5 | Caruburization | 1000° C. × 2 hr | 5 | 55.5 | 56.0 | 1420 | 1/10 | flaked | 1000 | No seizure | |
| | 708 | H5 | Dip hardening | 1050° C. × 2 hr | 3 | 51.0 | 53.0 | 1280 | 2/10 | flaked | 970 | 1/10 | seizure |
| Comp. | 701 | I5 | Dip hardening | 830° C. × 2 hr | 10 | 50.5 | 52.5 | 350 | 10/10 | flaked | 230 | 10/10 | seizure |
| Exam | 702 | I5 | Dip hardening | 830° C. × 2 hr | 10 | 52.0 | 54.0 | 440 | 10/10 | flaked | 220 | 10/10 | seizure |
| | 703 | I5 | Dip hardening | 830° C. × 2 hr | 0 | 52.0 | 54.0 | 460 | 9/10 | flaked | 280 | 10/10 | seizure |
| | 704 | J5 | Dip hardening | 830° C. × 2 hr | 8 | 52.0 | 54.0 | 670 | 7/10 | flaked | 230 | 10/10 | seizure |
| | 705 | K5 | Dip hardening | 830° C. × 2 hr | 4 | 50.5 | 51.0 | 660 | 7/10 | flaked | 440 | 9/10 | seizure |
| | 706 | K5 | Dip hardening | 1050° C. × 2 hr | 4 | 51.5 | 56.0 | 600 | 8/10 | flaked | 430 | 9/10 | seizure |
| | 707 | L5 | Dip hardening | 1050° C. × 2 hr | 12 | 53.0 | 55.5 | 720 | 7/10 | flaked | 620 | 5/10 | seizure |

| | | | | | | | | | | | |
|---|---|---|---|---|---|---|---|---|---|---|---|
| 708 | M5 | Dip hardening | 960° C. × 2 hr | 5 | 51.5 | 54.0 | 410 | 10/10 | flaked | 1000 | No seizure |
| 709 | N5 | Dip hardening | 1000° C. × 2 hr | 8 | 52.0 | 56.0 | 350 | 10/10 | flaked | 1000 | No seizure |

At first, the result of the flaking test is to be described.

As shown in Table 37, bearings of Examples 703, 705 and 706 were manufactured from the tested materials C5, E5 and F5 respectively and dip hardening was conducted as the heat treatment. Further, Example 704 was manufactured from the tested material D5 and carbonitridation was conducted as the heat treatment. The amount of C ranges from 0.5 to 0.8 mass %, and the amount of Cr ranges from 4.0 to 13.0 mass % and they satisfy:
C %≦−0.05×Cr %−0.12×(Mo %+V %)+1.41 (=α value).

Accordingly, in the life test, Examples 703 to 706 did not cause flaking and the L₁₀ life was 1500 hrs. Further, when the hardness of the raceway surface was measured after the test, HRC was from 60 to 64 in all Examples 703 to 706 and they had hardness required as the bearing steel.

The bearing of Example 701 was manufactured from the tested material A5 in which the amount of C was 0.9 mass % and the amount of Cr was 2.5 mass %. While Example 701 had a long life, since the amount of Cr was somewhat smaller compared with Examples 703 to 706, it generated heat when the rolling element caused rotations. Then, the hardness was lowered by the generation of heat to cause flaking in 2 out of 10 bearings. Actually, when the hardness of the raceway surface was measured, HRC was 59 and it was lowered by about HRC 3 compared with the initial hardness. However, when compared with comparative examples to be described later, particularly, with Comparative Examples 701 and 702 manufactured from SUJ2 (Cr amount: 1.5 mass %) it had a longer life of three times or more.

The bearing of Example 702 was manufactured from the tested material B5 in which the amount of C was 1.2 mass % and the amount of Cr was 3.0 mass %. In this case, since the hardness was lowered due to the smaller amount of Cr, or eutectic-carbides were precipitated because of larger amount of C as 1.2 mass % compared with Examples 703 to 706, the L₁₀ life was 1440 hrs.

Examples 707, 708 were manufactured from the tested materials G5, H5 in which the amount of C was 0.5 mass % and 0.55 mass %, and the amount of Cr was 15.0 mass % and 17.0 mass %, respectively. In both of Examples 707 and 708, since the amount of Cr was larger, shortening of the life caused by the lowering of the hardness was not observed. However, since eutectic carbides were formed, flaking occurred being originated from eutectic carbides and the L₁₀ life was 1420 hrs and 1280 hrs, respectively.

Comparative Examples 701 to 703 were manufactured from the tested material IS (SUJ2), and the average amount of the retained austenite γR was controlled to 10%, 10% and 0% by changing the heat treatment condition. In Comparative Examples 701 to 703, since the amount of Cr was not at the optimum value in both of them, heat was generated by metal contact between the rolling element and the inner and outer rings to shorten the life due to the lowering of the hardness. In fact, when the raceway surface of the bearing was observed, grinding traces were present no where and, when the hardness for the raceway surface was measured, HRC was.55 or less in each of Comparative Examples 701 to 703.

Further, in Comparative Examples 701, 702, the effect on the life was investigated by changing the groove R for the raceway surface of the inner and outer rings while the average amount of retained austenite γR being fixed at 10%, but there was scarce effect. Further, while the effect of the average amount of retained austenite was investigated for Comparative Examples 701 and 703, this provided scarce effect on the life also in this case, and it is considered that optimization for the alloying ingredient such as Cr is only one effective means.

Comparative Example 704 was manufactured from the tested material J5 formed by adding Mo and V to SUJ2. Also in this case, since the amount of Cr was not at the optimal value, the life was shortened by the lowering of the hardness.

Further, Comparative Examples 705 and 706 were manufactured from the tested material K5 in which the amount of C was 0.8 mass % and the amount of Cr was 2.0 mass %. Also in this case, the radius of curvature for the groove (groove R) for the raceway surface was changed both for the inner and outer rings such that the groove R of the inner ring was set to 50.5% for the diameter of the rolling element, and the groove R of the outer ring was set to 51.0% for the diameter of the rolling element in Comparative Example 705, while the groove R of the inner ring was set to 51.5% for the diameter of the rolling groove and the groove R of the outer ring was set to 56.0% for the diameter of the rolling element in Comparative Example 706. However, there was scarce effect of the groove R and, since the amount of Cr was smaller compared with the optimal ingredient range both in Comparative Examples 705 and 706, flaking occurred in 7 out of 10, and 8 out of 10 bearings, respectively, to shorten the life.

Comparative Example 707 was manufactured from the tested material L5 in which C was 0.55 mass %, the amount of Cr was 20.0 mass % and the average amount of retained austenite γR was 12%. Since the amount of Cr was large, shortening of the life by the lowering of the hardness was not observed. However, since the amount of Cr was excessive compared with the optimal ingredient amount, eutectic carbides were formed and flaking was originated from the eutectic-carbides, so that the L₁₀ life was reduced to 720 hrs.

Comparative Example 708 was manufactured from the tested material M5 in which the amount of Mo exceeded the optimal ingredient range. Comparative Example 709 was manufactured from the tested material N5 in which the amount of C exceeded the optimal ingredient range.

Further, in both of Comparative Examples 708 and 709, since the amount of C is larger than the α value (=−0.05×Cr %−0.12×(Mo %+V %)+1.41), eutectic carbides were formed. Then, stresses were concentrated at the periphery of the eutectic carbides and flaking was originated from the sites and the L₁₀ life was short as 410 hrs and 350 hrs, respectively. However, since the amount of Cr was larger compared with SUJ2, lowering of hardness after the test was not observed and the hardness of the raceway surface was HRC 62 in both of them.

FIG. 37 is a graph showing a relation between the amount of Cr and the flaking life of the bearing.

Then, the result of the seizure test is to be described.

For Examples 702 to 707, since Cr was contained by 3 masse or more, the hardness required as the bearing was kept also in a case where heat was generated by rotation slip of the rolling element, so that seizure did not occur at all. Further, since the decomposition of the retained austenite was retarded to provide excellent dimensional stability also in a case where the average amount of retained austenite γR was present in a great amount, seizure did not occur at all.

For Example 701, since the amount of Cr was smaller compared with Examples 702 to 707, the bearing clearance was decreased due to the lowering of the hardness and expansion of the bearing size to cause seizure in 2 out of 10 bearings and the L₁₀ life was 890 hrs. For Example 708, since Cr was contained by 17.0 mass %, lowering of the hardness was not observed and the dimensional stability was also excellent. However, since Cr was contained in a great amount, heat conductivity was lowered to rise the bearing temperature and deteriorate the grease thereby causing seizure in one out of 10 bearings.

Comparative Examples 701 to 703 were manufactured from the tested material I5 (SUJ2). Both of Comparative Examples 701 and 702 were hardened at 840° C. and tempered at 180° C. In Comparative Example 701, the groove R of the inner ring was set to 50.5% for the diameter of the rolling element and the groove R of the outer ring was set to 52.5% for the diameter of the rolling element. In Comparative Example 702, the groove R of the inner ring was set to 52.0% for the diameter of the rolling element and the groove R of the outer ring was set to 54.0% for the diameter of the rolling element. Also in this case, since the amount of retained austenite γR was large as 10%, this caused dimensional change to result in seizure. Further, change of the groove R for the raceway surface of the inner and outer rings had no effect on the seizure life, and the L₁₀ life for Comparative Examples 701 and 702 were 230 hrs and 220 hrs, respectively.

For Comparative Example 703, hardening at 840° C., sub-zero treatment and tempering at 240° C. were applied to reduce the average amount of retained austenite γR to 0%. In this case, since it was manufactured from SUJ2, hardness was lowered during the seizure test to result in seizure and the L₁₀ life was 280 hrs.

Comparative Example 704 was manufactured from the tested material J5, which provided scarce effect and the L₁₀ life was 230 hrs.

Comparative Examples 705 and 706 were manufactured from the tested material K5 in which the radius R of the inner ring was set to 50.5% for the diameter of the rolling element and the groove R of the outer ring was set to 51.0% for the diameter of the rolling element in Comparative Example 705, while the groove R of the inner ring was set to 51.5% for the diameter of the rolling element and the groove R of the outer ring was set to 56.0% for the diameter of the rolling element in Comparative Example 706. In this case, since Cr was as less as 2.0 mass %, seizure was caused by the dimensional change and the lowering of the hardness.

In Comparative Example 707, since the amount of Cr was 20 mass %, lowering of hardness and dimensional change did not occur. However, since the amount of Cr was excessive, heat conductivity of the bearing was worsened to rise the bearing temperature and cause seizure due to the degradation of the grease.

Further, in Examples 701 to 708 and Comparative Examples 701 to 707 (C %≦α value), the optimal ingredient range for the amount of Cr was from 2.5 to 17.0 mass % with respect to the flaking life and the seizure life. In a case where the amount of Cr was less than 2.5 mass %, hardness required as the bearing could not be obtained in a case where metal contact was formed to generate heat, thereby causing flaking, as well as causing seizure due to the lowering of the hardness and deterioration of the dimensional stability. On the other hand, in a case where the amount of Cr exceeded 17.0 mass %, since eutectic carbides were formed to cause flaking and seizure was caused by the lowering of the heat conductivity, the life was shortened.

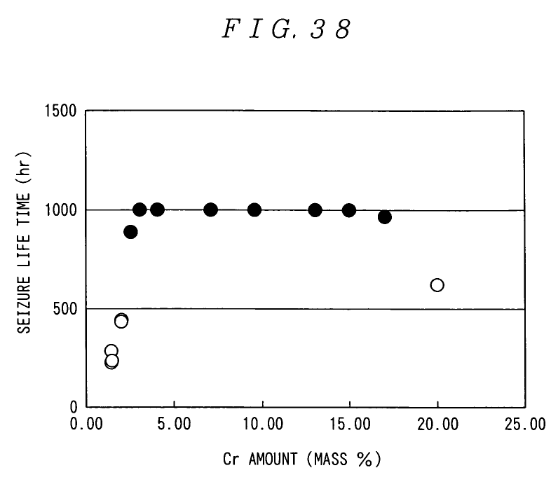

For further improving the life of the bearing, it is desirable that the amount of Cr was 4.0 to 13.0 mass % or less. For the heat treatment, it is considered that identical heat treatment effect can be obtained by any of dip hardening, carburization and carbonitridation. FIG. 38 is a graph showing a relation between the amount of Cr and the seizure life of the bearing.

Further, Comparative Examples 707 to 709 had shorter life since the amount of C is larger than the α value.

### (V) Embodiment of the Invention for Solving the Fifth Subject

In this embodiment, a flaking reproduction test was conducted as a life test for the rolling bearing.

As the flaking reproduction tester, a rapid acceleration/deceleration tester described in Japanese Unexamined Patent Publication No. Hei 9-89724 was used for example. Then, the test was conducted under the condition, for example, of switching the rotational speed between 9000 min⁻¹ and 18000 min⁻¹ on every predetermined time of about 9 sec.

Further, for both of examples of the present invention and comparative examples, JIS bearing designation 6303 was used for the tested bearing, the bearing clearance was 10 to 15 μm, the loading condition was as at: P (applied load)/C (dynamic load rating)=0.10 and the test temperature was set constant at 80° C. Since the calculated life of the bearing is 1350 hrs in this case, the test termination time was defined as 1500 hrs. When the vibration value increased up to five times the initial vibrations, the test was interrupted and the absence or presence of flaking was confirmed. The test was conducted for each type of bearings each by the number of 10 to determine the L₁₀ life. In a case where flaking did not occur in all ten bearings up to the test termination time, the L₁₀ life was defined as 1500 hrs.

In the flaking test described above, the tested materials of Examples A6 to I6 and Comparative Examples J6 to R6 shown in Table 38 were used for the material of the inner and outer rings of the bearings, and applied with usual heat treatment (hardening by heating at 830 to 1050° C., oil cooling and then tempering at 180 to 460° C.) for use. However, it was not restricted to the dip hardening, but carburization, carbonitrization or induction hardening may also be applied. As apparent from Table 38, in the tested materials for each of Examples A6 to I6, all alloying ingredient contents were within the recommended range of the present invention. Numerical values with underlines in Table 38 were for those out of the recommended range of the present invention in view of the contents of alloying ingredient.

TABLE 38

| | | Composition of Steel | | | | | | | | | | Rating | |
|---|---|---|---|---|---|---|---|---|---|---|---|---|---|
| | Tested | C | Si | Mn | Cr | Mo | V | O | Ti | S | α | number | |
| | material | (mass %) | (mass %) | (mass %) | (mass %) | (mass %) | (mass %) | (ppm) | (ppm) | (mass %) | value | Thin | Heavy |
| Example | A6 | 1.0 | 0.20 | 0.50 | 2.50 | 0.20 | 0.20 | 9 | 14 | 0.003 | 1.24 | 0.5 | 0.5 |
| | B6 | 1.20 | 1.0 | 0.40 | 3.0 | | | 8 | 12 | 0.002 | 1.26 | 1.0 | 0.5 |
| | C6 | 0.80 | 0.50 | 1.0 | 4.0 | 2.0 | | 8 | 11 | 0.008 | 0.97 | 1.5 | 1.0 |
| | D6 | 0.80 | 0.50 | 1.0 | 4.0 | 2.0 | | 8 | 13 | 0.002 | 0.97 | 0.5 | 0.0 |
| | E6 | 0.60 | 0.45 | 0.50 | 6.0 | 0.40 | | 9 | 13 | 0.002 | 1.06 | 0.5 | 0.0 |
| | F6 | 0.70 | 1.50 | 0.20 | 9.0 | | 0.20 | 6 | 10 | 0.005 | 0.94 | 0.5 | 0.0 |
| | G6 | 0.50 | 1.0 | 0.50 | 11.0 | 0.50 | | 9 | 14 | 0.002 | 0.80 | 0.5 | 0.5 |
| | H6 | 0.60 | 0.75 | 0.80 | 13.0 | 0.10 | | 7 | 10 | 0.004 | 0.75 | 0.5 | 0.5 |
| | I6 | 0.55 | 1.0 | 0.40 | 17.0 | | | 9 | 17 | 0.003 | 0.56 | 1.0 | 0.5 |
| Comp. | J6 | 0.95 | 0.35 | 0.38 | 1.5 | | | 8 | 12 | 0.002 | 1.34 | 1.0 | 0 |
| Example | K6 | 0.80 | 0.50 | 0.40 | 2.0 | 0.50 | | 8 | 13 | 0.003 | 1.25 | 1.0 | 0.5 |
| | L6 | 0.55 | 1.0 | 0.50 | 18.0 | 1.0 | 0.50 | 9 | 14 | 0.002 | 0.33 | 0.5 | 0.5 |
| | M6 | 1.20 | 1.0 | 0.40 | 3.0 | | | 9 | 12 | 0.009 | 1.26 | 2.5 | 2.0 |
| | N6 | 0.60 | 0.45 | 0.50 | 6.0 | 0.40 | | 8 | 11 | 0.004 | 1.06 | 2.0 | 1.5 |
| | O6 | 0.60 | 0.45 | 0.50 | 6.0 | 0.40 | | 9 | 11 | 0.010 | 1.06 | 2.0 | 1.5 |
| | P6 | 0.60 | 0.75 | 0.80 | 13.0 | 0.10 | | 9 | 14 | 0.011 | 0.75 | 2.0 | 2.0 |
| | Q6 | 0.85 | 1.0 | 0.30 | 4.10 | 4.30 | 0.20 | 9 | 14 | 0.002 | 0.67 | 1.0 | 0.5 |
| | R6 | 1.30 | 0.80 | 0.80 | 4.0 | 0.50 | 0.20 | 9 | 14 | 0.002 | 1.13 | 0.5 | 0.5 |

1) Rating number for thin type A series inclusions and rated number for heavy type A series inclusions.

Table 38 also shows the rating numbers for the A series inclusions in the steel (rating number for Thin type A series inclusions and rating numbers for Heavy type A series inclusions by the method according to ASTM E45) and the values on the right side of the formula calculated from the content for reach of the alloying ingredients together (α value):
C %≦−0.05×Cr %−0.12×(Mo %+V %+W %)+1.41

Further, the rolling element was constituted with SUJ2 (bearing steel, 2nd class). Further, the surface hardness HRC was from 58 to 64 and the amount of retained austenite was from 0 to 20% for the inner and outer rings and the rolling element. Then, the center line average roughness for the raceway surface was from 0.015 to 0.025 μmRa for the inner and outer rings, while the center line average roughness was from 0.003 to 0.010 μmRa for the rolling element. Table 39 shows the result of the flaking reproduction test.

TABLE 39

| | Test | Tested | L₁₀ life | Flaking | |
|---|---|---|---|---|---|
| | piece | material | (hr) | state | |
| Example | 801 | A6 | 1290 | 2/10 | flaked |
| | 802 | B6 | 1420 | 1/10 | flaked |
| | 803 | C6 | 1320 | 2/10 | flaked |
| | 804 | D6 | 1500 | No flaking | |
| | 805 | E6 | 1500 | No flaking | |
| | 806 | F6 | 1500 | No flaking | |
| | 807 | G6 | 1500 | No flaking | |
| | 808 | H6 | 1500 | No flaking | |
| | 809 | I6 | 1250 | 2/10 | flaked |
| Comp. | 801 | J6 | 360 | 10/10 | flaked |
| Example | 802 | K6 | 440 | 10/10 | flaked |
| | 803 | L6 | 460 | 9/10 | flaked |
| | 804 | M6 | 530 | 7/10 | flaked |
| | 805 | N6 | 940 | 6/10 | flaked |
| | 806 | O6 | 630 | 8/10 | flaked |
| | 807 | P6 | 770 | 7/10 | flaked |
| | 808 | Q6 | 440 | 10/10 | flaked |
| | 809 | R6 | 380 | 10/10 | flaked |

As can be seen from Table 39, in the rolling bearings of the examples, since all of the composition of steels, α values, and A type inclusion rating numbers satisfy the condition of the present invention, they caused less flaking and were excellent in the life. Particularly, the rolling bearings of Examples 804 to 808 caused no flaking at all.

However, in the rolling bearing of Example 803, since the amount of S was somewhat larger and the rating number of A type inclusion was somewhat larger, hydrogen generated during the test and MnS chemically reacted to evolve hydrogen sulfide. Accordingly, flaking accompanied by structural change to the white structure occurred to somewhat shorten the life.

Further, also in the rolling bearings of Examples 801 and 802, since the amount of Cr having the effect of retarding the structural change to the white structure was somewhat smaller, flaking occurred in the same manner as in Example 803 to somewhat shorten the life.

Further, in the rolling bearing of Example 809, since the amount of S was smaller and the amount of Cr was larger, it less caused structural change to the white structure. However, since eutectic carbides were formed, flaking was originated therefrom to somewhat shorten the life.

On the other hand, the rolling bearing of Comparative Example 801 was made of SUJ2. While the amount of S and the rating number of the A type inclusions satisfy the conditions of the present invention, since the amount of Cr was smaller, it could not retard the structural change to the white structure to shorten the life. Further, the rolling bearing of Comparative Example 802 also had short life by the same reason as described above.

Further, in the rolling bearing of Comparative Example 803, although the amount of S and the rating number of the A type inclusions satisfy the condition of the present invention, since the amount of Cr was excessive, eutectic carbides were formed. As a result, flaking was originated from the eutectic carbides to shorten the life.

Further, in the rolling bearings of Comparative Examples 804, 806 and 807, while the amount of Cr was appropriate, since the amount of S and the rating number of the A type inclusions did not satisfy the condition of the present invention, hydrogen evolved during the test and MnS chemically reacted with each other to evolve hydrogen sulfide. Accordingly, flaking accompanied by structural change to the white structure occurred to shorten the life.

Further, in the rolling bearing of the Comparative Example 805, while the amount of Cr and the amount of S were appropriate, since the rating number for the A type inclusions did not satisfy the condition of the present invention, the life was shortened by the same reasons as those for Comparative Examples 804, 806 and 807.

Further, in the rolling bearings of Comparative Examples 808 and 809, since the amount of C was larger than the α value, eutectic carbides were formed. As a result, stresses were concentrated at the periphery of the eutectic carbides and flaking was originated from the sites to shorten the life.

Each of the embodiments described above shows the example of the present invention and the present invention is not restricted to the embodiments. For example, while description has been made to the rolling bearing with respect to the deep grooved ball bearings as an example, it will be apparent that the rolling bearing according to the present invention is applicable to various other types of rolling bearings. They include, for example, radial type rolling bearings such as angular ball bearings, self-aligned ball bearings, cylindrical roller bearings, tapered roller bearings, needle roller bearings, and self-aligned roller bearings, as well as thrust type roller bearings such as thrust ball bearings, thrust roller bearings, etc.

### INDUSTRIAL APPLICABILITY

As has been described above, according to the rolling bearing of the present invention, the surface roughness for the raceway surface of at least the fixed ring in the fixed ring and the rotational ring is controlled to a predetermined value as described above, and the contents of the alloying ingredients is controlled to the predetermined amounts as described above. Further, in the rolling bearing according to the present invention, a grease is sealed being blended with additives such as conductive substance, diurea compound, metal compound and the like. Accordingly, the rolling bearing of the present invention can be retained from flaking or seizure to provide long life.

1. A rolling bearing in which plural rolling elements are arranged between a fixed ring and a rotational ring for use wherein a center line average roughness for the raceway surface of at least the fixed ring in the fixed ring and the rotational ring is from 0.025 to 0.075 μmRa.

2. A rolling bearing according to claim 1, wherein at least the fixed ring in the fixed ring and the rotational ring contains alloying ingredients at a ratio of from 0.50 to 1.20 mass % of carbon, from 0.10 to 1.50 mass % of silicon, from 0.1 to 2.0 mass % of manganese, from 3.0 to 6.0 mass % of chromium, 2.0 mass % or less of molybdenum and 1.0 mass % or less of vanadium.

3. A rolling bearing in which plural rolling elements are arranged between a fixed ring and a rotational ring for use wherein at least the fixed ring in the fixed ring and the rotational ring contains alloying ingredients at a ratio of from 0.50 to 1.20 mass % of carbon, from 0.10 to 1.50 mass % of silicon, from 0.1 to 2.0 mass % of manganese, from 3.0 to 6.0 mass % of chromium, 2.0 mass % or less of molybdenum and 1.0 mass % or less of vanadium.

4. A rolling bearing for use in supporting pulleys in a belt-type continuously variable transmission according to any one of claims 1 to 3.

5. A rolling bearing for use in supporting pulleys in a belt-type continuously variable transmission in which plural rolling elements are arranged between a fixed ring and a rotational ring for use, wherein at least one of the fixed ring, the rotational ring and the rolling element is formed of a steel material containing alloying ingredients at a ratio of from 0.50 to 1.20 mass % of carbon, from 0.10 to 1.50 mass % of silicon, from 0.1 to 2.0 mass % of manganese, from 2.5 to 9.5 mass % of chromium, 2.0 mass % or less of molybdenum and 1.0 mass % or less of vanadium, and the carbon content C %, the chromium content Cr %, the molybdenum content Mo %, and the vanadium content V % satisfy the following formula:
C %≦−0.05×Cr %−0.12×(Mo %+V %)+1.41).

6. A rolling bearing for use in an engine auxiliary equipment in which plural rolling elements are arranged between a fixed ring and a rotational ring for use, wherein a center line average roughness for the raceway surface of at least the fixed ring in the fixed ring and the rotational ring is from 0.025 to 0.075 μmRa.

7. A rolling bearing according to claim 6 wherein at least the fixed ring in the fixed ring and the rotational ring contains alloying ingredients at a ratio of from 0.50 to 1.20 mass % of carbon, from 0.60 to 1.50 mass % of silicon, from 0.1 to 2.0 mass % of manganese, from 2.5 to 9.5 mass % of chromium, 2.0 mass % or less of molybdenum and 1.0 mass % or less of vanadium.

8. A rolling bearing for use in an engine auxiliary equipment in which plural rolling elements are arranged between a fixed ring and rotational ring for use wherein at least the fixed ring in the fixed ring and the rotational ring contains alloying ingredients at a ratio of from 0.50 to 1.20 mass % of carbon, from 0.60 to 1.50 mass % of silicon, from 0.1 to 2.0 mass % of manganese, from 2.5 to 9.5 mass % of chromium, 2.0 mass % or less of molybdenum and 1.0 mass % or less of vanadium.

9. A rolling bearing in which plural rolling elements arranged between a fixed ring and a rotational ring are lubricated with grease for use, wherein at least one of the fixed ring and the rotational ring and is formed of a steel material containing alloying ingredients at a ratio of from 0.50 to 1.20 mass % of carbon, from 0.60 to 1.50 mass % of silicon, from 0.1 to 2.0 mass % of manganese, from 2.5 to 9.5 mass % of chromium, 2.0 mass % or less of molybdenum and 1.0 mass % or less of vanadium.

10. A rolling bearing in which plural rolling elements arranged between a fixed ring and a rotational ring are lubricated with grease for use, wherein at least one of the fixed ring and the rotational ring is formed of a steel material containing alloying ingredients at a ratio of from 0.50 to 1.20 mass % of carbon, from 0.60 to 1.50 mass % of silicon, from 0.1 to 2.0 mass % of manganese, from 2.5 to 9.5 mass % of chromium, 2.0 mass % or less of molybdenum and 1.0 mass % or less of vanadium, and a conductive substance is blended by from 0.1 to 10 mass % based on the entire amount of a grease comprising a lubricant base oil and a thickening agent, and the grease is sealed.

11. A rolling bearing for use in an engine auxiliary equipment or a gas heat pump with a compressor being driven by a gas engine in which plural rolling elements arranged between a fixed ring and a rotational ring are lubricated with a grease for use, wherein
at least one of the fixed ring, the rotational ring and the rolling element is formed of a steel material containing alloying ingredients at a ratio of from 0.50 to 1.20 mass % of carbon, from 0.60 to 1.50 mass % of silicon, from 0.1 to 2.0 mass % of manganese, from 2.5 to 17.0 mass % of chromium, 2.0 mass % or less of molybdenum and 1.0 mass % or less of vanadium, and the carbon content C %, the chromium content Cr %, the molybdenum content Mo %, and the vanadium content V % satisfy the following formula:
C %≦−0.05×Cr %−0.12×(Mo %+V % )+1.41.

12. A rolling bearing according to claim 11, wherein the center line average roughness for the raceway surface of at least the fixed ring in the fixed ring, the rotational ring and the rolling element is from 0.025 to 0.15 μmRa.

13. A rolling bearing according to claim 11 or 12, wherein at least the fixed ring in the fixed ring, the rotational ring and the rolling element is controlled by hardening and tempering to a hardness HRC of from 56 to 64.

14. A rolling bearing in which plural rolling elements arranged between a fixed ring and a rotational ring are lubricated with grease for use, wherein the center line average roughness is from 0.01 to 0.08 μmRa, and the skewness is from −5.0 to −0.5 for the raceway surface of at least the fixed ring in the fixed ring and the rotational ring.

15. A rolling bearing according to claim 14, wherein the viscosity of a base oil contained in the grease is from 70 to 200 mm²/s at 40° C.

16. A rolling bearing according to claim 14 or 15, wherein at least the fixed ring in the fixed ring, the rotational ring and the rolling element contains chromium as the alloying ingredient at a ratio of from 2.0 to 16.0 mass %, and the hardness is controlled to HRC of from 56 to 64 by hardening and tempering.

17. A rolling bearing according to claim 11, 12, 14, or 15, wherein from 0.1 to 10 mass % of a conductive material is blended based on the entire grease.

18. A rolling bearing according to claim 11, wherein the grease contains a base oil, at least one of diurea compounds of the following chemical formulae (1) to (3), a naphthenate, and succinic acid or a derivative thereof,
the content of the diurea compounds based on the entire grease satisfies the conditions represented by the following formulae (4) and (5), and the content of the naphthenate and the content of succinic acid or the derivative thereof is from 0.1 to 10 mass % based on the entire grease: 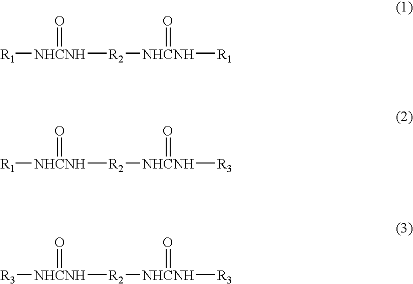
0≦W₁+W₂+W₃≦35 (4)
0≦(W₁+0.5×W₂)/(w₁+W₂+W₃)≦0.55 (5)
in which R₁ represents an aromatic ring-containing hydrocarbon group (7 to 12 carbon atoms in total), R₂ represents a bivalent aromatic ring-containing hydrocarbon group (6 to 15 carbon atoms in total), and R₃ represent a cyclohexyl group or alkylcyclohexyl group (7 to 12 carbon atoms in total) in the chemical formula (1) to (3), and
W₁, W₂ and W₃ in the formulae (4) and (5) each represents the content of the diurea compounds of the chemical formulae (1), (2) and (3) based on the entire grease (on the basis of mass % unit).

19. A rolling bearing according to claim 18, wherein the grease contains at least one of metal compounds of the following chemical formulae (6) to (11) and the content thereof is from 0.1 to 10 mass % based on the entire grease: 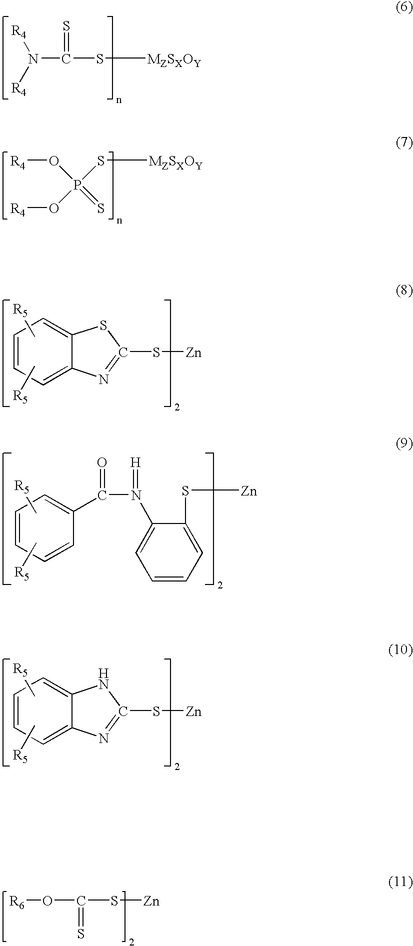
in which R₄ represents a hydrocarbon group of 1 to 18 carbon atoms, M represents metal, n represents an integer of from 2 to 4, x and y each represents an integer of from 0 to 4, and z represents an integer of from 1 to 4, respectively, in the chemical formulae (6) and (7) and, further,
R₅ represents hydrogen or a hydrocarbon group of 1 to 18 carbon atoms in the chemical formulae (8) to (10), and R₆ represents a hydrocarbon group of 1 to 18 carbon atoms in the chemical formula (11).

20. A rolling bearing according to claim 18 or 19, wherein the grease does not contain a sulfonate.

21. A rolling bearing according to claim 12, wherein the mean distance Sm for the concave/convex on the raceway surface is from 3 to 50 μm.

22. A rolling bearing comprising an inner ring, an outer ring and plural rolling elements arranged rotationally between the inner ring and the outer ring, wherein,
at least one of the inner ring, the outer ring and the rolling element is constituted with a steel satisfying the following three conditions:
Condition 1:
it contains from 0.40 to 0.87 mass % of carbon, from 3.0 to 7.0 mass % of chromium, from 0.1 to 2.0 mass % of manganese, from 0.1 to 2.0 mass % of silicon and from 0.03 to 0.2 mass % of nitrogen with the balance of iron and inevitable impurities.
Condition 2:
the content for carbon and nitrogen in total is from 0.5 to 0.9 mass %,
Condition 3:
the carbon content C % and the chromium content Cr % satisfy the formula:
C %≦−0.05×Cr %+1.41.

23. A rolling bearing comprising an inner ring, an outer ring and plural rolling elements arranged rotationally between the inner ring and the outer ring, wherein,
at least one of the inner ring, the outer ring and the rolling element is constituted with a steel satisfying the following three conditions:
Condition 1:
it contains from 0.40 to 0.87 mass % of carbon, from 3.0 to 7.0 mass % of chromium, from 0.1 to 2.0 mass % of manganese, from 0.1 to 2.0 mass % of silicon and from 0.03 to 0.2 mass % of nitrogen, and containing at least one of 3.0 mass % or less of molybdenum, 2.0 mass % or less of vanadium and 2.0 mass % or less of tungsten by 1.0 mass % or more in total with the balance of iron and inevitable impurities.
Condition 2:
the content for carbon and nitrogen in total is from 0.5 to 0.9 mass %,
Condition 3:
the carbon content C %, the chromium content Cr %, the molybdenum content Mo %, the vanadium content V % and the tungsten content W % satisfy the formula:
C %≦−0.05×Cr %−0.12×(Mo %+V %+W %)+1.41.

24. A multiple-point contact rolling bearing in which plural rolling elements are rotationally arranged between an inner ring and an outer ring, wherein at least one of the fixed ring, the rotational ring and the rolling element is formed of a steel material containing alloying ingredients at a ratio of from 0.50 to 1.20 mass % of carbon, from 0.10 to 1.50 mass % of silicon, from 0.1 to 2.0 mass % of manganese, from 2.5 to 17.0 mass % of chromium, 2.0 mass % or less of molybdenum and 1.0 mass % or less of vanadium, and the carbon content C %, the chromium content Cr %, the molybdenum content Mo %, and the vanadium content V % satisfy the following formula:
C %≦−0.05×Cr %−0.12×(Mo %+V %)+1.41.

25. A rolling bearing used for use in an engine auxiliary equipment or a gas heat pump with a compressor being driven by a gas engine in which plural rolling elements arranged between a fixed ring and a rotational ring are lubricated with a grease for use, wherein at least one of the fixed ring, the rotational ring and the rolling element is formed of a steel material containing alloying ingredients at a ratio of from 0.50 to 1.20 mass % of carbon, from 0.10 to 1.50 mass % of silicon, from 0.1 to 2.0 mass % of manganese, from 2.5 to 17.0 mass % of chromium, 2.0 mass % or less of molybdenum and 1.0 mass % or less of vanadium, and the carbon content C %, the chromium content Cr %, the molybdenum content Mo %, and the vanadium content V % satisfy the following formula:
C %≦−0.05×Cr %−0.12×(Mo %+V %)+1.41.

26. A rolling bearing according to claim 25, wherein the steel material has a sulfur content of 0.008 mass % or less and a rating number of Thin type A series inclusions is 1.5 or less and a rating number of Heavy type A series inclusions is 1.0 or less by the method according to ASTM E45.

27. A rolling bearing according to claim 13, wherein from 0.1 to 10 mass % of a conductive material is blended based on the entire grease.

28. A rolling bearing according to claim 16, wherein from 0.1 to 10 masse of a conductive material is blended based on the entire grease.
